(19) United States
(12) Patent Application Publication
(10) Pub. No.: US 2007/0156594 A1
(43) Pub. Date: Jul. 5, 2007

(54) System and method for allowing creators, artsists, and owners to protect and profit from content

(76) Inventor: Elliot McGucken, Malibu, CA (US)

Correspondence Address: Dr. Elliot McGucken, 24345 Baxter Drive, Malibu, CA, 90265, US

(21) Appl. No.: 11/648,963

(22) Filed: Jan. 3, 2007

Related U.S. Application Data
(60) Provisional application No. 60/755,927, filed on Jan. 3, 2006.
(60) Provisional application No. 60/792,107, filed on Apr. 15, 2006.

(51) Int. Cl. G06Q 99/00; H04N 7/16

(52) U.S. Cl. 705/51; 705/50; 726/26

(57) ABSTRACT

The present invention offers novel and superior means for protecting and profiting from digital content. The rights-centric, creator-centric digital rights management application will lead to greater revenue and rights for artists, and a new era of creator's entrepreneurship, as opposed to the dominant aggregator's entrepreneurship. The present invention offers a simple interface for creators, artists, users, and owners to define rights, select from a plurality of DRM options, advertising options, watermarking options, thumbnailing options, syndication options, and publish, share, sell, and distribute their content in a plurality of manners. This invention has far-ranging ramifications, as it causes DRM providers, device manufacturers, web companies, social networks, and content marketplaces to more directly compete with one-another to provide the creator and content owner the best compensation for their work. Creators can bypass the traditional and new middlemen, define their rights, sell their content, and enhance profits.

### BACKGROUND OF THE INVENTION

1. Field of the Invention

The present invention relates to software that provides creators enhanced control of rights definitions, rights management, syndication, distribution, delivery, watermarking, and ecommerce. The moral premise of the present invention is that every creator ought to be afforded the rights to protect and profit from their creations.

An embodiment of the present invention allows creators to bypass all the DRM and ecommerce middlemen, allowing the creator to upload their content, define their rights and price, protect their content before distributing it, and be directly compensated by the consumer.

This invention is dedicated to Fifty Cent, Eminem, Harlan Elison, Kid Rock, George Lucas, Puff Daddy, Lars Ulrich, Aimee Mann, Kristin Hersh, Scott Weiland, Kristen Hersh, Chris Robinson, toby Keith, Lou Reed, Victoria Shaw, Art Alexakis, the Beatles and Rolling Stones, Bob Dylan, DMX, and every other artist who started off as an indie artist, and all the indie artists to come. The present invention salutes Abraham Lincoln's eloquence, the spirit and words of the United States Constitution and The Declaration of Independence, Johnny Cash, and the Creator they all served. For it is creator's Natural Right to protect and profit from their creations.

This present invention is dedicated to all the entrepreneurs seeking to build a renaissance that recognizes the higher ideals by which all everlasting art is created, and by which such art might be protected, so that creators reap the maximum profits. In addition to serving the creator and indie artist, the present invention will open doors for entrepreneurs seeking to build novel and superior distribution systems for digital content-systems which reward the artist and creator in ever improving manners, thusly fostering greater art and wealth-both cultural and monetary.

There is a Creator mentioned in The Declaration of Independence, in the following early sentence, “We hold these truths to be self-evident, that all men are created equal, that they are endowed by their Creator with certain unalienable Rights, that among these are Life, Liberty and the pursuit of Happiness.” In the spirit of this sentence, and in humble observance of that very same Creator, the 45 Revolver seeks to empower all creators with optimized compensation, distribution, and protection for their content. And what's good for the indie creator will be good for the ginat studios. We all use the same electricity, fill up at the same gas stations, and use the same internet. There also ought be equal access to DRM for all, and there will be, via the present invention.

The present invention will provide tools of vast use to artists, creators, and entrepreneurs on their Hero's Journeys, where they answer the call to adventure to build a renaissance. Luke Skywalker had his light saber, Neo had his martial arts, The Man With no Name had his 45 Revolver, and so too will tomorrow's creators have their 45 Revolver.

2. Prior Art

The ideas, concepts, and various innovations underlying the present invention—The 45 Revolver—will usher in a new era of the internet that supports Creator's Capitalism, instead of the current Aggregators' Capitalism, which employs lawyers, activists, and hipster MBA marketing experts to trample upon the Constitutional rights of indie artists and creators. The 45 Revolver will foster a renaissance in entrepreneurship, wherein the indie creator—the fount of vast wealth throughout the internet and beyond—is afforded new opportunities to protect and profit from their content. Furthermore, entrepreneurs serving the interests of the author and creator will be afforded opportunities to create new business models based upon the novel ideas underlying 45 Revolver. Abraham Lincoln wrote, “to secure to each laborer the whole product of his labor, or as nearly as possible, is a most worthy object of any good government.” This is the moral premise of the ideas and innovations underlying the present invention and all manifestations of the 45 Revolver, which offers novel and superior methods to protecting and profiting from ones content.

The rising generation is longing for a renaissance wherein classical ideals are performed in the contemporary context, and the 45 Revolver will allow those who build the renaissance to protect and profit from their creations, thereby providing artist and authors with incentive to create and share, sell, and distribute the wealth of their creations. There exist thousands of places for one to share, distribute, and sell one's content, but none of the prior art offers the breadth, nor depth of options described herein, which result in a new class of 45 Revolver applications that put the creator at the center of the internet, empowering them with a full suite of rights management and distribution tools with numerous options, thusly commoditizing the myriad of companies that have hitherto commoditized the creator. “The prudent, penniless beginner in the world,” Lincoln wrote, “labors for wages awhile, saves a surplus with which to buy tools or land for himself, then labors on his own account for awhile, and at length hires another new beginner to help him. This is the just and generous and prosperous system which opens the way to all, gives hope to all, and consequent energy and progress and improvement of condition to all.” The 45 Revolver—an embodiment of the present invention—supports the American Dream as described by Lincoln, and it provides a novel and superior manner for creators to protect and profit from their content.

When Lincoln addressed Congress in 1861, he said, “On the side of the Union is a struggle for maintaining in the world that form and substance of government whose leading object is to elevate the condition of men to lift artificial weights from all shoulders; to clear the paths of laudable pursuits for all; to afford all an unfettered start, and a fair chance in the race of life.” That is the object of The 45 Revolver—to provide creators with a superior means of protecting and profiting from their content.

Every true artist begins as an inide artist, develops as an indie artist, and passes on as an indie artist. Even though corporate and academic bureaucracies regularly try to manufacture non-inide artists, such pseudo-artists work is short-lived, for only the true indie artist can string eternity's bow. Truth comes from within the individual—not from the bureaucracy. Thus the 45 Revolver, which empowers the indie artist, can lead to renaissances in content and culture.

The concepts behind the 45 Revolver are a product of multiple years of Dr. Elliot McGucken's research into intellectual property rights and both open source and proprietary methods for content and rights management and social networking. Dr. McGucken has written several books including the novel Autumn Rangers, and his dissertation on an artificial retina for the blind, entitled, “Multiple unit artificial retina chipset to aid the visually impaired and enhanced holed-emitter CMOS phototransistors,” was awarded a Merrill Lynch Innovations award in an international competition paying homage to fundamental research with commercial applications. Dr. McGucken (Dr. E) has spoken at the Harvard Law School's Berkman Center for Internet and Society regarding his Open Source DRM project Authena.org at the oscom.org conference-the present invention offers an improvement over the IP disclosed throughout the Authena.org project. Dr. McGucken's 22surf.org Open Source business plan has been downloaded and read by thousands, and it was accepted into the Zurich OSCOM: http://sourceforge.net/projects/authena22surf. The present invention is an improvement upon Dr. E's prior art. Dr. McGucken appeared on a panel aside John Whealan-Deputy General Counsel for Intellectual Property Law & Solicitor USPTO, and Marybeth Peters—U.S. Register of Copyrights, where he spoke about the fundamental Constitutional concepts underlying the present invention—a video of this panel may be viewed at: http://www.unctv.org/ipcip/: UNC Symposium on Intellectual Property, Creativity, and the Innovation Process—catch Dr. E at SXSW 2007. Dr. E's research has appeared in Popular Science and Business Week, and The Wall Street Journal wrote, “Elliot McGucken decided to straddle the two worlds. After he earned a doctoral degree in physics/electrical engineering, Dr. McGucken considered himself “fortunate” to get a teaching job at Davidson College in Davidson, N.C., and to continue his engineering research. But then, last year, he won the Innovation Grants Competition sponsored by Merrill Lynch Forum, the virtual think tank of the financial-services company. The contest, now in its second year, gives out $150,000 in prizes for Ph.D.s, and their institutions, who find commercial applications for their research . . . . After winning the contest, he got to tour the New York Stock Exchange. Dr. McGucken caught the entrepreneurial bug. Eventually, he launched jollyroger.com, an Internet company devoted to his longtime passions: writing and classical literature.”

Dr. McGucken devised and is currently teaching a course, Artistic Entrepreneurship & Technology: artsentrepreneurship.com, which would be well-served by the underlying concepts of the present invention. Indeed, a common problem of so many rising artists is securing and monetizing their creations-protecting and profiting from their content—form their blood, sweat, and tears—from their tireless labors of love. This present invention assists rising creators by providing novel methods by which they can protect and profit from their creations. The 45 Revolver, by focusing on property rights, and offering the creator the ability to define their rights, select from different digital rights management options, watermarking options, and thumbnailing options, will not only helps the indie creator in a vast manner, but will also foster and father an abundance of further innovation and invention, and become best friend to authors, artists, inventors, and entrepreneurs alike.

Thousands of rising artists have little or no means to protect their content before releasing it on the web, where digital content may be copied ad in finitum. A purpose of this invention is to offer artists the ability to use DRM in protecting their content. Vast media companies including Myspace, Flickr, and hundreds of other Web 2.0 companies have business models that rely upon freely using, copying, and distributing others' content, without ever compensating the creator. Creators are told that there is little or no value in their creation as it stands alone, but only within the context of the greater group. The media and Wall Street have been successful in convincing creators to work for free in building out web 1.0 and web 2.0, just as traditional record companies have oft been successful in convincing artists to work for free in building traditional record labels. The present invention, by combining existing technologies in novel ways that counter expert opinion, provides a superior means for artists to protect and profit from their work, and for participants in social networks to profit from their participation.

### Prior Art and Further Background

The Nobel Laureate Economist Friedrich Hayek offers great insight into the quandary of Web 2.0 companies, which millions work for without profiting. Hayek states, “Perhaps the fact that we have seen millions voting themselves into complete dependence on a tyrant has made our generation understand that to choose one's government is not necessarily to secure freedom.” Hayek also states that, “If we wish to preserve a free society, it is essential that we recognize that the desirability of a particular object is not sufficient justification for the use of coercion.” This means that even though Web 2.0 companies want to bolster their bottom lines by claiming rights to everyone's creations and content, that doesn't give Larry Lessig et al the right to deconstruct the United States Constitution. Hayek also states, “There is, in a competitive society, nobody who can exercise even a fraction of the power which a socialist planning board would possess,” thus signifying that the rights of creators ought to be left up to the creators, and not handed over to some faculty board, nor committee of postmodern lawyers, nor Web 2.0 company, nor any other socialistic nor feudalistic entity—no matter what it has changed its name to, nor pretense it hides behind, to escape detection.

The famous economist, and Nobel Laureate, Milton Friedman stated, “The greatest advances of civilization, whether in architecture or painting, in science and literature, in industry or agriculture, have never come from centralized government.” So it is that the indie authors and artists ought be given the technology that affords them their Constitutional Rights.

Friedman also says, “So the question is, do corporate executives, provided they stay within the law, have responsibilities in their business activities other than to make as much money for their stockholders as possible? And my answer to that is, no they do not.” Note that he stipulates “provided they stay with the law.” The law, as stated in the Constitution, is that artists and authors have the right to protect and profit from their creations. Friedman states, “Underlying most arguments against the free market is a lack of belief in freedom itself.” So it is that the activists and lawyers do not believe in freedom fro the artist, as they do not believe in freedom themselves. They do not understand the act of creation and entrepreneurship. They see economics as a zero-sum game, to which Friedman says, “Most economic fallacies derive from the tendency to assume that there is a fixed pie, that one party can gain only at the expense of another.” The 45 Revolver believes in the artists' rights—in the artists' freedom, and the software exists as a method and means for them to profit via the excerising of those rights.

Finally, Friedman says this, “Nobody spends somebody else's money as carefully as he spends his own. Nobody uses somebody else's resources as carefully as he uses his own. So if you want efficiency and effectiveness, if you want knowledge to be properly utilized, you have to do it through the means of private property.” The 45 Revolver believes in the artists' private property—in the artists' freedom—and the software exists as a method and means for them to profit via the exercising of those rights. The prior art, including Web 2.0 companies and Larry Lessig's philosophies and ventures, do not respect the artist's private property.

Sites and companies such as CD Baby are great for the indie artist. But, CD Baby's site states, “No Microsoft products were used in the creation of this website.” This means that musicians are unable to protect, encrypt, or offer their works using Windows DRM directly through the CD Baby site. The 45 Revolver, on the other hand, would allow musicians access to Windows DRM, so that they could protect and profit from their content.

At the Snocap.com site, it says, “Q: How does SNOCAP protect content? Which DRM are you using? A: Rights holders choose whether they want to sell their content in MP3 format, or using Microsoft's Windows Media DRM technology.” So it is that Snocap only offers Windows DRM, and only through snocap, thusly limiting the devices media can be played on, while keeping the price of DRM—a commodity—artificially inflated, so as to benefit the non-creators at Snocap, such as Shawn Fanning. The present invention offers a multitude of DRM and DRM packages from different DRM. Snocap charges the unsigned artist a whopping $0.45/download. Consider a 99 cent song—the artist writes, performs, records, mixes, and masters the song, and snocap automatically gets about half the profits when the song is sold, for doing just about nothing. They did not create the internet, nor DRM, nor the protocols that protect and distribute content, nor the ecommerce engines that handle transactions. The 45 Revolver places all this in perspective, exerting downward pressure on the price of DRM and distribution by offering indie artists a multitude of DRM formats, as well as DRM providers, from which to choose from.

Snocap is very much just another Web 2.0 company. The 45 Revolver will allow users to upload to snocap, but it wall also offer other, superior options. The Web 2.0 company menatility is that they want full control of your content. When you upload content into Snocap, or Lulu, or Youtube, they don't want it going anywhere else. Youtube and others change the format and never give you access to the pristine original. The 45 Revolver will always give the user access to the pristine original, as well as interfaces and information that aid in the distribution of the creator's content. Simple web services can register accounts in multiple content ompanies that aggregate content, and upload, manage, publicize, promote, and profit from the content throughout all of them. The 45 Revolver would be a vast time saver, allowing the user to upload the pristine original once to a secure server, and syndicate watermarked, or degraded versions, on out to hundreds of other portals who make a living by commoditizing hundreds of artists.

The Rapper Fifty Cent (50 Cent) states in his book From Pieces to Weight, “Get Rich or Die Tryin': When I say that, everyone focuses on the negative aspects: death, desperation, depression. But you know what? Everybody, from the guy who gets up to punch a clock every day to the kid standing on the corner, is trying to get rich before they die. The guy punching the clock is probably going to night school or has a hustle on the side or some dream he's working on. Why? To get rich. The kid who picks up a bag of drugs to sell is the same way. He's out there in the entrepreneurial spirit, hustling, trying to get rich. That kid just doesn't want to work for anybody—he wants to work for himself. It's just that he has the wrong direction at that point in his life. All at the same time, he's trying to get rich, just like that guy punching a clock, the old man driving a cab, the kid going to college to get his degree, the girl waiting tables at the restaurant. It's all about back to getting rich—or trying to do so. This is nothing new. You can find pretty much the same sentiments in all philosophies—Samurai codes and sh--like that. If Confucius says it, it's wisdom. But when 50 Cent says it, he's being negative.”

50 Cent ought to be afforded an application that empowers him with greater versatility to distribute his music. He ought be given the opportunity to upload his songs, set a price, and then be fully compensated. This is because DRM is based on algorithms, which are free as the wind. Instead, when 50 Cent sells a 99 cent song on iTunes, which can only be downloaded by an iPod, he gets about 10 cents. The 45 Revolver, by offering the creator different DRM formats, would make DRM providers compete against one-another, driving the price of DRM down, until it reached its natural level—0.

In the same way that many modern economists and lawyers are ignoring 50 cents rights and Nobel Prize winners such as Hayek and Friedman, modern physicists are ignoring Einstein and Feynman, so as to create little pockets of tax-subsidized foolishness, tenure, and fraud that has become so fashionable these days, wherein the primary objective is to deny that the truth exists, replace it all with personal, political propaganda, and support it with tax, tuition, snark, hype, and lies. So it that you get what we have here—which is the way they want it—well, they get it. Massive corporations profit from the labor and creativity of artists, who are denied their natural rights to the technology, because the lack of innovation in the realm of DRM, due to academia's opposition to the creative individual, and loyalty to the professional bureaucrat. Well, Dr. E is throwing the first academic conference with a panel devoted to DRM this spring—the Hero's Journey Entrepreneurship Festival.

The 45 Revolver seeks to serve Eminem and Fifty Cent. In the December 2006 of Vibe Magazine, Eminem & Fifty Cent talk about the industry in an article entitled Family Matters. Eminem states, “I see a lot of guys on tour, I'm not going to say any names, but on tour, they're touring just to make money. Because the way the record industry is right now, it's tough to sell records. The internet is killing us. At this point of my career, I'd be scared to drop an album for the smell of failure. Do we know how many fans we have in Soundscan says a certain number, but two million people downloaded it? Who knows if I put out another album what I'd sell, who knows what 50 would sell?”Vibe Magazine responds, “Are you worried that if the record business changes for the worse, you may have a domino effect with other businesses?”

Fifty Cent says “What we have the control of is the actual quality of the actual material. Now, if you're questioning if we're going to make the best music, I think generally if you ask anybody, they're going to tell you we're going to make the best rap records. so having the best rap records tied to a brand of clothing makes the clothing cool. The kid who enjoys a 50 Cent or Eminem project is not gonna stop enjoying the projects, but they may stop purchasing the CD. They may start stealing our music from the Internet. But they won't stop being fans of it.”

Vibe Magazine: “And you can't download shirt.”

50 Cent: “Right”

Note 50 Cent says, “They may start stealing our music from the internet.”

So it is that the prior and current art does not afford 50 Cent nor Eminem, any other indie musician, the ability to protect and profit from their content as they ought to. The 45 Revolver provides a new and improved ability to protect and profit from one's content.

50 Cent calls it “stealing,” while Larry Lessig et al would call it “sharing,” as Lessig et al believe that the Feudal Lords of Web 2.0 companies and lawyers ought get paid for the artist's creativity and labor. 50 Cent often quotes the Bible and mentions God on his albums, so he, Like Mark Twain, has a better sense of “Thou shall not steal.” Lessig, unlike the Founding Fathers who wrote the Constitution he has made fortune off of deconstructing, never mentions the Bible nor God, as if our rights are not Natural Property, but as if they are granted and taken away by lawyers. While such a philosophy enriches lawyers in the postmodern marketplace for justice, it degrades society, and it eventually loses out to Justice.

Like Fifty Cent, Mark Twain also prefers the Bible over lawyers when it comes to sources regarding copyrights. In 1906 Twain addressed congress concerning copyrights and intellectual property: “I am aware that copyright must have a limit, because that is required by the Constitution of the United States, which sets aside the earlier Constitution, which we call the Decalogue. The Decalogue says you shall not take away from any man his profit. I don't like to be obliged to use the harsh term. What the Decalogue really says is, “Thou shalt not steal,” but I am trying to use more polite language.” Twain also noted, “They always talk handsomely about the literature of the land . . . . And in the midst of their enthusiasm they turn around and do what they can to discourage it.” And this, “Whenever a copyright law is to be made or altered, then the idiots assemble.”

Lessig offers two solutions to stop the theft and illegal downloading of music—neither of which involves the logical solution—DRM. Lessig would have Fifty Cent release his song on a creative commons license so that his friends at Web 2.0 and other internet companies could profit from it, but not Fifty. Or he would pass a law so that only activists, who graduated from prestigious law schools, could release rap albums, thusly eradicating piracy for once and for all. This may also be achieved by launching MFA programs for hiphop. Just as MFA programs have institutionalized literature and killed Hollywood, to the point where nobody reads and less and less people are seeing movies, an MFA program in hiphop would halt piracy. For the greater good of the state and corporation, the indie artist and independent thinker must die.

Ideas have consequences, and so it is that upon the early web, DRM just isn't allowed to be, as the rights of artists and creators are generally detested by a handful of vocal programmers, techies, and their hero—Larry Lessig. Larry Lessig seems to be a living embodiment of a character from an Ayn Rand novel, as he encourages creators to turn over their copyrights voluntarily. He vehemently opposes DRM, which is ironic, because the Constitution recognizes that the creator has the right to do what they want with their creations, including using DRM to protect and profit from it, and the proper role of lawyers is to serve the people and the Constitution—not just the Feudal Lords of Web 2.0 companies and Aggregator Capitalists. The United States constitution recognizes the right of the artist to protect and profit from their content. And it also gives them the right to bear arms.

In Atlas Shrugged, Ayn Rand writes, “‘Precisely,’ said Dr. Ferris. ‘It's extremely important to get those patents turned over to us voluntarily. Even if we had a law permitting outright nationalization, it would be much better to get them as a gift. We want to leave the people with the illusion that they're still preserving their private property rights. And most of them will play along. They'll sign the Gift Certificates. Just raise a lot of noise about its being a patriotic duty and that anyone who refuses is a prince of greed, and they'll sign . . . Point three. All patents and copyrights, pertaining to any devices, inventions, formulas, and processes and works of any nature whatsoever, shall be turned over to the nation as a patriotic emergency gift by means of Gift Certificates to be signed voluntarily by the owners of all such patents and copyrights. The Unification Board shall then license the use of such patents and copyrights to all applicants, equally and without discrimination, for the purpose of eliminating monopolistic practices, discarding obsolete products, and making the best available to the whole nation. No trademarks, brand names or copyrighted titles shall be used. Every formerly patented product shall be known by a new name and sold by all manufacturers under the same name, such name to be selected by the Unification Board. All private trademarks and brand names are hereby abolished.’”

The 45 Revolver holds the rights of Artists as sacred entities. The Constitution does not grant rights, so much as it Recognizes Natural rights. For what is not granted, but inherent, can never be taken away. The 45 Revolver recognizes the indie artist and creator's natural rights to protect and profit from their content, and it expresses the ideal via its novel and unobvious combination of technologies.

### PRIOR ART AND SUMMARY OF THE INVENTION

“I'm going to pick a fight,” said William Wallace in the movie Braveheart.

And with the 45 Revolver, the indie artist can too.

The 45 Revolver allows the indie artist to define their rights, and then upload and protect their content with a few clicks of a mouse.

The 45 Revolver allows the indie artist to sit down at the high stakes table and call the bluff. The internet exists. DRM exists. End devices exist. The 45 Revolver allows indie artists to upload their media, define their rights, set a price, choose from different DRM providers, packagers, marketplaces, and sell their content. When a DRM provider or marketplace such as iTunes takes too big of a cut, or doesn't secure the content well enough. The creator can elect to not upload their content to that marketplace, but instead choose others. So it is that over time distribution will improve, as more and more devices seek to serve the artist, as opposed to traditional record labels, corporate behemoths, and academic fads wherein the indie artist has no right. And the great thing about this is that every true artist is an indie artist, so what works for 50 Cent will work for the garage band down the street—they'll all get to protect and profit from their content as never before.

With the 45 Revolver, the indie artist can call all the bluffs—Larry Lessig's bluff. Tim Oreilly's Web 2.0™ bluff, which disses the artist's rights, while Tim et al trademark Web 2.0. Cory Doctorow's bluff. Bill Gates' bluff. Larry, Eric, and Sergey's bluff. Rupert Murdoch's bluff. The RIAA's bluff. Sony's bluff. Yahoo's bluff—even yahoo, which is located more and more in Hollywood—came out against DRM. For it seems that everyone's bluffing except for maybe Mark Cuban.

The hard part in the act of creation is the act of creation. The internet, DRM protocols, and end devices are already there. They are commodities. The art is not. The art—be it a photograph, painting, song, book, video, film, documentary, or some hybrid combination—is unique. All that's needed are systems, methods, and innovations that treat the technological commodities as commodities, and the creation as unique, which is the way it is. Such a system reverses the Web 2.0 philosophy that commoditizes the artist and strips them of their natural rights, resulting in the “commodity reversal.”

The same corporate and academic bureaucracies that try to manufacture artists also oppose digital rights management for true artists. Rupert Murdoch runs both American Idol and Myspace. For in their eyes, there is no good nor bad, nor higher aesthetics, nor United States Constitution that's really worth thinking about, nor defending. There is only a postmodern marketplace wherein the elites have the right to exaggerate (lie), profit from other's content, pensions, and saving (steal), and pornify the world, breaking up the family, speartaing husband and wife, and parents and children, and giving everyone credit cards and encouraging them to kill the unproductive members of society—the innocent unborn—to raise the bottom line for the short term profit of the elites, at the long-term expense of society. As the famous exchange in Scent of a Woman has it, “Lt. Col. Frank Slade: Haven't you heard? CONSCIENCE is daihed. Charlie Simms: No, I haven't heard. Lt. Col. Frank Slade: Well, then, take the f---in' WAX outta your ears! GROW UP! It's f--k your buddy. Cheat on your wife. Call your mother on Mother's Day. Charlie, it's all sh--.” Lincoln is long gone along with all the great Lawyers schooled by the Great Books and the Bible instead of postmodern snarkiness, and with absolutely no leadership at the coproate and academic helms, no taste at the movie studios, no men capabable of passing God's Great and Just Judgment, it's mob rule; and it's elite rule too—just as long as the mob and the elite oppose the classical ideals. And the wholesale destruction of the traditional family is justified by a marketplace that replaces epic story and mythology with porn, as the numeric value of the Dow says nothing about the death of the soul, and thus the economists, who killed religion when they labeled economics a science, wash their hands, as Pontius Pilate washed his. The 45 Revolver, by protecting and defending the property rights of those who will build the renaissance, by allowing them to make money independent of myspace, Larry Lessig, Reality TV, Hollywood Studios, Dave Eggers' and his fake amazon review methodology, and American Idol, and all the rest of the bread and circuses that have distracted us from the better angels of our nature, and pit us against one-another. The 45 Revolver will lead to unparalleled wealth creation—both monetary and spiritual.

In Capitalism, The Unknown Ideal, Ayn Rand writes, “Today, patents are the special target of the collectivists' attacks—directly and indirectly, through the proposed abolition of trademarks, brand names, etc. While the so-called “conservatives” look at those attacks indifferently or, at times, approvingly, the collectivists seem to realize that patents are the heart and core of intellectual property rights, and that once they are destroyed, the destruction of all other rights will follow automatically, as a brief postscript.” The ironic collectivists, such as Lessig et al, have figured out a better system—the common creators—the indie artists—shall have no rights to their creations, but only the elite aggregators who Larry hangs out with in Silicon Valley. The principles of the 45 Revolver blow the ironic pretense away, by providing a systems, methods, and means for creators and indie artists to protect and profit from their content.

In Capitalism, The Unknown Ideal, Ayn Rand writes, “The present state of our patent system is a nightmare. The inventors' rights are being infringed, eroded, chipped, gnawed, and violated in to many ways, under cover of so many non-objective statutes . . . . Those who observe the spectacle of the progressive collapse of patents—the spectacle of mediocrity scrambling to cash-in on the achievements of genius—and who understand its implications, will understand why in the closing paragraphs of Chapter VII, Part II, of atlas Shrugged, one of the guiltiest men is the passenger who said: “Why should Rearden be the only one permitted to manufacture Rearden Metal?” The 45 Revolver will allow an artist to protect and profit from their content, so that they are the soul distributor. Who needs middlemen on the web?

But alas, Rand is not taught in business and law schools. Postmodern, spineless textbooks have replaced Shakespeare and the Bible, as Epic Mythology reminds us of the Truths in our eternal souls, and thus gets in the way of the creative accounting, doublespeak, hype, lies, deconstruction, and deceit, that are the primary skills taught to pomo-hipster MBA/JD/MFAs. Throughout college, grad school, and work, the honest creator is marginalized, castigated, and impugned, as the creative arts are professionalized by postmodem bureaucracies. Thus the characterless and non-creators excel, and rise to the top of the postmodem class, and the groupthinkers are sent to work at prestigious postmodern firms on Wall Street and Main Street, in Hollywood and the Heartland, to continue cashing in on the destruction of higher ideals, so as to build their fiefdoms.

The same, tired, postmodem gimmick is played out time and time again. Tenured mobs of elite physicists, bankers, MLA members, MFAs, lawyers, and MBAs deconstruct the classics, tell a thousand little lies with things like “blink don't think,” and “string theory,” and “the new economy,” transfer all the risk to he workers and creators and all the wealth to themselves as they play with pensions and cash in on the decline. Their common hallmark is splendid mediocrity overshadowed by avaricious ambition. Their common commitment is to short-term investing to enrich themselves at the expense of everyone else—their neighbors and their children—the preachers, teachers, and firemen—the indie artists and creators—and even the unborn. Their foolishness, along with the Renaissance that is to be, is the theme of Autumn Rangers, Jollyroger.com: Navigating an American Renaissance, The Tragedy of Drake Raft, this present invention, and all the rest of Dr. E's books.

On the back of each dollar it is printed “In God We Trust,” and those who think that Truth is not important; those who think that economics can be separated from art and literature—from a moral context—and yet signify something meaningful in the academy and beyond—those who think that the gold standard can be replaced with the porn standard without hell to pay, have another thing coming.

Ayn Rand writes, “Patents and copyrights are the legal implementation of the base of all property rights: a man's right to the product of his mind . . . . By forbidding an unauthorized reproduction of the object, the law declares, in effect, that the physical labor of copying is not the source of the object's value, that the value is created by the originator of the idea and may not be used without his consent; thus the law establishes the property right of a mind to that which it has brought into existence.” The 45 Revolver helps the indie creator protect and profit from their natural property rights in a novel and superior manner, by offering a full spectrum of rights and rights management technologies to choose from. A consequence of this invention is that it will force the creators of Web 2.0 companies, digital rights management technologies, to more directly compete with one another so as to offer the creator better and better deals, and better and better ways to protect and profit from their content.

Just as the Priceline patents revolutionized the auction system by having the buyer name their price, and then letting the suppliers compete to match it, this present invention revolutionizes content distribution, by allowing the creator to define their rights and terms, and then letting all the web companies and digital rights management providers compete to meet the creators' needs. Those companies which offer the creator decent terms will win out. Those companies that do not will lose. Thus innovations to better serve the creator will resound far and wide with the inception of the 45 Revolver, as waves ripple forth when a rock is tossed into the still waters of a lake.

Warren Buffett states, “The business schools reward difficult complex behavior more than simple behavior, but simple behavior is more effective.” Complex and difficult behavior is favored by the postmodern elite as it allows them to obfuscate—to muddy their waters so as to appear deeper—as Nietzsche suggested, so as to provide cover as they plunder pensions, steal inventions, erode property rights, transfer all the risk to the working man and graduate student, and all the wealth to the postmodern elite—anyone who is so uncreative that instead of working for a living, they buy an MBA or JD or MFA, join the administrative intermediary class, make sure that Plato, Shakespeare, and the Bible—the proper context for the United States Constitution are banned, and claim eminent domain on the fruits of others' labors.

The 45 Revolver prefers Warren Buffett's just simplicity. The 45 Revolver offers a novel way to better protect and profit form one's content, which is not only unobvious to the experts, but which is and will be opposed by the experts. It has been helpful to me,” Buffett explained, “to have tens of thousands (students) turned out of business schools taught that it didn't do any good to think.” And too is the 45 Revolver capitalizing on all the MBA/JD denizens who have been trained not to think, who have been taught that marketing is superior to intrinsic meaning, and who sold their souls for the immoral right to erode and capitalize off of the creators' private property. The 45 Revolver I capitalizing on all the MBA/JD/MFAs who never read the constitution. The 45 Revolver gives the indie artist a method to defend themselves against the armies of lawyers and MBAs being sent forth by Lessig et al to complete the cultural and Constitutional destruction. The 45 Revolver empowers the indie artist to protect and profit from their innovations.

Because myspace—the world's largest social network—has little or no mechanism to protect one's property, Rupert Murdoch's business model by and large depends on teenage girls posing in their underwear. Myspace accomplishes many purposes, including the continued destruction of the traditional family so as to drive the economy in the short term. On myspace, far more girls are friends with Burger King than they are with their own fathers. In order to see more pictures of them in your underwear, Rupert Murdoch has set it up to that you too must join, and in the process you'll see hundreds of banner ads designed by snarky design students, hired by snarky MBAs, all of whom are united by their general dismissal of and hatred for the Great Books and Classics and all that gets in the way of the postmodern bottom line, just like their professors were, who wrote them letters of recommendation that got them jobs at Myspace.

Because The 45 Revolver provides artists and authors superior, Constitutional, and moral means to protect and profit from their content, the 45 Revolver will result in superior social networks with superior content, worth protecting. Although it is a primal sin against Lord Lessig and Lord Murdoch to talk about cultural wealth and the Hugher Values of values, I will do so, because I believe in a higher God, and this is yet a Free Country. The 45 Revolver will be the primary tool of the Rising Renaissance, and none can stop it. With the 45 Revolver the risting poets and prophets shall destroy the postmodem Temple, and rebuild it in three days.

Regarding the democratic cultural devolution that is myspace—which is as much a manifestation of a logical conclusion of the pomo-elite's opposition to the Constitution, the Bible, Shakespeare, and property rights as are the mutual fund scandals and feminist studies departments—Scott Karp blogs at http://publishing2.com/2006/03/16/myspace-is-a-ticking-time-bomb/, “I've been dreading this post, but I can't avoid saying this any longer—MySpace is a DEEPLY DISTURBING place. It's so disturbing that I'm convinced that the vast majority of the Web 2.0 fan club who gush over MySpace has NEVER actually spent any time on MySpace.” Larry Lessig has never criticized Myspace because passing judgment on porn is as much against his religion as is passing judgment on content theft. Karp continues, “Try doing a Google News search for “MySpace murder” or “MySpace sex” and check out all the stories in reputable local media outlets (which have no obvious ax to grind with MySpace). . . . Still not disturbed? Try spending some time on MySpace. See how long it takes you to find sexually suggestive or explicit content . . . . Or, try going to the MySpace page of Reuters CEO Tom Glocer (which I found via I Want Media). Check out his friends, click around, and see what you make of what you find . . . . I'm going to be accused of fraternizing with Nick Carr for saying this, but this is what you get when you remove all social barriers—you get humanity in the raw . . . . Is this new to the web? Of course not. Is it limited to MySpace? Of course not. Does that mean we should start talking about censorship and regulation? I'm not going to touch that third rail—and I really don't have any answers . . . . I'm not going to do a moral critique of MySpace or Web 2.0 or anything else—that's not my gig . . . . I will say this—my greatest fear of MySpace is as a parent. That's my personal view, which I won't try to foist on to anyone else . . . . But as Web 2.0 watcher, I have a strong view from a business perspective, which leads me to this prediction: Rupert Murdoch will come to regret the purchase of MySpace . . . . Why? Because the reality is that MySpace can't be controlled, and that's a liability . . . . Yes, I know, Web 2.0 is all about “ceding control” to the “edge.” But MySpace pushes this evolution to the extreme . . . . Before you respond, let me be repeat—this is NOT a moral critique. It's a practical, business critique.”

Until he loses his life, and takes to heart those immortal ideals at the base of our Constitution, Karp will remain lost. For to lose one's life is to find it. Again we see that pomo-hipsters are incapable of passing moral judgments, as moral judgments get in the way of the bottom line, just as the Constitution, Shakespeare, and the Bible get in the way of those who plunder and steal from others for a living. As Jesus said, and as Wall Streeters John Bogle quotes in Battle for the soul of Capitalism and Paul Stiles quotes in Is The American Dream Killing You? “No man can serve two masters: for either he will hate the one, and love the other; or else he will hold to the one and despise the other. Ye cannot serve God and mammon.” Thus Karp is impotent in his critique. He is powerless to stem the tide of decline. And that's why it will be up to the rising generation, which is longing for Epic Storytelling across all media, to build the Renaissance. And that is why I am giving them the 45 Revolver—to protect and profit from the renaissance they create. May the Lord ride with them.

Their Kingdom is not of this world—they will build the renaissance independent of Lessig, independent of Murdoch, independent of all the amoral, indifferent MBAs, MFAs, and JDs who man the helms of the postmodem corporation in the same way that the indifferent, characterless sinners ran in endless circles in Dante's first level of hell, chasing banners with corporate logos and false marketing campaigns all designed with one intent—to transfer all the risk to the common worker, the artist, and the creator; and all the wealth to the soulless, postmodern elite, who claim to support the arts to raise taxes, and then do everyting in their power to destroy it. For ye shall know them by their fruits, and look at their fallen culture.

As Dostoyevsky argued, “Without God, anything is permissible,” and that's the amoral premise of the pomo elite. Unfortunately, without God, everlasting art is impossible, and that's why the Renaissance will go to the rising Believers. The 45 Revolver is designed to allow the creators and indie artists to protect their private property—to build their empire piece by piece, bit by bit, reinvesting their profits into their businesses, as Lincoln so eloquently suggested they do. The 45 Revolver shall foster a renaissance in innovation and creation with far-reaching consequences. The 45 Revolver, and the property rights it protects and allows creators to profit from in an improved manner, will be at the heart and soul of the rising renaissance.

Any innovation that leads to such great spiritual and cultural wealth will be granted a patent, and it will father child patents.

Rand writes, “. . . what the patent and copyright laws acknowledge is the paramount role of mental effort in the production of material values; these laws protect the mind's contribution in its purest form: the origination of an idea. The subject of patents and copyrights is intellectual property.” The amoral premise of modem business schools and law schools is to teach that it is one type of person who creates, and another type who owns. Larry Lessig is the logical conclusion of this premise—the creator has to right to protect that which they create, and thus no right to profit from it, as Eminem and 50 Cent remind us. Modem business and law schools have succeeded in taking all the risk out of entrepreneurship—for the elite insiders that is. They risk the investor's money, or the tax dollars, or the tuition, pocket exorbitant fees and salaries while setting up tech transfer departments designed to transfer all the wealth to the permanent MBA bureaucrats and all the risk to the Ph.D. physicists and engineers, pretend to teach something other than socialism as they give one-another rewards, raise taxes, plunder pensions, and smile, smile, and smile. But Hamlet reminds us, “That one may smile, and smile, and be a villain.”

To deny the rising artist the 45 Revolver—an improved method for protecting and profiting from their creations—would make it more difficult for the indie artist to battle the corporate and academic postmodemists to realize a renaissance. Pomo-hipster mob-rule sites, such as myspace, where the artists has little or no rights, are backed by billions of dollars and legions of Lessig's snarky proteges—all of whom get paid handsomely to join in the Constitution's, the Bible's, and Common Sense's deconstruction. To deny the rising artist the 45 Revolver and their Renaissance would be to deny them the Spirit of very Declaration of Independence: “When, in the course of human events, it becomes necessary for one people to dissolve the political bonds which have connected them with another, and to assume among the powers of the earth, the separate and equal station to which the laws of nature and of nature's God entitle them, a decent respect to the opinions of mankind requires that they should declare the causes which impel them to the separation.”

The indie artist—not the bureaucracy—believes in higher ideals—in Beatrice's beauty and Penelope's immortal soul—and sails beyond the corporate and government bureaucracies, to create the works that last. The indie artist shall create and lead the renaissance—the MBA/MFA/JD posses are relegated to creating American Idol, Myspace, and Reality TV, which are definitively void of Epic Story and Higher Ideals, because lawyers have less work where Story naturally prevails. Artistotle said, “when storytelling declines, the result is decadence,” and the decadence of the pomo-hipsters on Wall Street and in Hollywood is supported and funded by the pomo-hispters in government, as their fellow elite's decadence allows the bureaucrats to go to the people to say, “See? We need to increase your taxes to grow the government and create more laws!” The postmodernists' fundamental livelihood is based on growing bureaucracies to augment the problems they claim they can solve. Via short-sighted foolishness, or evil, knowing, cunning, they play this short-term game, enriching the elites for the short-term at the long-term expense to the greater society, denying the common people and the indie artists their natural rights, their property, and their freedoms. Would that it were not so, but humanity will always find a way to build a bureaucracy around an ideal so as to oppose it; and those who are blind to the irony are written letters of recommendation, hired, and made partner after selling their souls and screwing the artist, the creator, and the worker.

To defend against these corruptions, the brilliant Founding Fathers gave us a Constitution with intellectual property rights, the freedom of speech, and the right to bear arms; and in that same Spirit, I give to ye, the indie artist, the 45 Revolver.

Make no mistake, we indie artists just want to live in peace and farm—onn the fruits of our labors. But when the pomo elite bureaucrats manufacture armies of Orcish MBAs and JDs to suck dry the fruits of our labors, we're not going to take it lying own. As the pomo-hipster Kings send their administrative forces of lawyers and MBAs forth to declare Prima Nocte on our IP, we recall the words of William Wallace, “Aye, fight and you may die, run, and you'll get to work as an assistant professor or lecturer . . . at least for a while. And dying in your beds, many years from now, would you be willin' to trade ALL the days, from this day to that, for one chance, just one chance, to come back here and tell our enemies that they may take our wives, but they'll never take . . . OUR FREEDOM!”

The modern form of capitalism resembles communism in many ways, with all the risk transferred to the workers and creators and artists, and the wealth transferred to the lawyers and bureaucrats; sanctified by the media that is owned and operated by the lawyers and bureaucrats. Wall Street's defense against this is, “how could you accuse us of communism?! We work on Wall Street!” It is funny how they defend the classic socialistic, immoral practice of transferring the wealth to the elites and the risk to the worker—“we're not communists—we love money! Both ours and yours! See? We have a lot of money. We're capitalists. What we need is more communism so as to share the wealth. Just give Larry Lessig one more chance—we promise he will get it right this time. All we need to do is raise the common man's taxes just a bit—the common man shouldn't be so damn selfish. Old people can't get medical help, and children don't have fathers, because the common man and indie artist is so damned selfish.” And so it is that the common man, artist, worker, and creator get caught in the cross-fire between amoral business bureaucracies and amoral government bureaucracies, who must fight over the fount of wealth in their zero-sum games—the indie creator and working man.

But the creator and indie artist plays at a table with far higher stakes-it is not a table with a finite number of chips, but it is a table where all lasting wealth is created via innovation and invention—as, “The Poet's eye, in a fine frenzy rolling, Doth glance from heaven to earth, from earth to heaven, and gives to airy nothing, a local habitation, and a name”—the table from where all other chips derive their value. And the indie artist ought have the 45 Revolver, so that they can hold onto more of the chips they create—their rightful inheritance.

The indie artist is the natural fount of wealth, and thus the indie artist ought be provided the optimum combination of technology that affords them the fullest expression of their rights as set forth in the United States Constitution—the right to protect and profit from their creations. Any society concerned about its well-being and long term growth, must protect the rights of the innovative creators, and all individuals, for they are one and the same. The present invention—The 45 Revolver—affords authors, artists, and writers the access to a full spectrum of rights management tools. The present invention salutes every artist, creator, and author, and vows to offer them maximum and optimum protection, distribution, and reach.

Were authors, creators, and indie artists afforded the opportunity to protect their content in the manner described in this present invention, the floodgates of the world would open to new business innovations based upon the present invention. The present invention—The 45 Revolver—could father hundreds of other inventions that serve the creator, and lead to a new generation of the internet. Major corporations and government bureaucracies that oppose the individual's rights, higher aesthetics, and everlasting art and its source will vocally protest such an invention for the sake of their selfish, short-term gains made by corrupting the meaning of the Constitution, and exploiting the indie artist, author, and creator, as lawyers and MBAs have done since the inception of their schools that teach the art of wealth transfer. The postmodern, soulless academies replaced the classical liberal arts education with a dumbed-down curriculum that rewards the mediocre conformists—those willing to lie, cheat, and steal—and sends them off to work at investment banks and media/porn companies, where they degrade the cultural wealth that brave men fought and died for, while transferring all the wealth to the elite insiders, and all the risk to the workers, creators, and indie artists. The 45 Revolver will create untold wealth by helping rising creators fight these trends of decline and decadence.

Furthermore, were authors, creators, and indie artists afforded the opportunity to profit from their creations in the manner described in this present invention, the floodgates of the world would open to new business innovations, and methods of profiting from content. The 45 Revolver will usher in a brand new era of the internet, where indie artists are free to protect and profit from their content.

The present invention is worthy of the Nobel Prize in Economics—far more than all the indecipherable pseudo-mathematics that has been winning the prize in these postmodern times that have deconstructed the cowboy. I'm a physicist—mathematics is a good friend of mine, and economics is not math. The 45 Revolver provides not only the words of a novel concept, but an embodiment of words in the action of the 45 Revolver. The resent invention provides the heart and soul of a tool that will let the creative cowboy ride again, and protect and profit from their artistic works, while also fostering further opportunities for inventors and entrepreneurs seeking to invent the next-generation internet so as to foster and serve Creator's Capitalism.

While Wall Street, academic economists, and Venture Capitalists have proven adept at Aggregators' Capitalism, wherein the lion's share of the wealth is transferred from indie artists and the individual creator to elite groups of venture capitalists, lawyers, MBAs, and non-creators; often in devious, pump-and-dump schemes such as those that transferred $7 trillion dollars from pensions and working-people to Wall Street Bankers and VCs circa 2000, Wall Street and Venture Capitalists have failed at creating a system that supports Creator's Capitalism—a far better long-term investment. Wall Street and postmodern VCs have failed to create a system that would create far greater wealth in a far more moral manner in accordance with the moral premise of the United States Constitution—affording the artist, author, and creator the opportunity to protect and profit from their works. Ideas have consequences, and because of Lessig et al's constant oppositional chattering, blogs, and campaigns against the Constitution and artists' rights, the technology has not lived up to its greater potential, and artists and musicians in Hollywood and beyond have been denied opportunities for systems that allow them to protect and profit from their creations. As a result of diminished opportunities to protect and distribute one's indie creations, rather than having the economy driven via the natural act of wealth creation by ingenuity and entrepreneurship, the Fed had to drive the economy by printing more money—by lowering interest rates and encouraging people to give more of their homes to Wall Street in exchange for paper money. Because the postmodern lawyers are killing the higher ideals—the Constitution and the Great Books—the older generation has to place the younger generation in vast cultural and monetary debt just to survive and feed their leviathan appetites for superficial power, trinkets, porn, and circuses. The 45 Revolver will allow indie artists to own and capitalize on the renaissance they create, reversing the cultural decline. Thus the 45 Revolver will foster vast wealth creation.

At the end of the day, all economies must be viewed as they are—entities that require souls and moral premises to exist, just as humans do. Kill the moral premise, the human will devolve, and the economy, along with the society, will wander off towards tragedy. By taking the dollar off the gold standard, by taking the Constitution of the God standard, and by replacing it all with the postmodem porn standard, elite groups have derived vast short-term profits at the expense of the indie artist, creator, and working man—the preachers, teachers, and firemen who yet Believe. The 45 Revolver is an invention that will operate on many levels, and which will allow the creation of vast amounts of wealth, as it ushers in a cultural and economic renaissance. The 45 Revolver will allow a return to the Constitutional Ideals which many Great Men pledged their Lives, their Fortunes, and their Sacred Honors so that we might enjoy Freedom and Prosperity today.

### Further Discussion of Prior Art and Invention

Red Herring Magazine, in an article entitled, Paid Citizens, Web 2.0 Colonialism?, Volume 3, No. 06 reports, “In a session at the crowded Web 2.0 conference in San Francisco last October, Yahoo CEO Terry Semel said user-generated content ‘is of utmost importance’ to his company—‘A gigantic piece of what we do and ability to monetize.’ In the last year, Yahoo launched a blog service, a ‘publishers' network’ that places ads on users' sites, and bought the popular photo-sharing service Flickr. The portal profits from these services by selling ads to run alongside them or by charging subscription fees. It's revenues rose 47 percent last year to $5.26 billion . . . . Profiting from user-generated content is Web 2.0 Colonialism.” It would take an afternoon for a flick engineer to add watermarking capabilities, and a couple weeks to add the DRM and ecommerce of the present invention, but that would go against the expert's opinion—the spirit of “sharing”—the spirit of feudalism for, and servitude by, the creator.

The 45 Revolver is all about Web 3.0—where content creators make money. And web 4.0 and web 5.0—where movies don't suck. There're all these myths designed to keep the artistic entrepreneur down, and we've got no need for them. The 45 Revolver will allow rising artists to blow the myths away. If you're man enough to create it, you're man enough to profit form it. You're man enough to own it, to define your rights, to control the DRM—you're man enough to profit from it.

There's a pernicious myth perpetuated by the business and law schools that it's one type of person who creates, and another type of person who has the right to profit from it. They started that myth in the business and law schools, as that it how they sell the degrees—they give you the right to steal. The postmodern economists ignore the United States Constitution and promote the science of distributing risk throughout the creators, and all the wealth amongst the MBAs/JDs harvesting the rewards. Sch an inverted society cannot long last, for, as Hamlet said, “O cursed world, is out of joint, my spite, that I was born to set it right.” Every step of the way, every convoluted porno copyright clause and underhanded snub, is designed to transfer wealth from the creator to the non-creator. But I say the United States Constitution is beautiful and profound, and it does us just fine. For unlike porno lawyers and MBAs, the US Constitution is Higher Art.

The creators are not the commodities—the lawyers and MBAs are. Our songs, movies, and books are unique. MBA bureaucracies abound. What? You don't want to invest in us? Well your money's a commodity too. Our art is unique. And now with all this technology—with Rocky Raccoon's 45 Revolver, we can walk into town, define our rights and launch our creations into thousands of portals—the thousands of portals that had been designed to treat artist and creators as commodities—as widgets.

Well, to the degree an MBA lacks talent, they view art as a widget, as a risk—they view creators as a great herd of prima-donnas to be grouped together in some social network where they can fight it out and enrich the owners of the network.

But we artists know where the real risks lie—dealing with MBA bureaucracies. We know that our art is no risk—it is our heart and our soul. For those who have no choice but to serve Eternity, MBA bureaucracies pose the greatest risks. It might not fetch a fair price on the trading floor at the NYSE today—it might fetch nothin', but we're calling the bluff. For our art is unique, and social networks and web 2.0 content sites are a dime a dozen. With the 45 Revolver, we're walking right on in and sitting down at those tables where we had never been allowed before, and we're calling the bluff. Art is the Ace of Spades in this game, and sitting here there's something else I see—you've been playing with our chips.

Red Herring Magazine, in an article entitled, Paid Citizens, Web 2.0 Colonialism?, Volume 3, No. 06 reports, “That's great for Yahoo, but what about the users who create the content? That question is raised by Anil Dash, a well-read blogger (dashes.com) and VP of professional products at the largest independent blogging company, SixApart. In a post last October, Mr. Dash discussed Flickr's process of classifying users' pictures by their ‘interestingness’—a combination of the comments, tags, click-throughs, and favorites associated with a photo. ‘Is interesteningness its own reward?’ asked Mr. Dash, suggesting users might be compensated with money or some other kind of value . . . . Paul Mooney (dotnetjunkies.com/weblog/paul/) summed up many people's thoughts in his comment: ‘Profiting from user-generated content is Web 2.0 Colonialism.’”

Many corporate and academic elites will rage and blow against the 45 Revolver, as they detest its moral premise and the very notion of a moral premise, as it gets in the way of their bottom line. The tenured priests are busy tenuring and promoting all the creative mediocrities who write law-review papers opposing the noble invention and the United States Constitution, but by Time and the Power of God, their words will be rendered useless as the moral context upon which this nation was conceived and founded, prevails. For as Abraham Lincoln said, “Those who deny freedom to others, deserve it not for themselves; and, under a just God, can not long retain it.” The postmodern lawyers and elites cannot long deny the artists and creators their fundamental economic freedom, for without economic freedom, there is no freedom. And artists, not lawyers, are who define our freedom, for as the poet Shelley noted, “Those who imagine and express indestructible order, are not only the authors of language and music, of the dance, and architecture, and statuary, and painting; they are the institutors of laws and the founders of civil society, and the inventors of the arts of life, and the teachers, who draw into certain propinquity with the beautiful and the true that partial apprehension of the agencies of the invisible world which is called religion.” Artists, and art, cannot exist without freedom, and where everlasting art is denied, so is civil society. Artists must be guaranteed the freedom to protect and profit from their innovations, and that is what the 45 Revolver gives them, in a novel and previously unseen manner.

Freedom—the freedom to protect and profit from one's property—is a divine right. Thomas Jefferson reminds us, “We hold these truths to be self-evident, that all men are created equal, that they are endowed by their Creator with certain unalienable Rights, that among these are Life, Liberty and the pursuit of Happiness. That to secure these Rights, Governments are instituted among Men, deriving their just Powers from the Consent of the Governed, that whenever any Form of Government becomes destructive of these Ends, it is the Right of the People to alter or to abolish it, and to institute new Government, laying its Foundation on such Principles, and organizing its Powers in such Form, as to them shall seem most likely to effect their Safety and Happiness.”

And thus the 45 Revolver serves the spirit of The Declaration of Independence.

Jefferson once wrote that “a lively sense of filial duty is more effectively impressed on the mind of a son or daughter by reading King Lear, than by all the dry volumes of ethics, and divinity, that ever were written.” So it is that art, and Epic Story, are of utmost importance o a civil society. So it is that the individual artist's rights must be protected, and they must be able to profit from the fruits of their labor. Shelley, the famous poet, agreed, and I quote him in the opening paragraph at starbuck.com:

The Starbuck Classical Poetry Port was inspired by a mystical memory which has haunted me ever since this foggy May night by the Corolla Lighthouse, which can be found just North of Duck, on the outer banks of North Carolina. The Lighthouse can be found there, while the memory resides here. Hoping to climb the spiral stairs in the Corolla Light, Misty and I had hopped the criss-cross wooden corrale fence so as to see if the door to the Light was unlocked. Not only was this a first date with a totally awesome girl, but it also happened on that same gothic night that I was introduced to Moby Dick. Now a lot of people might contend that Moby Dick is a novel, rather than a poem, but as of late I have been staying up to all hours of the morning studying the subject, and I say that Poetry is the music of the rational soul, the ultimate expression of the spirit's reality, and a mirror of the intangible, phantasmal essence of our existence. Poetry is found in all the magnificent works which define the fundamental words at the foundations of all our laws, convictions and conventions, our morality, our conscience, and our sense of divinity. Shelley himself declared that poets are the unacknowledged legislators of mankind, and I contend that one can find no noble milestones in history which were not preceded by the spoken or written work of an individual who had the courage to render a bold new vision in words. Though it is often endowed with rhyme and meter, poetry derives its everlasting glory from the depths of the profundities it preserves. Thus the classical poets, who we shall dedicate all the Classicals Inc. websites to, range in character from Shakespeare, to Plato, to St. Augustine, to Thomas Jefferson, to the Prophets, to Herman Melville, to Kipling, to Salinger. And though lacking corporeality, all Great Poetry is as solid and permanent as the rock of the eternal soul.

In The Natural Aristocracy, Thomas Jefferson wrote to John Adams from Monticello, on Oct. 28, 1813. “I agree with you that there is a natural aristocracy among men. The grounds of this are virtue and talents. Formerly, bodily powers gave place among the aristoi [aristocrats]. But since the invention of gunpowder has armed the weak as well as the strong with missile death, bodily strength, like beauty, good humor, politeness, and other accomplishments, has become but an auxiliary ground for distinction. There is also an artificial aristocracy, founded on wealth and birth, without either virtue or talents; for with these it would belong to the first class. The natural aristocracy I consider as the most precious gift of nature, for the instruction, the trusts, and government of society. And indeed, it would have been inconsistent in creation to have formed man for the social state, and not to have provided virtue and wisdom enough to manage the concerns of the society. May we not even say, that that form of government is the best, which provides the most effectually for a pure selection of these natural aristoi into the offices of government? The artificial aristocracy is a mischievous ingredient in government, and provision should be made to prevent its ascendency . . . . I think the best remedy is exactly that provided by all our constitutions, to leave to the citizens the free election and separation of the aristoi from the pseudo-aristoi [pseudoaristocrats], of the wheat from the chaff. In general they will elect the really good and wise. In some instances, wealth may corrupt, and birth blind them, but not in sufficient degree to endanger the society.”

Lessig, Murdoch, et al are doing everything possible to bolster their artificial aristocracies at the expense of the natural aristocracy made up of indie artists and creators. Hollywood is in decline because there is too much nepotism—somebody knows somebody who was a student of Larry Lessig's and they get to write the rewrite of some seventies sitcom. This heartless, soulless system is as incapable of producing art as is myspace is incapable of creating bands, and society suffers. The 45 Revolver will allow Jefferson's “natural aristocracy”—the indie artists, creators, and working mena and women—to defend their rights against the feudal MBA/MFA/JD nobility of Lessig's and Murdoch's artifiticial aristocracy.

Abraham Lincoln, the “eloquent president,” also said, “We have, as all will agree, a free Government, where every man has a right to be equal with every other man. In this great struggle, this form of Government and every form of human right is endangered if our enemies succeed.” So it is that every indie creator and artist ought be provided the same rights as Steven Jobs, Google, and Microsoft. Lincoln says, “I have never had a feeling, politically, that did not spring from . . . The Declaration of Independence . . . that all should have an equal chance. This is the sentiment embodied in The Declaration of Independence . . . I would rather be assassinated on this spot than surrender it.” And so it is that the 45 Revolver is dedicated to giving every artist, author and creator an equal chance to protect and profit from their content.

Yardley.ca states, “Profiting off user-generated content is Web 2.0 colonialism . . . . I suspect that the omission of a payment mechanism is deliberate, and that the biggest proponents of Structured Blogging are just looking for new ways to aggregate a lot of content, use it to build up a valuable userbase, and sell, generating nothing for us-plain-folks but ‘a bigger megaphone.’”

Ethan Zuckerman writes at http://ethanzuckerman.com/blog/?p=468, “My buddy Boris has an excellent recent post titled, “It's not about you”. He argues that the rise of Web 2.0 businesses—which build communities around content users post to the sites—shouldn't fool you into thinking that these companies care about you. They don't—they care about your bits.” Boris writes at http://bopuc.levendis.com/weblog/archives/-2006/03/28/its_not_about_you.php, “But that's not what the bankrollers are on about. They don't care about your newfound ability to publish your thoughts or your pictures. They are just glad that you are doing so. Why? Because in an information based economy, data is your primary natural source. And flow of data creates movement which can be harnessed. Like a water-mill. The difference is that these millers don't need to go find a river: they can make one. And that's what sites like Flickr, del.icio.us, Upcoming, YouTube, Newsvine and the lot of them, have done. Centralize, centralize, centralize. Concentrate and control. What that means: 1—your data is not under your direct control. 2—what is done with your data, is not under your direct control. So what? What are these people doing with your data? It's pretty simple: they use it to drive advertising revenues. We are all working for them. For free. That's how it's ‘about we.’ It's not a ‘media revolution,’ it's a reversion to feudal medievalism. ‘Voluntary servitude’ it's been called (back in 1548!) (This is worth a read too though it has quite a Marxist taste to it.”

The 45 Revolver stands head and shoulders of the above mentioned Web 2.0 companies, as it provides the creator superior freedom-freedom to watermark, encrypt, and syndicate their content throughout the entire web. The fount of all wealth is the indie spirit—give them the method to protect and profit from their creations in this invention, and the rising tide will lift all boats.

Boris characterizes the favorite argument of Lessig, Murdoch et al. by which the postmodern lawyer and MBA transfer all the wealth to themselves, and all the risk to the creator—“The counter argument is ‘but they are providing a service which in order to survive must sustain itself economically somehow, and you free information people are the first to yell ‘information wants to be free’ and so it is and we can't rely on subscription or pay-per-content schemes.’ Totally fair. And services like all the above mentioned all do fairly decent jobs of providing ways to export and retrieve your data. One way or another, you gotta pay to play, right? The malaise remains however: they are profiting from our ignorance (or forgetfulness). Whether it is ignorance of their actions or ignorance of your abilities (to do any of this yourself in a de-centralized way) or rights.”

The 45 Revolver naturally educates the user with their natural rights, and affords them a simple and easy means for protecting and profiting from their content.

The present invention is meant to level the playing field for the indie artist, author, and creator. The 45 Revolver bypasses all the traditional and Web 2.0 middlemen to simply afford the artist and inventor with the method to protect and profit from their work.

In his book The Great Risk Shift: The Assault on American Jobs, Families, Health Care, and Retirement—And How You Can Fight Back, Jacob S. Hacker characterizes how the postmodern elite's primary goal is to transfer all the risk and work to the indie artist and creator—the working man—and take all the wealth for themselves. The postmodern elite fly Corey Doctorow and Larry Lessig around to conference after conference after conference, so they can lecture the masses on the virtues of voluntary servitude. Lou Dobbs has noticed the “Lessig Bait & Switch” as well, as he reports in his book, War on the Middle Class: How the Government, Big Business, and Special Interest Groups Are Waging War on the American Dream and How to Fight Back.

Modem law and MBA schools are akin to the Mordor factories that manufactured Orcs to terrorize the land. Modern law schools, business schools, and MFA programs are manufacturing a postmodern elite based on rich mediocrity—rich by the money that is printed. But as one can print money, but not honor, integrity, art, and Truth, the 45 Revolver is betting on the latter.

The same classical values guiding the rising artistic renaissance will protect the artists' intellectual property. The immortal ideals which guide the story of blockbuster books and movies such as The Matrix, Lord of the Rings, Braveheart, The Chronicles of Narnia, and Star Wars, are the very same ideals underlying the United States Constitution. These classic ideals—which pervade Homer, Plato, Shakespeare, and the Bible are the source of both epic story and property rights, of law and business, of academia and civilization. It is great to witness classical ideals performed in Middle Earth, upon the Scottish highlands, long ago, in a galaxy far, far, away, and in Narnia, but too, such ideals must be perpetually performed in the contemporary context and living language. The 45 Revolver shall be powered by the same classical ideals as the art which it protects.

While one possible way to stop piracy would be to have Lessig and Doctorow and all the myspace mobs and MFAs create all art from here until doomsday, thusly removing all the incentives to copy content, the 45 Revolver sees the future of art differently. The 45 Revolver is anticipating the massive rising renaissance, wherin creators will wish to protect and profit from their content. Those who adhere to classical ideals shall eventually make it on home, as Odysseus did, while the rest shall be lost, as Odysseus's men were. He tried to help them ,but they just wouldn't listen. And just as Odysseus strung the bow and killed all the false Suitors hitting on his wife and laying his riches to waste, the honest Creator shall find the 45 Revolver of great use in fighting off the legions upon legions of the postmodern elite who are plundering pensions, marketing fake and plagiarized novels and memoirs, and screwing midgets and video taping acts of anal sex to augment book sales-ye shall know them by their fruits—as Simon and Schuster (Viacom) has its authors do. It is no coincidence that the blogger with a bestselling book who screws midgets and video tapes anal sex to succeed in the attention economy is a graduate of Duke University Law School—home of the Center for the Study of the Public Domain—a program devoted to ripping content out of the creators' hands, reaping all the benefits, and using promises of right to transfer wealth to jack up the price of a law degrees that allows the JD to be superior to the Creator. The 45 Revolver, by respecting the higher ideals by which all everlasting, romantic art is penned and promoted, and by which Natural Property rights are protected, shall open the floodgates for a renaissance of exalted entertainment and entrepreneurship.

Communists like their porn as much as their pretensions, and the bestselling blogger—a creation of feminist academia—was given a scholarship. Everyone ought read Hayek's The Road to Serfdom, with an introduction by Milton Friedman, and commit the chapters entitled The End of Truth and Why The Worst Get on Top. The first chapter explains the Center for the Study of The Public Domain, and the second explains the story regarding the filming of the anal sex scene, which was originally published in a book via a company founded by the same fellow who donated a fair sum of money to The Center for the Study of the Public Domain—money that was gotten in the great dot-con pyramid scheme which robbed investors of seven trillion with deceit and treachery. But that is what happens when the Bible is replaced with Sperm Wars. “How all occasions do inform against me,” Hamlet says. Make no mistake—the elite boomers love the matrix they have created—they deconstruct and rage against all higher ideals, take women out of the home and have them work and have meaningless sex during their child-bearing years, prostitute their daughters to short-term corporate values, pit all the honest engineers and creators against one-another, try to corral the creators in little rooms with false promises of security and fake pensions, and profit immensely while the greater culture declines. But yet, the Renaissance will yet be, and the 45 Revolver will allow indie artists to operate independently of their communistic corporations corrupting the original Spirit of Capitalism—abusing the rights and taking the wealth of others. So it is that central planning and decline walks hand-in-hand with opposition to God, religion, Truth, and freedom as defined in the United States Constitution and the words of the Founding Fathers. The 45 Revolver, by respecting fundamental property rights and placing the power of the technology in the creator's hand, will go a long ways in furthing a renaissance based on the spirit of the original founding Father's intent. Franklin wrote, “I have lived, a long time, and the longer I live, the more convincing proofs I see of this truth—that God Governs in the affairs of men. And if a sparrow cannot fall to the ground without His notice, is it probable that an empire can rise without His aid?“Thomas Jefferson wrote,”The doctrines of Jesus are simple, and tend to all the happiness of man . . . . Of all the systems of morality, ancient or modem which have come under my observation, none appears to me so pure as that of Jesus . . . . I am a real Christian, that is to say, a disciple of the doctrines of Jesus . . . . God who gave us life gave us liberty. And can the liberties of a nation be thought secure when we have removed their only firm basis, a conviction in the minds of the people that these liberties are a gift from God? That they are not to be violated but with His wrath? Indeed I tremble for my country when I reflect that God is just, and that His justice cannot sleep forever. [Notes on the State of Virginia, 1781] . . . . It [the Bible] is a document in proof that I am a real Christian, that is to say, a disciple of the doctrines of Jesus.” Alexander Hamilton wrote, “In my opinion, the present constitution is the standard to which we are to cling . . . . Let an association be formed to be denominated ‘The Christian Constitutional Society,’ its object to be first: The support of the Christian religion. Second: The support of the United States.” Patrick Henry wrote, “The great pillars of all government . . . [are] virtue, morality, and religion. This is the armor, my friend, and this alone, that renders us invincible.”” Thomas Paine wrote, “The cause of America is in a great measure the cause of all mankind. Where, say some, is the king of America? I'll tell you, friend, He reigns above.” George Washington said, “While just government protects all in their religious rights, true religion affords to government its surest support.” James Madison said, “.” Abraham Lincoln sid “What constitutes the bulwark of our own liberty and independence? It is not . . . the guns of our war steamers, or the strength of our gallant and disciplined army . . . our reliance is in the love of liberty which God has planted in our bosoms.” Daniel Webster said, “Daniel Webster: “God grants liberty only to those who love it, and are always ready to guard and defend it.” It is no wonder then that the postmodern hipster lawyer detests the Founding Fathers, who penned the very Constitution they desecrate. The 45 Revolver will help the architects of the rising renaissance live out the ideals of The Constitution and Declaration of Independence, defend their intellectual property against the lawyer/MBA/pomo-hipster/porn class. Frederick Douglass said, Those who profess to favor freedom, and yet deprecate agitation, are men who want crops without plowing up the ground. They want rain without thunder and lightning. They want the ocean without the awful roar of its waters. This struggle may be a moral one; or it may be a physical one; or it may be both moral and physical; but it must be a struggle! Power concedes nothing without a demand. It never did, and it never will. Find out just what people will submit to, and you have found out the exact amount of injustice and wrong which will be imposed upon them; and these will continue until they are resisted with either words or blows, or with both. The limits of tyrants are prescribed by the endurance of those whom they oppress.” JAMES MADISON: “We have staked the whole future of American civilization, not upon the power of government, far from it. We have staked the future . . . upon the capacity of each and all of us to govern ourselves, to sustain ourselves, according to the Ten Commandments of God.” JOHN ADAMS wrote, “Our Constitution was made only for a religious and moral people. It is wholly inadequate for the government of any other.” Benjamin Franklin wrote, “Virtue is not secure until its practice has become habitual.” ANDREW JACKSON wrote “The BIBLE is the rock on which our Republic rests.” DANIEL WEBSTER wrote, “If we abide by the principles taught in the BIBLE, our country will go on prospering.” ALEXIS DE TOQUEVILLE wrote, “America is great because America is GOOD. If America ever ceases to be good it will cease to be great.” Finally, BENJAMIN FRANKLIN wroter: “Man will ultimately be governed by GOD or by tyrants,” and that is why the 45 Revolver is needed, so that the indie artists and creators—the founts of all true wealth and the unacknowledged legislators of mankind, might be able to protect and profit from their private property. For technology ought support God's will, and God gave every man the right to protect and profit from their creations. Those who reference the United States Constitution and the Declaration of Independence can say nothing less, without being liars. The cultural and monetary value of the present invention—a device that will allow a generation to build a Renaissance and live the American Dream, cannot be underestimated. The rising generation will be afforded the opportunity to rock a Hollywood Renaissance, and write profound poetry independent, independent of the will of the postmodern state and corporations to control all art and tax and destroy every entity that exalts ad entertains via The Truth.

The showdown will be quite a spectacle to watch, and I'm putting all my money on the companies, artists, and creators using the 45 Revolver against the gangs of thugs, porno lawyers, and postmodern bureaucracies, just as Clint Eastwood faced the Roho gang as a lone gunman with his 45 Revolver in Sergio Leone's classic Fistful of Dollars—a movie shot for $200,000 that soulless Hollywood could not duplicate with a billion dollars today. I'd bet on Fifty Cent, who quotes the Bible in his art, against Larry Lessig any day. Here's how it went back then, and how it shall go for the indie artists with the 45 Revolver:

“When a man with a rifle meets a man with a 45 Revolver, the man with the 45 Revolver ends up dead.”—Ramone

“I'll stick with my 45 Revolver,” says Clint Eastwood as The Man With no Name, from Sergio Leone's A Fistful of Dollars.

Odysseus too was a “man with no name” when he rode back into town over 2800 years ago. Those who think that myspace or Lessig or bully MBAs have a chance against the lone creator with a 45 Revolver are fools who will not last long in the Renaissance.

It is no wonder that Hollywood banning the classic Western, academia banning the Odyssey, and Larry Lessig wishing to ban property rights for artists and creators have all coincided. Like the cave-dwellers in Plato's cave, Lessig et al all see one foot in-front of them, and thus are subject to group think and believing whatever they tell themselves in the postmodern fog that hides all the higher ideals—the ever-fixed stars. So it is that content creators have no property rights in the Web 2.0 arena, while Tim O'reilly goes out and trademarks the term “Web 2.0.” Go figure.

At the end of Sergio Leone's masterpiece, which broke Eastwood and established him as an international star, Eastwood says to the lead gangster Ramone, after shooting five of his men in a typical six-on-one showdown that the indie artist and innovator always faces, “When a man with 45 meets a man with a rifle, you said, the man with a pistol's a dead man. Let's see if that's true. Go ahead, load up and shoot.”—The Man with No Name from Leone's A Fistful of Dollars.

When every artist is given a 45 Revolver, let's see how long the pomo-hipster snarkiness lasts. Let's see how long the Hollywood remakes hog all the theaters. Let's see how long the MFA/MBA/JD conglomerates market crap and pilfer pensions. A lawyers's got to know his limitations, so go ahead—make my day.

The 45 Revolver, by ushering in a renaissance in property rights, every bit as great as the renaissance in production and distribution, will foster a renaissance in epic storytelling. Classic westerns will ride once again, along with novels that have cowboys and contemporary heroes fighting for the True, and faithful women every bit as glorious as Beatrice, Penelope, and Audrey Hepburn. The 45 Revolver, via its novel manner of affording a superior means for protecting and profiting from content, will usher in a vast and resounding cultural renaissance, of great monetary and spiritual value. Ideas have consequences, and God bless the United States Constitution that gives us the right protect and profit from our innovations, and the first and second amendments that empower the individual to speak out against evil and take up arms against it when necessary. May the 45 Revolver serve you well, for the rising generation is longing for a renaissance in epic storytelling—go forth and give it to them. And protect and profit from the fruits of your labor.

The digital media revolution has collapsed the distance between art, business, law, and media technology programs, and students are longing for those general permanent principles found within the pages of the Great Books. With a flagship AE&T program founded upon the classics, innovative companies that use the 45 Revolver could become vanguards in reviving the lost art of the liberal arts education, while reviving the fallen culture in which more households are composed of none-families than are composed of families—that fundamental brick of God's higher civilizations.

Throughout the greater culture, there exists a longing for contemporary heroes and heroines in literature reflecting those brave men and women wearing uniforms in real life. There exists a longing for epic stories in our books, movies, and video games, and for digital rights management software and systems based on the Founding Fathers' idealism. And thus there exist vast opportunities for rugged artistic entrepreneurs to lead renaissances on all fronts. These entrepreneurs will need a means to protect their property rights from pirates, youtube uploaders, and Web 2.0 activists such as Larry Lessig and all the prior art his philosophies have resulted in. These cultural entrepreneurs shall find the 45 Revolver a most useful tool in building the Renaissance.

For a time many have been tempted to forget classical ideals, valuing short-term profits over long-term wealth, exalting the bottom line over the higher ideals; but the nascent brilliance of the technological revolutions can only achieve its fuller potential via Story. While many will suggest that the best solution to digital rights management is to remove story from movies, as Hollywood has dedicated itself to as of late, thusly removing incentive to pirate them, I counter that classical ideals can enhance both the storytelling within movies and the DRM that protects them.

Just as the Founding Fathers complimented property rights by providing everyone with the right to bear arms, a novel software system that provides all creators with a turnkey choice from a full spectrum of digital rights management would foster a renaissance in the creation and distribution of intellectual property and art. The name of this software is the 45 Revolver, and the killer app could lead next-generation social networks and content portals that would benefit Hollywood—from the indie filmmakers to the major studios. Let's build it. Let's build tomorrow's ecommerce portals—tomorrow's books, movies, video games, and culture upon classical ideals.

That distant wave has been a long time coming, and the new fashions will be about performing the classical ideals in the contemporary context. The rising generation will lead a renaissance in storytelling; a renaissance in the composition, production, and distribution of art, a renaissance in business, culture, and civilization; in academia and entrepreneurship. For that is the artistic entrepreneur's duty.

Professional education is creating the postmodern lying class discussed at length in Hacker's and Dobb's books. These postmodern nobles, who gain their power via snark, hype, and lies, are akin to the Scottish nobles in Braveheart. When Universities try to teach entrepreneurship, they twist fundamental American Entrepreneurship that is so integral to the American soul beyond recognition, until it becomes socialism, which by any other name would still be communism, which must destroy the indvidual's property rights for the greater good. Upon receiving millions from a foundation, the bureaucrats reason thusly, “The problem with entrepreneurship . . . is that there are too many entrepreneurs. If we can't get them out, we'll breed them out. The MBA/JDs in our technology-transfer department shall have first rights to the entrepreneurs' inventions and the artists' art, and we'll create the myth that it's one type of man suited to creating, and another suited to owning, by any means necessary—and we'll sell he latter MBAs and law degrees.” This reasoning by the postmodern academic leadership echoes of the reasoning of Longshanks from the movie Braveheart, “. . . The trouble with Scotland is that it's full of Scots. (Everyone laughs except Princess Isabella) Perhaps the time has come to reinstitute an old custom. Grant them prima noctes: first night. When any common girl inhabiting their lands is married, our nobles shall have sexual rights to her on the night of her wedding. If we can't get them out, we'll breed them out. That should fetch just the kind of lords we want to Scotland, taxes or no taxes.”

Artists just want to make an honest living, as William Wallace did in Braveheart, but the nobles just won't let them.

Whenever socialists get money to teach entrepreneurship, they teach “ironic” entrepreneurship, which means they flat out lie. They receive millions of dollars from some foundation, and they divvy it up amongst the usual suspects—all the boomers who live in the big houses close to the sprawling campus, which is a real estate company, always grabbing land to justify higher taxes. Their primary goal is to build as many buildings possible, to justify tax and tuition increases, all in the name of entrepreneurship. Giving million dollar grants to socialists to teach entrepreneurship is like giving kerosene to firemen to put out fires. Hamlet reminds us, “Ay, truly; for the power of beauty will sooner transform honesty from what it is to a bawd than the force of honesty can translate beauty into his likeness: this was sometime a paradox, but now the time gives it proof. I did love you once,” but Shakespeare is not taught in business nor law schools, and I am not even sure that one is allowed to quote the Bard in a patent application. I pray that the patent is not revoked because of this, and I hope that one is still allowed to pray in a patent application, for the Declaration of Independence—a most fundamental legal document yet says—“When in the Course of human events it becomes necessary for one people to dissolve the political bands which have connected them with another and to assume among the powers of the earth, the separate and equal station to which the Laws of Nature and of Nature's God entitle them, a decent respect to the opinions of mankind requires that they should declare the causes which impel them to the separation. We hold these truths to be self-evident, that all men are created equal, that they are endowed by their Creator with certain unalienable Rights, that among these are Life, Liberty and the pursuit of Happiness.” And too, the Bill of Rights, a most fundamental legal document, yet states, “Congress shall make no law respecting an establishment of religion, or prohibiting the free exercise thereof; or abridging the freedom of speech, or of the press; or the right of the people peaceably to assemble, and to petition the Government for a redress of grievances.” And too, it states, “A well regulated Militia, being necessary to the security of a free State, the right of the people to keep and bear Arms, shall not be infringed.” Hence the 45 Revolver—a novel innovation that allows creators to protect and profit from their creations.

The 45 Revolver will give all the creators a fighting chance to protect and profit from their creation, instead of some Web 2.0 company run by the postmodern MBA/JDs from the Mordors that are Harvard and Stanford. Regarding the army of amoral postmodern MBAs/JDs, who are given licenses to become agents who steal from the common creator and the common worker, John Bogle, the founder of the world's largest mutual fund, states, “Once an ‘ownership society’ in which direct owners of stock held voting control over corporate America, we have become an ‘agency society,’ and we are not going back. But the agents—largely mutual fund managers and pension fund trustees—have failed to represent, first and foremost, their principals—pension beneficiaries and owners of mutual fund shares. These intermediaries consume far too large a portion of whatever returns our corporations and our financial markets are generous enough to provide, with far too small a portion of these returns delivered to the last-line investors who have put up all of the capital and assumed all of the risks. Curiously enough, what has happened to our system of capitalism is precisely what this university's great founder warned us about two centuries ago. Hear Thomas Jefferson: ‘I hope we shall crush in its birth the aristocracy of our moneyed corporations which dare already to challenge our government in a trail of strength, and bid defiance to our laws.’” We didn't do that, and here are nine quick examples—three each from corporate America, investment America, and mutual fund America—that reflect the negative consequences of this change.”

Bogle describes the postmodern feudalism, posing as capitalism, that the snarky, ironic elites are promoting so as to transfer wealth from the creators to the communists, sending Larry Lessig forth to extol the virtues of sharing content under his communistic licenses, while the elite lawyers and MBAs plunder the pensions. So it is that the 45 Revolver will help the creator to protect and profit from the wealth they create, and fight back. For the freedom of speech is worth nothing without the right to bear arms—‘tis why the founding Fathers gave us the second amendment.

The Founding Fathers—those who penned that fundamental legal and business document—the Constitution—never attended law school nor business school—instead they read the Great Books and Classics. But today the Great Books and Classics have been banned throughout all of academia. This makes it far easier for lawyers to find anything they're paid to find in the Constitution, including abortion, socialism, the right to lie, the right to steal another man's property, and the right to legislate against digital rights management.

The freedom to publish and distribute, which the internet does an adequate job of, is akin to the First Amendment, “Congress shall make no law respecting an establishment of religion, or prohibiting the free exercise thereof; or abridging the freedom of speech, or of the press; or the right of the people peaceably to assemble, and to petition the government for a redress of grievances.” The freedom to protect and profit from one's private property, which the massive corporations and government bureaucracies have hired Lessig et al to attack, diminish, and destroy, is akin to the Second Amendment.

The present invention—The 45 Revolver—is meant to restore the creator's natural rights, “A well regulated militia, being necessary to the security of a free state, the right of the people to keep and bear arms, shall not be infringed.”

Hollywood has no idea why Lessig et al oppose indie creators such as J. R. R. Tolkien, George Lucas, Harlan Ellison, and every other indie author, artist, creator, and innovator. Lessig et al are working hard towards the death of the professional writer, and towards a society where all writing is equal, except for their own tax, tuition, and corporate subsidized writing, which is more equal, because it raised the bureaucracy's bottom line by denying the Creator their fundamental rights. The 45 Revolver salutes authors such as Harlan Ellison, who writes, in all caps, a letter aimed at Larry Lessig, Cory Doctorow, et al, concerning the court case: Harlan Ellison v. Stephen Robertson, America Online, Inc., RemarQ Communities, Inc., Critical Path, Inc., Citizen 513, and Does 1-10, Federal District Court, Central District of California Civil Case No. 00-04321 FMC (RCx), 22 Feb. 2001:

At http://harlanellison.com/KICK/kick rls.rtf, the famous author Harlan Ellison writes in all caps in a document entitled HARLAN ELLISON FIGHTS FOR CREATORS' RIGHTS, “FOR THE PAST TEN MONTHS MY ATTORNEY, M. CHRISTINE VALADA, AND I HAVE BEEN HIP-DEEP FIGHTING A LEGAL BATTLE, WHAT WE THINK IS AN EXTREMELY IMPORTANT CASE: TO PROTECT WRITERS' CREATIVE PROPERTIES.”

“WE FILED A LAWSUIT AGAINST THE ABOVE PARTIES TO STOP THEM FROM POSTING MY WORKS ON THE INTERNET WITHOUT PERMISSION. THIS IS COPYRIGHT INFRINGEMENT. RAMPANT. OUT OF CONTROL. PANDEMIC.”

“AOL, REMARQ/CRITICAL PATH AND A HOST OF SELF-SERVING INDIVIDUALS SEEM TO THINK THAT THEY CAN ALLOW THE DISSEMINATION OF WRITERS' WORK ON THE INTERNET WITHOUT AUTHORIZATION, AND WITHOUT PAYMENT, UNDER THE BANNER OF “FAIR USE” OR THE IDIOT SLOGAN “INFORMATION MUST BE FREE.” A WRITER'S WORK IS NOT INFORMATION: IT IS OUR CREATIVE PROPERTY, OUR LIVELIHOOD AND OUR FAMILIES' ANNUITY. WHY SHOULD ANY ARTIST, OF ANY KIND, CONTINUE CREATING NEW WORK, EKING OUT AN EXISTENCE IN PURSUIT OF A CAREER, FOLLOWING THE MUSE, WHEN LITTLE INTERNET THIEVES, RODENTS WITHOUT ETHIC OR UNDERSTANDING, STEAL AND STEAL AND STEAL, CONVENIENCING THEMSELVES AND “SCREW THE AUTHOR”? WHAT WE'RE LOOKING AT IS THE DEATH OF THE PROFESSIONAL WRITER!”

“THIS IS NOT ONLY MY FIGHT, I'M NOT THE ONLY ONE WHOSE WORK IS BEING PIRATED. HUNDREDS OF WRITERS' STORIES, ENTIRE BOOKS, THE WORK OF A LIFETIME, EVERYONE FROM ISAAC ASIMOV TO ROGER ZELAZNY: THEIR WORK HAS BEEN THROWN ONTO THE WEB BY THESE SMARTASS VANDALS WHO FIND IT AN IMPOSITION TO HAVE TO PAY FOR THE GOODS. (BUT GAWD FORBID YOU TRY TO APPROPRIATE SOMETHING OF THEIRS . . . LISTEN TO 'EM SQUEAL!) THE OUTCOME OF THIS CASE WILL AFFECT EVERY WRITER, EDITOR, PHOTOGRAPHER, ARTIST, MUSICIAN, POET, SCULPTOR, ACTOR, BOOK DESIGNER, PUBLISHER AND READER. WHAT WE'RE LOOKING AT IS THE ANARCHY OF IGNORANT THIEVES RIPPING OFF THOSE WHO LABOR FOR AN HONEST PAYDAY, BECAUSE THEY CONVENIENTLY HONOR THE LIE THAT EVERYTHING SHOULD BE THEIRS FOR THE TAKING.”

“LOOK, THIS IS YOUR FIGHT, TOO. IF THAT DEMENTED, SELF-SERVING MISUNDERSTANDING OF THE WORD “INFORMATION” PREVAILS, AND EVERY ZERO-ETHIC TOT WHO WANTS EVERYTHING FOR NOTHING, WHO EXISTS IN A TIME WHERE E-COMMERCE HUSTLERS HAVE CONVINCED HIM/HER THAT THEY'RE ENTITLED TO EVERYTHING FOR NOTHING PREVAILS, AND THEY ARE PERMITTED TO BELIEVE INFORMATION MUST BE FREE, WITH NO DIFFERENTIATION MADE BETWEEN RAW DATA AND THE CREATIVE PROPERTIES THAT PROVIDE ALL ARTISTS OF ANY KIND WITH AN ANNUITY, TO ALLOW THEM TO CONTINUE CREATING NEW WORK, THEN WHAT WE'RE LOOKING AT IS THE EGREGIOUS INEVITABILITY OF NO ONE BUT AMATEURS GETTING THEIR WORK EXPOSED, WHILE THOSE WHO PRODUCE THE BULK OF ALL PROFESSIONAL-LEVEL ART FIND THEY CANNOT MAKE A DECENT LIVING.”

“DO NOT, FOR AN INSTANT, BUY INTO THE CULTURAL MYTHOLOGY THAT ALL ARTISTS ARE RICH. A FEW ARE, BUT MOST HAVE A HARD ROW TO HOE JUST SUBSISTING, HOLDING DOWN SECOND JOBS. MOST CREATORS PRACTICE THEIR ART BECAUSE THEY LOVE IT. IF IT WERE ONLY FOR THE BUCKS, THEY'D FARE BETTER AS DENTISTS, PLUMBERS, OR STEAM FITTERS. I'M FIGHTING FOR MYSELF, OF COURSE, BUT I'M ALSO DOING THIS FOR AVRAM DAVIDSON, WHO DIED BROKE; FOR ROGER ZELAZNY, WHO HAD TO WORK LIKE A DOG TILL THE DAY HE PITCHED OVER; AND FOR GERALD KERSH, WHOSE WORK WAS REPRINTED AND PIRATED IN SIXTY-FIVE COUNTRIES, WHILE HE HAD TO BORROW MONEY FROM FRIENDS TO FIGHT OFF THE CANCER. THIS IS YOUR FIGHT, TOO, GANG . . . AND NOW WE NEED YOUR HELP!”

The 45 Revolver application salutes Harlan Ellison.

The 45 Revolver Stand Alone Digital Rights Management (DRM) Application puts the power of rights definitions, rights management, syndication, and ecommerce in the hands of the creator of intellectual property, the owner of intellectual property, and the producer and distributor of intellectual property.

A novel feature of The 45 Revolver is that it offers the creator or artist or owner of the content multiple formats of DRM from which to choose, such as Microsoft DRM, Apple DRM, or Google DRM, or open source DRM, or any other DRM. The 45 Revolver may offer the DRM for free. The creator may choose any or all of the DRM formats to deliver their content in. Or they may choose a Creative Commons license, or any other form of copyright, which the 45 Revolver is dedicated to studying and maintaining.

Dr. Elliot McGucken has presented the concepts of The 45 Revolver to audiences at UNC Chapel Hill, Pepperdine University, Wake Forrest, Duke University, and the Kauffman Foundation. The invention was very well received, especially by all the entrepreneurs, artists, and creators,

The present invention is the killer desktop app, and/or the killer web app, and it will reside happily beside Photoshop, Fireworks, Adobe Acrobat, Microsoft Word, Adobe Premiere, Final Cut Pro, and numerous other software packages that allow the creation and editing of digital media. The present invention could be licensed to Myspace, flickr, modelmayhem, deviantart, pbase, youtube, or revver, and give them a vast advantage over their competition.

The missing component in the world of software, both web and desktop, has ever been a rights-management suite, which offers a simple interface where rights might be defined, and DRM and copyright definitions that might be selected from an intuitive interface or drop-down menu, which this present invention affords.

Without the rights management method of the present invention, creators, authors, and artists have been leaving billions of dollars on the table—a vast amount of wealth which have been absorbed by massive corporations, both traditional and new. This massive and continual wealth transfer from the indie creator into the coffers and back accounts of vast corporations goes against the original spirit of The United States constitution. The vast corporate conglomerates that detest DRM as it goes against their business plans of free access to everything ever created by the lone creatr, donate millions upon millions to the likes of Larry Lessig, to support him and the temporary fashion in academia that opposes the individual, the artist, and creator, while supporting pro-bureaucracy hype.

The present invention respects the creator, and believes that they ought to be able to protect and profit from their creations. The present invention serves the spirit of the United States Constitution, which states, “The Congress shall have Power To promote the Progress of Science and useful Arts, by securing for limited Times to Authors and Inventors the exclusive Right to their respective Writings and Discoveries.”

Every creator ought to be afforded the opportunity to protect and profit from their content. If Steven Jobs and the major labels can encrypt, own, and profit from the creators' content, the creators ought to be able to, as the simple mathematical algorithms underlying DRM ought to be free as the wind—for one cannot patent, copyright, nor trademark laws of nature.

The beauty of the digital age is that record labels are no longer needed for distribution, nor production, and thus this present invention—the 45 Revolver—realizes the full power and glory of the internet, as it bypasses the middlemen, including aging record companies, Web 2.0 companies that reject the individual artists' rights and profit from commoditizing massive amounts of indie artists, and services such as iTunes which pay artists such as Weird Al Yankovic even less than they made from a CD sale, despite the fact that digital distribution alleviates the costs associated with producing, packaging, shipping, storing, and retailing physical media such as CDs. This present invention unlocks the vast potential profits of the internet, by placing the control of the content's rights where they ought to be—in the artists' hands.

The present invention serves the spirit of The Declaration of Independence:

“We hold these truths to be self-evident, that all men are created equal, that they are endowed by their Creator with certain unalienable Rights, that among these are Life, Liberty and the pursuit of Happiness. That to secure these Rights, Governments are instituted among Men, deriving their just Powers from the Consent of the Governed, that whenever any Form of Government becomes destructive of these Ends, it is the Right of the People to alter or to abolish it, and to institute new Government, laying its Foundation on such Principles, and organizing its Powers in such Form, as to them shall seem most likely to effect their Safety and Happiness.”

The present invention allows creators to easily circumvent large media companies, Web 2.0 portals that treat the creator as valueless commodities, and the philosophies of lawyers who get paid to preach against the indie artist, and offer direct distribution, thus enhancing the creators' reach, augmenting their audience, and raising their bottom line, resulting in more funding for further art. The 45 Revolver allows creators to select rights from a full spectrum of rights, and it allows creators to lock down and encrypt their works by choosing digital rights management from a full suite of DRM protocols, both proprietary and Open Source.

### Further Prior Art & Objects and Advantages of the Invention

The present invention is based upon a simple moral premise, and thus it is natural that it should be thoroughly rejected by expert economists throughout academia and business, for sadly enough, modern economics is often little more than little men's opinions masquerading as fact under the false guise of science. Alexander Rosenberg reminds us, “microeconomic theory has made no advances in the management of economic processes since its current formalism was first elaborated in the nineteenth century . . . the twentieth-century history of economic theory certainly does not appear to be that of an empirical science . . . . Economists would indeed be well-advised not to surrender their . . . research program, if only they could boast even a small part of the startling successes that other [similarly structured] research programs have achieved. But two hundred years of work in the same direction have produced nothing comparable to the physicists' discovery of new planets, or of new technologies by which to control the mechanical phenomena that Newton's laws synthesized. Economics have attained no independently substantiated insight into their domain to rival the biologists' understanding of macroevolution and its underlying mechanism of adaptation and heredity.”

So it is that academic economists may well reject indie creators and artists taking their destinies into their own hands, as the very premise of academic economics and central planning is that individuals are incapable of freedom and governing themselves.

The popular talk show host Rush Limbaugh, who supports the traditional view of constitution that the Founding Fathers intended, opposes the pseudo-academics and supports the premise of the 45 Revolver with this quote, “This story in the LA Times is just unreal. Here's the headline: “Experts Are at a Loss on Investing.” Subheadline: “Nobel winners and top academics fumble the sorts of decisions Bush's Social Security overhaul plan would ask average Americans to make . . . . You know why? Because the Nobel winners and top academics are a bunch of egghead elitists who can't even button their shirts. So, we're supposed to say because these clowns, these eggheads, these Nobel winners and top academics are lousy investors—(doing impression) ‘Man, if the most brilliant people among us can't figure it out, then how is ol' Mabel in the trailer park going to pull this off.’ That's the point of this story . . . . My investments, meager though they are, are all over the place in a bunch of different managers' hands, and I measure the managers against each other to see who's doing better. I did not need a Nobel Prize winner to tell me that this was the right way to do it. The fact that somebody won the Nobel Prize for suggesting this is a testament to how irrelevant the Nobel Prize is.”

The study of economics is only proper to the degree that it respects the rights and freedom of the individual, and holds them superior to the group and elite administrators. Thus the present invention—The 45 Revolver—will usher in a much needed renaissance in the study of economics and entrepreneurship.

Again and again, classical, epic story—with characters who believe in entities greater than themselves, is banned. For the eradication of myths and ideals is great for the short term economy. In order to bolster their social security and 401Ks, the porno elite must make sure that husband and wife are separated, as are child and parent; and that everyone is given a credit card in the superficial society that powers their short-term economy of decline. They have to devalue the Word—deconstruct it at every turn—in order to get people to buy more. It is a perfect storm against higher art—feminists oppose it, market conservatives oppose it, and market liberals oppose it; and thus this generation has been denied the right to see men and women performing the classical ideals upon the silver screen—ideals of Love—of Honor, Courage, and Commitment—as manifested in Dante's Inferno and The Odyssey. Instead Murdoch, Lessig, et al enforce a dumbed-down, degraded culture, where the individual artist has no rights, and all future Great bands shall be determined by myspace mobs, just as soon as they have more friends than Burger King or the latest reality TV show. And the fed has to lower interest rates to print money to create pseudo-wealth in Hollywood, because the postmodern studios are unable to create real wealth via art. Because they and their ilk are bereft of a moral imagination, Lessig, Murdoch, et al cannot see a more exalted way. The rising generation can, and they will build a renaissance based on the classical ideals. The 45 Revolver will help them protect their art from deconstruction and destruction via Lessig's and Murdoch's vast corporations and elite networks. Immortal love will rise again, the family will be reunited, and women will again be afforded the opportunity to bear and raise children instead of working for meaningless, degraded postmodem corporations, instead of having to vote for bigger government, socialism, and communism to extort hard-working men to support their kids born out of wedlock when they don't abort them for economic reasons—fatherless kids, where the dad could be just about anybody and everybody. The 45 Revolver will allow indie creators to again tell Great Stories of Epic Myth, protect their art, and profit from it, in ever augmenting ways.

Thomas W. Hazlett writes in Reason Magazine at http://www.reason.com/news/show/33304.html, “From the 1920s until the '40s, Hayek and his countryman Ludwig von Mises argued that socialism was bound to fail as an economic system because only free markets—by individuals wheeling and dealing in their own interest—could generate the information necessary to intelligently coordinate social behavior. In other words, freedom is a necessary input into a prosperous economy.”

The 45 Revolver, by offering the indie artist and creator the rights to protect and profit and from their creations, restores the economic freedom that Lessig et al have been eroding.

The present invention embodies a Hero's Journey in Digital Rights Management and Constitution Rights for the indie artist and creator. So often it is that an ideal is rejected by the masses—by the group thinkers, lawyers, and vocal activists. So often it is that individual rights are trampled upon for the profit of an elite few preaching equality. But some individual comes along for who the immortal ideals, such as those set forth in the Constitution and Declaration of Independence, are real. They seem crazy as they navigate by the ideals, finding their way out of Plato's cave. But the ideals give them vast and newfound powers; for the ideals, when applied to the current world, can offer improved and enhanced systems to benefit his fellow creators, artists, and entrepreneurs. But human nature is such that it often opposes change, and a great irony of our age is that those who promote themselves as liberal progressives are actually staunch conservatives when it comes to preserving their power and revenue streams—which typically consist of transferring the risk to other people, and the wealth to themselves.

The current elite—the media, Wall Street, and Hollywood elite, have taken culture of the God standard in the same way they took the dollar off the gold standard. With vast cultural inflation, it is impossible to afford to support a family at any price, as the family has been broken up. The current elite lack exalted leadership, and so instead of promoting Great Books and Classics, they leave it up to the masses decide—whoever has the most friends on myspace is the best writer or the greatest band. Their short-term pofits depend upon the deconstruction of classic, long-term ideals, traditions, and values. But those values came from humble origins—from Socrates, from a baby drifting amongst the reeds, and from another born in a manger, and so the renaissance too will be. The 45 Revolver will help it along, as it will allow its creators to protect and profit from their content, independent of Lessig, Murdoch, and myspace.

This perpetual irony promoted by the omnipresent, elite doublespeakers has most recently been aimed at the indie artist and their natural, Constitutional right to digital rights management. Examine the words of the speakers—of those who oppose digital rights management—and their funding, and you will see that their opinions are founded upon massive grants from state bureaucracies and corporations that profit from denying the indie artist her natural rights. In the same way record companies were set up to screw creators out of their profits, the new boss, in the form of Web 2.0 companies, is doing the same. It is a perpetual war against the indie creator and innovator by the MBA/lawyer class, against the author, artist, prophet, and poet by the group thinker. “Meet the new boss, same as the old boss.”—The Who The 45 Revolver—this present invention—gives the indie author and inventor a fighting chance in the rough and tumble world of content creation and distribution.

When the indie artist creates a piece of content, they ride into town alone. They are surrounded on all sides. To their left are the lawyers and activists telling them that they have no rights to protect nor profit from their creations. To their right are the massive corporations and traditional record companies, with the rest of the lawyers, writing up contracts that will have the artist/author in debt by the time they finish their tour. Up ahead are the massive Web 2.0companies, which, when they are sold for $1.6 billion, somehow never compensate the indie creator, but instead send millions of dollars to the traditional record labels and all the lawyers—the pomo-hipster lawyers who preach that the indie artist has no right to protect and profit from their content, and the corporate lawyers who preach that the indie artist has no right to protect and profit from their content. So it is that the indie artist is surrounded on all sides by the elite pomo-hipster lawyers who attended expensive schools to learn the arts of corruption and obfuscation. The 45 Revolver gives the artist a fighting chance.

In Mel Gibson's Passion, Jesus Christ was beaten down by the bureaucracy and mob. When given an opportunity to set Jesus free or a murderer free, the mob chose the murderer. And yet, despite this, and the Trial and Death of Socrates, wherein a noble man was put to death by an elite mob, mobs are the favored entities of Lessig, Web 2.0 companies, and postmodern academia. Indie artists are told to blink, but never think, by books such as Malcom Gladwell's Think, Don't Blink. The Long End of The Tail celebrates the death of the Greats with venture-funded archives of teenagers in their underwear, just as academia has celebrated the death of the professor by hiring thousands of administrators, who never research, never teach, never take any risks, and live off the pensions, savings, tax, and tuition of the criminalized creators. And criminializing the creator is exactly what the bureaucrats must do. The 45 Revolver allows the artists and creators to defend themselves.

Lessig's blog and word games have been devoted to criminalizing the creator—to make the lone author or artist feel guilty for wanting to protect and profit from their works, to own what they do. Lessig et al cast the fundamental Constitutional right to protect and profit from what one creates as a crime against the greater good—the greater good of corporate, academic, and government bureaucracies where an elite few—the none-creative, none-risk-taking, eternal bureaucrats—pompously profit at the expense of the artists and indie creators. The 45 Revolver allows the indie creator to celebrate their rights and take back their private property from Lessig et al.

The fundamental rulebook of Lessig, Murdoch, et al is that the destruction and deconstruction of the ideals which made this country great are a good thing. Anything which grows the state and the corporate bureaucracy at the expense of the individual is a great thing. Anything that mocks the Great Books and Classics, which were all created by indie artists, that diminishes genius and exalts the non-creative mobs of lawyers/MBAs is a great thing, as then they can charge more for an MBA/JD education, promising the students the rights to pilfer pensions, take technologies, and leverage the creations of others without ever paying them. Anything that taxes the working man and raises the tuition of the poor college student—whose only opportunity is to buy into lies upon some soulless campus—is a good thing. The 45 Revolver—the present invention—reverses the dervish postmodern trend, and it is thus an invention that will lead to incalculable spiritual and monetary wealth. The 45 Revolver is an invention that will lead to a renaissance in movies, film, literature, and more. By affording them economic independence, The 45 Revolver will allow artists to think differently, independent of the burgeoning mobs of lawyers, MBAs, and the administrative class that claims the property of others to fuel their corporations and bureaucracies, that prints money to fuel tumultuous bubble that enrich the few at the expense of the many, promotes the corruption of the Constitution, and tramples upon the rights of the indie author, artist, and entertainer.

The 45 Revolver empowers the Creator as never before, fostering improved commercial opportunities for creators, augmented income for creators, and new methods and modes of business for creators and entrepreneurs seeking to serve creators with optimized systems that afford them digital rights management. The 45 Revolver allows the lone creator to launch their intellectual property on its voyage throughout the world wide web as they best deem fit, allowing unparalleled distribution via bittorrent and other methods, reach, formats, device compatibility, and novel revenue streams. The 45 Revolver surpasses all prior art in distribution, reach, formats, device compatibility, and revenues. The 45 Revolver is unobvious to the experts—indeed it is opposed by many experts. The 45 Revolver solves a problem that's been around since the dawn of the internet, has never been seen before, and is of vast use to the creator and owner of intellectual property.

### Further Inventions and Innovations Fathered by the 45 Revolver

The present invention—The 45 Revolver—will naturally father many other inventions, as it reinvents the internet based on a more natural definition of property rights, in line with the United States Constitution, and the humane rights that ought be afforded every creator.

The 45 Revolver as a stand alone application, or plugin, or module; either on the desktop or as a web based application, will naturally give rise to and afford opportunity to other inventions, including:
1. A DRM marketplace wherein different DRM providers, distributors, and media comapnies will compete for the rights to distribute the creator's content, using their DRM protocols and proprietary devices, such as the Zune and iPod. Such a marketplace would drive the price of DRM down, as well as the price of the end devices, such as the iPods and Zune. Such a marketplace would also open up the devices to more indie artists, and increase their distribution, reach, and compensation.
2. The 45 Revolver Dashboard Application: As there are hundreds if not thousands of internet companies seeking to aggregate and profit from the Creator's content, uploading one's content, and tracking subsequent views and revenue generation can be time consuming. A single dashboard monitor, which tracked the hundreds of presences of a creator's content throughout the web, would be a vast boon to the creator. This dashboard application is a natural extension of the 45 Revolver which will be able to interface with multiple aggregating portals, so as to manifest the commodity reversal, where instead of commoditizing the indie artist and creator, the plethora of content-aggregating networks are commoditized. The commodity reversal reflects the natural order of the universe, as while the creator's content is unique, the thousands of sites for uploading content are not. The ability to encrypt and watermark one's content, while maintaining a secure pristine original in a single location, would be priceless to the creator.
3. Social Networks with Digital Rights Management: Imagine a social network wherein a band could protect and profit from its content. The band would be provided multiple digital rights management options, as supported by The 45 Revolver, which would be introduced as a plugin or module.
4. Methods and Systems for Tracking and Compensating for Fair Use in Mashups: Many activist lawyers freak out when they think that DRM will prevent them from using other peoples' works in their own works. But they needn't fear, for as Cory Doctorow has expressed, DRM doesn't work. Actually it does—witness iTunes and the iPod and the billions of songs that have been sold on the system. And what's even better is that DRM could be used as the foundation for a world in which original creators are compensated for mashups. DRM could track the percentage of a work that is used, and compensate the creator in a revenue-sharing scheme based upon some price or percentage level the original creator would suggest.

While massive projects based on algorithms such as linux lend themselves to open source—the anonymous contribution of thousands of participants; the vast majority of Great art requires individuals such as Shakespeare, Dante, Beetoven, 50 Cent, Eminem, George Lucas, and Elton John. Thus it makes sense that while open source licenses are good for linux, more traditional copyrights are needed by indie artists. So it is that the 45 Revolver serves the indie artists with a method for protecting and profiting from their creations.

Socialism and communism are two great methods to make one's lack of creativity a virtue. Suddenly lawyers such as Larry Lessig, who has never composed a song, nor developed software, nor filmed a movie, nor written a software program, are empowered, celebrated, and made rich by corporate, academic, and state bureaucracies all with an interest in profiting via the denial and destruction of the indie artist and their individual rights; via the deconstruction of the Constitution. As Stephen Manes point out at Forbes.com http://www.forbes.com/columnists/business/free_forbes/2004/0329/084.html in “At a time when intellectual property provides America's greatest worldwide successes, overturning established international copyright principles to legalize infringers is like abolishing real estate law to help out squatters. Let's make it clear: The artists who would benefit most from Lessig's legal meddling are rip-off artists.”

Lessig et al are brothers to the Wall Street mavens and mutual fund marketers who risk everyone's money—their pensions and their savings—and reap the lion's share of the benefits, as John C. Bogle, the founder of Vanguard, reports in Battle For the soul of Capitalism. Indeed, the pomo-hipster ironists go to the same ivy league schools where they purchase degrees that allow them to deconstruct the Constitution, along with Shakespeare and the Bible, so that they can lie, cheat, and steal. Well, the 45 Revolver is going to put an end to that.

### Further Objects and Advantages of the Current Invention

The rising generation is longing for Epic Stoy, and thus opportunity abounds in Hollywood and the Heartland, on Wall Street and Main Street, in video games and academia. Opportunity abounds to perform the classical ideals in the contemporary context, and artistic entrepreneurship is all about building a renaissance on your very own “Hero's Journey.”

The classic hero, from Odysseus on down, is one who serves. In all enduring literature and ventures, the moral premise is one and the same, as expressed by John C. Bogle—the “student entrepreneur” who founded the $700 billion Vanguard fund based on an idealistic premise in his 1951 Princeton senior thesis, which Bogle quotes in one of his eloquent speeches—“After analyzing fund performance, I concluded that “funds can make no claim to superiority over the market averages,” perhaps an early harbinger of my decision to create, nearly a quarter-century later, the world's first index mutual fund. And my conclusion powerfully reaffirmed the ideals that I hold to this day: The role of the mutual fund is to serve—“to serve the needs of both individual and institutional investors . . . to serve them in the most efficient, honest, and economical way possible . . . . The principal function of investment companies is the management of their investment portfolios. Everything else is incidental.”

Watch the academy-award-winning movie Braveheart, and you will see the same moral premise at its center and circumference, as expressed by William Wallace's actions and his words to the Scottish Nobles—“There's a difference between us. You think the people of this land exist to provide you with position. I think your position exists to provide those people with freedom. And I go to make sure that they have it.”

And Joseph Campbell, author of The Hero With a Thousand Faces which helped inspire Star Wars, The Matrix, The Lord of The Rings, and Dr. E's AE&T class wrote, “Man should not be in the service of society, society should be in the service of man. When man is in the service of society, you have a monster state . . . .”

So it is that entrepreneurship is an epic story wherein the world is continually “begun anew,” as the humble risk-taker—the reluctant hero—the fount of lasting cultural and monetary wealth—happens upon a Fortune Magazine article, heeds the call to adventure, navigates on out while keeping the higher ideals over the bottom line, endures the road of trials en route to the showdown, siezes the sword, and returns on home with the elixir—with the rewards gained from risking their time, their talents, their passions, and their money in penning that novel, shooting that film, and creating that venture—all based on that moral premise. For Google it is “Do no evil.” For Buffett it is “Our favourite holding period is forever.” For Bogle, Wallace, and Campbell it is “institutions must serve.”

And for the ideas premised by 45 Revolver, the moral premise “is every creator ought to be able to protect and profit from their content,” or merely “The 45 Revolver—“protect and profit.”

The ideas underlying the 45 Revolver hands all the rights over to the artist, allowing them to fully capitalize on the available technologies. A plethora of DRM exists. The internet exists. The novelty of the 45 Revolver is that it offers the indie artist the full potential of digital rights management.

Just as the classic western has been replaced by remakes of 70s sitcoms, and the classic action hero has been replaced by Orlando Bloom, and epic story has been replaced by reality TV, the Constitution has been replaced by Larry Lessig. It is the same story played out time and time again in every venue. The classic document or institution is deconstructed to empower the elite insiders, at the expense of the long term culture. Property rights are necessary to capitalism. And in the digital age, digital rights management are property rights. Without digital rights management, no studio—meaning actors, actresses, writers, film editors, directors, grips will be able to profit by creating Great Art. A renaissance in digitak Rights Management is one and the same as a renaissance in culture. While Larry Lessig might prefer browsing all the scantily clad teenagers on myspace, some of us would prefer Epic Story. While Lessig may prefer all the art the the user deems so worthless that they slap a creative commons license on it, some of us love 50 Cent and Eminem; Sergio Leone and George Lucas; Elton John and Toby Keith; Kid Rock and Metallica. Surely they deserve the right to protect and profit from their content. The 45 Revolver aims to give them this, thusly augmenting the availability of content on the web, leveling the playing field, and bypassing the itunes and other digital download stores that yet pay the artist a pittance.

Downhillbatlle.com writes, “Since we first created this page about iTunes in August 2003, there have been some positive developments. Apple, which had previously indicated that they would only allow artists signed to record labels to offer music on iTunes, has begun including music from CD Baby. CD Baby allows any artist to join their service and takes a very small cut from each song (about 9 cents). This leaves the artist with about 55 cents from each sale, which is pretty decent—though it could be a lot better. Additionally, as noted in the “victory” section above, Apple has stopped saying that iTunes is fair for artists, which was our primary concern. The key factor for deciding whether a music purchase is good for artists is the record label—some purchases on iTunes leave artists with fair compensation, but buying major label music not only leaves the artists with pennies, it also supports a system that marginalizes every independent musician.”—http://www.downhillbattle.org/itunes/index.html

The 45 Revolver would hand all the power over to the indie musician, and thus grant them even more than 55 cents for ever 99 cent song sold. The 45 Revolver would not require CD Baby, nor Apple, no Microsoft, nor the major labels. The 45 Revolver, by providing the creator a method for choosing from multiple forms of DRM, commoditizes the providers of DRM, thusly driving the price down, of both devices and DRM. As time goes on, hardware and software are naturally commoditized, but a Beatles song will always be priceless.

Microsoft wants everyone to use Microsoft Windows Media DRM or Zune DRM. Apple wants everyone to use Apple DRM. The music marketplaces of Microsoft and Apple are still products of yesterday's record companies and yesterday's technology companies, which devalue the artist. While device makers, hardware makers, lawyers, and web 2.0 firms have cashed out in huge ways; the artists—those who provide the soul for the web, have yet to profit to handsomely. The 45 Revolver will allow them to do so. By offering the artist multiple DRM formats, the 45 Revolver will naturally force the DRM providers to compete. Some DRM providers may not play nicely with others, and then their DRM, and their devices, will not be used—they will be consigned to the dustbins of forgotten technologies. As DRM and devices are commodities, there will be plenty oof options for various DRM and devices as time goes on. The pristine original will remain unique, and the 45 Revolver will proect it over time.

Many revered experts oppose the moral premise upon which the 45 Revolver is based. Most of them oppose it because it is a cool and hip thing to oppose morality and the United States Constitution. Lessig also opposes DRM because with a trustworthy DRM system, lawyers will have less work. Lessig opposes DRM, as his livelihood does not depend on DRM, as he is not an indie artist, nor an artist. Lessig blogs, “But some confuse praise for better DRM with praise for DRM. So let me be as clear as possible here (though saying the same thing I've always said): We should be building a DRM-free world. We should have laws that encouraged a DRM-free world. We should demonstrate practices that make compelling a DRM-free world. All of that should, I thought, be clear.” http://www.lessig.org/blog/archives/003353.shtml

So it is that Lessig wants to create laws opposing the authors', inventors', creators', and indie artists' Natural Rights. So it is that Lessig want to legislate against the very United States Constition.

As an American lawyer, Lessig's primary cause ought to be to uphold the United States Constitution and make sure that the indie-artists rights are protected. Ideas have consequences, because of Lessig et als devotion to deconstructing the Constitution, mammoth corporations, venture capitalists, and Wall Street firms have been profiting at the artist's expense. The aim of the 45 Revolver is to give the indie artist the protection they need, so that they might better profit from their work. Larry Lessig ought to read Nobel Prize economist F. A. Hayek's The Road to Serfdom—especially the chapters The End of Truth and Why The Worst Get on Top.

George Orwell stated, “It cannot be said too often—at any rate, it is not being said nearly often enough—that collectivism is not inherently democratic, but, on the contrary, gives to a tyrannical minority such powers as the Spanish Inquisitors never dreamt of.” And so it is that the purpose of the collectivism of Lessig's Creative Commons licenses and anti-DRM stance is to empower a tyrannical minority and make them lords over all the struggling, indie artists; profiting off of others' labors of love.

Contrast Lessig's stance with Eminem's, Marilyn Manson's, Trent Reznor's, Metallica's, and Elton John's—all who began as indie artists:

Lars Ulrich of Metallica writes, “Let's get the obvious out of the way: This is not just about money (as some of the more cynical people will think). This is as close as you get to what's right and what's wrong. Metallica have always been in favor of giving the fans as much access as possible to our music. This includes taping sections at our concerts, and streaming our music via our website. And while we certainly revere our fans for their continued support and desire for our music, we must stress that the open trading of any copyrighted material is, in effect, the looting of our art. And that is something that no artist can, in their right mind, condone. We are in the business of art. This is a walking contradiction if ever there was one. However, there is no denying it. On the artistic side, Metallica create music for ourselves first and our audience second. With each project, we go through a grueling creative process to achieve music that we feel is representative of Metallica at that very moment in our lives. We take our craft—whether it be the music, the lyrics, or the photos and artwork—very seriously, as do most artists. It is therefore sickening to know that our art is being traded, sometimes with an audio quality that has been severely compromised, like a commodity rather than the art that it is. From a business standpoint, this is about piracy—a/k/a taking something that doesn't belong to you; and that is morally and legally wrong. The trading of such information—whether it's music, videos, photos, or whatever—is, in effect, trafficking in stolen goods. Back to the obvious: Very successful recording artists are compensated extremely well for what they do. For every Metallica, however, there are an endless number of bands who rely on what ever they can get in royalties to survive. And while we all like to take shots at the big, bad record companies, they have always reinvested profits towards exposing new bands to the public (although sometimes not the RIGHT bands). Without this exposure, many fans would never have the opportunity to learn about tomorrow's bands today. Napster and other such sites were obviously not conceived to lose money. They, like the labels, must make money or they're out of business. And whatever money they are generating from their site is dirty money. It's being taken out of the hands of the artist and the record labels and put into the hands of another corporation.”

Eminem satates in the 2000 Wall of Sound, “I'm sorry; when I worked 9 to 5, I expected to get a f--king paycheck every week. It's the same with music; if I'm putting my f--king heart and all my time into music, I expect to get rewarded for that. I work hard and anybody can just throw a computer up and download my s--t for free. That Napster s--t, if that gets any bigger, it could kill the whole purpose of making music. It's not just about the money . . . . It's the thrill of going to the store; you can't wait till that artist's release date, taking the wrapper off the CD and putting the CD in to see what it sounds like. I've seen those little sissies on TV, talking about [how] ‘The working people should just get music for free,’ I've been a working person. I never could afford a computer, but I always bought and supported the artists that I liked. I always bought a Tupac CD, a Biggie CD, a Jay-Z CD. If you can afford a computer, you can afford to pay $16 for my CD.”

Trent Reznor of Nine Inch Nails, stated in the May 5, 2000 Boston Globe “. . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to 'stop technology. I love technology. Technology is here to stay.”

Sean “Puffy” Combs, CEO, Bad Boy Entertainment, Inc., states, “I couldn't believe it when I found out that this Napster was linking thousands of people to the new Notorious BIG album “Born Again,” a week before it even hit the streets. This album is a labor of love from Notorious BIG's friends to the man, his kids, the rest of his family and everyone else whose lives will never be the same since BIG passed. BIG and every other artist Napster abuses deserve respect for what they give us.”

Lou Reed states, “Artists, like anyone else, should be paid for their work.”

Elton John states, “I am excited about the opportunities presented by the Internet because it allows artists to communicate directly with fans. But the bottom line must always be respect and compensation for creative work. I am against Internet piracy and it is wrong for companies like Napster and others to promote stealing from artists online.”

So it is that a vast demand exists to protect one's content and profit from one's work.

The 45 Revolver proposes that the DRM dilemma will not be solved by lawyers, nor activists, nor committees; but by authors, artists, and creators being offered a full spectrum of rights management. Mark Twain said, “Only one thing is impossible for God: To find any sense in any copyright law on the planet.” He also said, in a Speech before Congress in 1906, “They always talk handsomely about the literature of the land . . . . And in the midst of their enthusiasm they turn around and do what they can to discourage it.” Finally, he wrote,_“Whenever a copyright law is to be made or altered, then the idiots assemble.”

Michael A. Lechter, ESQ., Intellectual Property Attorney, write the following in a book entitled, Protecting Your #1 Asset: Creating a Fortune from Your Ideas, An Intellectual Property Handbook “Intellectual property is to the world of business what the Colt .45 was to the dime-novel Old West: the great equalizer. It is often the only thing that permits an emerging business to compete successfully against larger, established competitors with vastly more marketing power. In other words, if you are going to compete against the Big Boys, you will typically have to do so through the creation and use of intellectual property.”

### More prior Art & Further Advantages of the Present Invention

Content management systems and ecommerce systems for hosting and selling content abound—hundreds can be found at opensourcecms.com and hotscripts.com. Content portals such as pbase.com, devinatart.com, lulu.com, turbosquid.com, cdbabay.com, and smugsmug.com allow the hosting and selling of media. There are hundreds, if not thousands, of web companies looking to aggregated and capitalize on user-created content.

But yet to date, a one-stop shop for digital rights management does not exist. A software tool offering a full spectrum of digital rights management, watermarking, advertising embedding, and other tools is nowhere to be found. So it is that indie artists are forced to leave billions on the table—billions that end up in the pockets of elite, mammoth corporations, which Larry Lessig sanctifies in his speeches opposing the rights of indie artists. It is no coincidence that Google and Yahoo donate millions upon millions to Stanford where Lessig is employed, and it is no coincidence that Lessig is far nore concerned with the multi-billion-dollar corporation's supposed rights to copy every book in the library, than Larry is with the indie, struggling artist's rights.

A stand-alone digital rights management software suite is the missing piece of the web, which would be of vast use to all creators, content producers, and distributors. And when creators benefit, culture benefits, as they are the geese who lay the golden eggs.

Visit the forums at deviantart.com, turbosquid.com, and pbase.com, and you will see that theft of intellectual property is of great concern to indie artists, photographers, programmers, and developers. Thousands of them would love the 45 Revolver—a tool that allows the lone artist to walk into town, protect their content, publish protected or watermarked forms across numerous portals, and syndicate it across a massive amount of marketplaces.

This dilemma of theft of content and the inability to profit from one's content could be solved with a software tool that provides a spectrum of full rights management in the form of watermarking, encryption, and syndication. The software tool would sit parallel to other platforms for ecommerce and hosting content-there is no need to reinvent the wheel.

A widely accepted form or system of Digital Rights Management has yet to be achieved. Corporations, foundations, lawyers, and programmers have been fighting over standards and their implementation, with thousands of Open Source experts, Stanford lawyers, and activists proclaiming that DRM is definitively bad. At a recent Microsoft event, Cory Doctorow stated, “Here's what I'm here to convince you of: 1. That DRM systems don't work 2. That DRM systems are bad for society 3. That DRM systems are bad for business 4. That DRM systems are bad for artists 5. That DRM is a bad business-move for MSFT.” (From: http://www.craphound.com/msftdrm.txt )

Cory goes on to state, “I lead a double life: I'm also a science fiction writer. That means I've got a dog in this fight, because I've been dreaming of making my living from writing since I was 12 years old. Admittedly, my IP-based biz isn't as big as yours, but I guarantee you that it's every bit as important to me as yours is to you.”

Fifty Cent calls Cory's bluff, as elaborated on elsewhere n this application. Kristin Hersh of the Throwing Muses calls Cory's bluff, “Nobody wants to look the artist in the eye and say, ‘Giving your music away for free is going to make you lots of money’—not while keeping a straight face, anyway.” Eminem calls Cory's bluff in All of sound, May 17, 2000: “I'm sorry; when I worked 9 to 5, I expected to get a f--king paycheck every week. It's the same with music; if I'm putting my f--king heart and all my time into music, I expect to get rewarded for that. I work hard and anybody can just throw a computer up and download my s--t for free. That Napster s--t, if that gets any bigger, it could kill the whole purpose of making music. It's not just about the money . . . . It's the thrill of going to the store; you can't wait till that artist's release date, taking the wrapper off the CD and putting the CD in to see what it sounds like. I've seen those little sissies on TV, talking about [how] ‘The working people should just get music for free,’ I've been a working person. I never could afford a computer, but I always bought and supported the artists that I liked. I always bought a Tupac CD, a Biggie CD, a Jay-Z CD. If you can afford a computer, you can afford to pay $16 for my CD.”

While Microsoft is a multi-billion-dollar company, Cory's books lack the plot, character, and structure that Hollywood generally needs to produce a movie that people will pay to see. Perhaps Doctorow is suggesting that the best way to protect against piracy is to write plotless, characterless novels that never get made into movies that people want to see. Indeed, if lawyers such as Larry Lessig were to take up the slack and become Hiphop artists, replacing Fifty Cent and Eminem, then piracy would finally stop, for once and for all.

Perhaps then we should augment funding for creative writing workshops, hiphop workshops, and more, and transfer all control of the arts to the state bureaucrats so as to ensure that they remain profitless pursuits. When we have no DRM, but for iTunes. When we have no property rights, but for Google executives and Larry Lessig. When we have no Constitution, nor Great Books, nor Classics in academia, but only opinions given by lawyers, then shall we finally have a level playing field.

On the other hand The 45 Revolver sides with the artist. The 45 Revolver seeks to serve Eminem and Fifty Cent. In the December 2006 of Vibe Magazine, Eminem & Fifty Cent talk about the industry in an article entitled Family Matters. Eminem states, “I see a lot of guys on tour, I'm not going to say any names, but on tour, they're touring just to make money. Because the way the record industry is right now, it's tough to sell records. The internet is killing us. At this point of my career, I'd be scared to drop an album for the smell of failure. Do we know how many fans we have in Soundscan says a certain number, but two million people downloaded it? Who knows if I put out anothe album what I'd sell, who knows what 50 would sell?”

Vibe Magazine responds, “Are you worried that if the record business changes for the worse, you may have a domino effect with other businesses?”

Fifty Cent says “What we have the control of is the actual quality of the actual material. Now, if you're questioning if we're going to make the best music, I think generally if you ask anybody, they're going to tell you we're going to make the best rap records. so having the best rap records tied to a brand of clothing makes the clothing cool. The kid who enjoys a 50 Cent or Eminem project is not gonna stop enjoying the projects, but they may stop purchasing the CD. They may star stealing our music from the Internet. But they won't stop being fans of it.”

Vibe Magazine: “And you can't download shirt.”

50 Cent: “Right”

Within this brief dialogue we have the crux of the issue—what will tomorrow's music industry look like? Will Digital Rights Management help protect the artists' natural rights to protect and profit from their work? Or will services such as myspace and youtube, which rarely compensate the indie artist while paying the aggregators billions, triumph? Will artists and creators be denied their fundamental rights to protect and profit from their content? Will state and corporate-funded initiatives, designed to enrich state and corporate bureaucracies at the expense of the individual artist and indie musician, triumph?

For the sake of art and higher, enduring culture, the 45 Revolver must triumph. This present invention—the 45 Revolver will—will allow the indie artists, and thus higher art and enduring culture, to triumph. The 45 Revolver will foster a renaissance. For although Web 2.0 gurus and lawyers will argue that the vast majority of artist's creations, stuck in the “long end of the tail,” are worth nothing, or pennies at best, Dr. Benjamin Franklin reminds us that “a penny saved is a penny earned.” Imagine if indie artists could aggregate and profit from those pennies, and invest them in no-load index funds—over the course of a lifetime, they would amass a small fortune. With all the mutual fund and pension fund scandals, the indie artist's content would become a safe haven of investment. Imagine if indie artists could aggregate and profit from those pennies, and invest them in creating more content—over the course of a lifetime, they would amass small fortunes.

Voyage on over to Mark Cuban's awesome blog where Mark says at http://www.blogmaverick.com/2006/03/19/digital-rights-management-the-coming-collateral-damage/: “Property owners have every right to do whatever they think is necessary to protect their property. Homeowners can build walls and add security. Content owners can add copy protection schemes to their digital content . . . . Unfortunately for content owners, digital rights/copy protection schemes have always proven crackable. No matter how smart the good guys think their programmers are, the bad guys have programmers that are just as smart. More importantly, the good guys have to build the perfect protection scheme, impenatrable by any of infinite number of possible attacks. The bad guys only have to find out where the good guys screwed up. It's a lot easier to be the bad guys and crack the copy protection. Which is exactly why every effort to fully protect digital content has failed.”

Mark Cuban also points out that as DRM evolves to keep up, the file we just purchased yesterday might not work on today's device. So how do we solve this problem? How do we protect the rights of the creators and consumers?

The 45 Revolver makes it beyond this impasse by placing digital rights management in the creators' hands. And not just any digital rights system. But every digital rights management system. The content is the unique creation in this story—the DRM systems are the commodities. And the 45 revolver is just that—a system that allows the content to be fired out in many different formats, thusly empowering the lone creator as never before.

Because the 45 Revolver will always maintain a pristine original, it will always be able to serve the content in any DRM format. DRM technologies are a dime a dozen. But there is only one Fifty Cent. There is only one Matrix. There is only one Star Wars, and George Lucas says, “Just because the market has shifted so dramatically. A lot of people are getting very worried about piracy. That has really eaten dramatically into the sales. It really just came down to, there may not be a market when I wanted to bring it out, which was like, three years from now. So rather than just sit by and watch the whole thing fall apart, better to bring it out early and get it over with.”

Why not offer George Lucas a method, system, and means to protect and profit from his content? Many prominent lawyers and activists argue that if we allow DRM, all of culture will disappear the moment the DRM format changes, and that DRM will thus foster the loss culture and will result in the world returning to the stone ages. The 45 Revolver, by maintaining a pristine original, and then offering a full spectrum of DRM—both yesterday's, today's, and tomorrow's will ensure that the media is forever available, as well as available.

The 45 Revolver will afford the artist with Microsoft DRM, Sony DRM, Apple DRM, Open source DRM, and any other DRM schema that is made available to the application or creator. And the 45 Revolver will ensure that companies will want to share their DRM schemas, for DRM is nothing more than a mathematical algorithm, while the content created by the creators are the reason people use the internet. Nobdoy fires up their computer to download DRM. Competition between DRM providers will ensure that the price for DRM will trend downards, as no company will wish to be left out of a software application that empowers artists as never before. The 45 Revolver will afford a marketplace in DRM.

The chief goal of Microsoft is to get everyone to use their DRM, their software, and their devices. This is not a bad goal—it's just business. Likewise, the chief goal of Sony is to get everyone to use their DRM, their software, and their devices. The chief goal of Apple is to get everyone to use their DRM, their software, and their devices. The chief goal of Google is to get everyone to use their DRM, their software, and their devices. They've all got to make a living. And that is why when you upload a video to youtube, youtube never allows you access to the pristine original. Youtube, as Lessig points out, is a one-way street, designed to aggregate content—both legal and illegal, as Mark Cuban points out, for the illegal content is where most of their traffic derives from.

They've all got to make a living. But so does the indie artist and creator.

During the ecstatic Web 2.0 hype, the Gospel shouted by Lessig et al from the mountaintops was that creators have no rights, that indie artists and creators have no value of their own, but only in the context of the masses. This is the age of “the wisdom of crowds,” and thus when youtube was sold for 1.6 billion, the individual artists and creators did not profit, but only the massive media and record companies google paid off so that they would sue not google nor youtube, but other sites such as myspace and bolt.

This is the age of the “long-tail” and profiting off of pirated content. This is not the age of Johnny Cash nor Bob Dylan. This is the age of millions of myspace bands that nobody has ever heard of—this is the age of plotless, characterless novels and reality TV, wherein the rising generation is denied their divine right to epic myth and classic storytelling, and given Lindsay Lohan and Britney Spears wearing no underwear instead.

But when the rising generation does rise to cerate true, deep, profound art, they're going to want to protect and profit from it, and that's where the 45 Revolver comes in.

The chief goal of the artist is to get their content in as many marketplaces as possible, where it can be accessed, bought, and played on as many platforms as possible, while remaining protected should they choose it to be so. The chief goal of the web 2.0 companies has been to amass as many artists as possible. The web 2.0 companies view the artist as a commodity, and the present invention—the 45 Revolver—fosters the commodity reversal—it views the true value in the act of creation, and it views the web 2.0 companies as commodities—there are hundreds of thousands of them.

Many cultural leeches do not understand the sacred act of creation. But understand it or not, the United States Constitution states that artists have every right to protect and profit from what they create. And one cannot assassinate ideas. Though mobs and juries sent both Jesus and Socrates to their deaths, the righteousness of their ideas, and their immortal spirits, yet lives on in the United States Constitution; which was written in the moral context that Lessig et al have dedicated themselves to deconstructing so as to enrich the elite few—the bureaucrats—at the expense of the many—the artists, creators, and preachers, teachers, and firemen. Ideas have consequences, and Lessig's ideas have proven popular by their ability to diminish the sacred, natural rights of that all those who do the heavy lifting—the creators.

Whereas former social networks and web 1.0/2.0 content archives have first and foremost focused on enriching the owners of the social network, the novel 45 Revolver system of this present invention focuses on enriching the content creators—those who are doing all the heavy lifting in building the true value of the web. With the 45 Revolver, they can elect whether or not to participate in social networks, and should they decide to partake, their content will be protected—watermarked, encrypted, and copyrighted as they deem fit. An overarching principle of the present invention is that by focusing on enriching creators, the network as a whole is strengthened, and is able to attract more and better creators, who can create trusted networks and upscale brands. A rising tide lifts all boats, and the network/archive/marketplace which best empowers its creators will become the best network/archive/marketplace.

Whereas Web 2.0 is often about mob-rule and myspace business models being driven by teenage girls posting pictures in underwear as opposed to pristine poetry and Epic Story, web 3.0, and more importantly web 4.0 and 5.0, will be about classic storytelling and the classical ideals rooted in the United States Constitution and the Great Books and Classics. The same philosophy underlying property rights and property law that enabled this country to become the world's most prosperous are at the center and circumference of this present invention—the 45 Revolver. All creators should be given the opportunity to own and protect what they create, as well as the freedom of opportunity to associate with other creators, and thus build trusted content arcives, presences, and marketplaces.

The United States Constitution states:
The Congress shall have Power to promote the Progress of Science and useful Arts, by securing for limited Times to Authors and Inventors the exclusive Right to their respective Writings and Discoveries;—The United States Constitution, Section 8, Clause 8

By adhering to Constitutional principles, this present invention offers a novel contribution to the realm of social networking and content markets and archives. For instance, the Constitution does not state that Myspace, nor Youtube, nor Google, nor Web 2.0 companies, nor record labels, nor academic communists, nor packs of lawyers and MBAs should be the primary owners nor beneficiaries of the labors of artists, authors, creators, and inventors. Instead, the United States Constitution states that “The Congress shall have Power to promote the Progress of Science and useful Arts, by securing for limited Times to Authors and Inventors the exclusive Right to their respective Writings and Discoveries.”

Although prestigious legautech experts including Cory Doctorow of the EFF and Lawrence Lessig of Stanford Law School flat-out oppose DRM because opposing it is cool and because opposing DRM enriches giant corporations at the indie-artist creator/musician's expense, the technology exists to offer creators better and improved methods for protecting content and defining rights, and the present invention's novel combination of existing technologies results in brand new technologies and novel business methods. Although prestigious legal/tech experts including Cory Doctorow of the EFF and Lawrence Lessig of Stanford Law School oppose digital rights management (DRM) on multiple levels, digital rights management (DRM) may be offered in the present invention so as to empower individual creators.

The United States Constitution does not say that MBAs and lawyers, working in either communistic or capitalistic business models, or some hybrid thereof such as an academic institution which show how well communism fares with capitalists to support it with tax and tuition dollars, should be able to seize the inherent value within a creator's works. Instead, the United States Constitution seeks to protect the rights of the individual creator, as the Founding Fathers realized that the individual is the goose that lays the golden egg.

In The Mystery of Capital, Why Capitalism Triumphs in the West and Fails Everywhere Else, by Hernando De Soto, Mr. Desoto ties the spirit of capitalism to “processes buried deep within the legal system.” A subheading in the introduction is, “The mystery of legal failure—why property law does not work outside the west.”

Property law of the West is interlinked with the deep-rooted, abstract values of the Judeo Christian heritage, centered about such simple precepts as “Thou shall not steal.” This overarching shared-faith allows the abstract ownership of property represented in talents and deeds to become effectively real—all paper wealth comes from a commitment to abstract principles. Individual ownership offers the individual incentive to protect, and thus the West has fathered the strongest economies and military powers. It is no mystery that the country with the right to free speech, free religion, and the right to bear arms also has the most powerful economy and system of property rights. The present invention extends these fundamental, classical, Constitutional principles onto the net, combining existing technologies in unique ways, thusly offering creators novel means for protecting and disseminating their work. This in turn leads to improved and hitherto unknown business models.

The fundamental right to own private property—to own and profit the fruits of one's labors—is the heart and soul of Western Capitalism. The present invention serves this fundamental spirit in a superior fashion to all existing and prior art.

Creators are currently leaving billions of dollars on the table in the present system—billions of dollars that they truly deserve, as they are the creators. And should the creators receive the money they rightfully deserve, they will create more, thusly increasing the net wealth of the internet and the world. The present invention helps them collect the billions of dollars that is rightfully theirs.

Google maintains a complete copy of the web, and they are attempting to make full copies of millions of books protected by copyright, without directly compensating the publishers or authors. Google's patented link algorithms have fostered and encouraged vast amounts of link spam, fake spam pages, fake blogs, blog spam, spam bits, and vast innovations in spam. A better model could consist of a search engine having to pay content owners for each and every copy made, and each and every copy served. Thus the novel search engine would be encouraged to exclude link farms, fake blogs, and link spam from their database, resulting in better search results and higher-quality content. By allowing a user to define the rights to their work, such a search engine could be worked toward.

Chris Anderson of Wired Magazine recently wrote a well-received book, The Long end of The Tail. The book's cover flap states,
“In short, though we still obsess over hits they are not quite the economic force they once were. Where are those fickle consumers going instead? No single place. They are scattered to the winds as markets fragment into a thousand niches . . . . Now, in this highly anticipated book, Anderson shows how we got to this point, and the huge opportunities that exist: for new producers, new aggregators, and new tastemakers . . . .”

There exist two entities which Mr. Anderson's bookflap fails to mention, and which Mr. Anderson's book does not discuss. One is the individual creator—those who actually create the content for the “producers, aggregators, and tastemakers” to play with and profit from. The other entity Mr. Anderson forgets to mention is digital rights management or DRM. For while none-DRM systems empower the aggregators such as the early Napster and Youtubes and Googles, and while groupthink search engines such as yahoo and google have little need for the indie creator, a long-term solution is going to have to sooner or later respect the rights of the individual creator. For groupthink has not solved all of humanities problems. Groupthik has produced communism, fascism, the modern languae association, and string theory. Indeed, neither digital rights management nor DRM can be found in the index of Mr. Anderson's book, which seems to be a glaring omission in that DRM is the only reason major labels or major recording artists or major Hollywood studios will ever convinced to distribute their content online. Kid Rock and Sir Paul McCartny are individuals seeking to be paid for their work, as are thousands of other artists—many of whom are quoted below. The present invention—22nets—seeks to serve them with an improved method for protecting and distributing their content.

Also quoted below are prestigious experts including Larry Lessig—the founder of the Creative Commons and renown Stanford Law professor, as well as Corey Doctorow—the famous blogger, writer, member of the EFF, and influential speaker on topics pertaining to DRM who has addressed many organization, including Microsoft, regarding DRM. While the vast, vast majority of artists support stronger protections for their works, both Lessig and Doctorow, who represent the majority opinions of the web 2.0 tech denizens and their loyal MFA/MBA fanboys; are vocally opposed to Digital Rights Management. Lessig's and Doctorow's vocal opinions have a far-reaching influence throughout the tech world, and the spirit of the present invention counters and opposes their vocal oppositions to DRM. Indeed, the prevailing views of Lessig, Doctorow, and others can explain in part why the present invention, serving the interests of the creators, has not yet seen been manifested. But eternity is on truth's and beauty's die, and the cost of computer applications tends towards zero—so it is that DRM will someday be free as the wind, while art and the individual will never be a commodity; and this invention fully capitalizes upon the proper persepective. While web 2.0 companies seek to commoditize the creator, the present invention treats the creator as unique while commoditizing the web 2.0 companies.

Lessig's and Doctorow's opinions are more fully discussed, as are the objects and advantages of the present invention. Very briefly, here is Corey Doctorow's expert view which was presented during a speech to Microsoft and translated into a dozen languages http://www.craphound.com/msftdrm.txt:

Here's what I'm here to convince you of:
1. That DRM systems don't work
2. That DRM systems are bad for society
3. That DRM systems are bad for business
4. That DRM systems are bad for artists
5. That DRM is a bad business-move for MSFT
Microsoft Research DRM talk, Cory Doctorow, cory@eff.org, Jun. 17, 2004, This talk was originally given to Microsoft's Research Group and other interested parties from within the company at their Redmond offices on Jun. 17, 2004.

Trent Reznor of Nine Inch Nails, calls Cory's bluff in Boston Globe, May 5, 2000, “. . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to 'stop technology. I love technology. Technology is here to stay . . . . ” It has ever been a war against the creator and those who seek to take and profit from another man's labor.

Very briefly, the spirit of the present invention—The 45 Revolver—allows Dr. Dre et al to call the bluff, by countering Cory's conventional web 1.0/web 2.0 wisdom by stating:
1. DRM does work
2. DRM systems are good for society
3. DRM systems are good for business
4. DRM systems are good for artists/individuals/creators
5. DRM is a good business-move for any business seeking to build a quality brand in the content space
6. DRM is the missing key to long-term profitability for social networks.
7. DRM is the missing key to better content on the web.
8. DRM that best serves the indies creator will also best serve the major creators.
9. DRM will allow better “fair use” systems where property that is tagged can be shared and included in other works while still compensating the original creator.
10. DRM can help foster a unique and novel business models including social networks and content marketplace.
11. DRM is the natural right of every artist and creator.
12. DRM is the Constitutional right of every creator.

Unlike prior art, this present invention realizes both the full value of internet technologes and the United States Constitution, by affording authors, artists, and creators the fullest potential to create and profit from social networks and marketplaces filled with content they and other artists create and protect. Contrast Cory Doctorow's words to those of George Lucas who has created a multi-billion dollar empire.

Should other artists, authors, and creators be denied the right to build multi-billion dollar empires just because Cory has not? Cory's books tend to lack plots, characters, and structure—the elements all everlasting art necessitates. There is a Biblical story about two women who claim ownership of a baby. The Wise King Solomon suggests that they cut it in two. One of the ladies thinks this is a good idea. The other is aghast at the prospect, and King Solomon gives the baby to her, as she is the true mother. So it is that DRM ought to be the right of true mother—the true creator who can give birth to true everlasting art.

Contrast Cory Doctorow's words to the words of John C. Bogle—the creator of the world's largest mutal fund, in a speech entitled, “Capitalism, Entrepreneurship, and Investing—The 18th Century vs. the 21st Century:”

“Let's begin with Franklin's entrepreneurship. It was not only remarkable for his era; it was remarkable for any era. While in today's grandiose era of capitalism the word “entrepreneur”has come to be commonly associated with those who are motivated to create new enterprises largely by the desire for personal wealth or even greed, the fact is that entrepreneur simply means “one who undertakes an enterprise,” a person who founds and directs an organization . . . . But at its best, entrepreneurship entails something far more important than mere money. Please do not take my word for it. Heed the words of the great Joseph Schumpeter, the first economist to recognize entrepreneurship as the vital force that drives economic growth. In his Theory of Economic Development, written nearly a century ago, Schumpeter dismissed material and monetary gain as the prime mover of the entrepreneur, finding motivations like these to be far more powerful: (1) ‘The joy of creating, of getting things done, of simply exercising one's energy and ingenuity,’ and (2) ‘The will to conquer: the impulse to fight, . . . to succeed for the sake, not of the fruits of success, but of success itself.’ . . . There is a difference, then, between an entrepreneur and a capitalist. Had Franklin possessed the soul of a true capitalist, ‘he would have devoted the time he saved from printing to making money somewhere else.’ 1 But he did not. For Franklin, the getting of money was always a means to an end, not an end in itself. The other enterprises he created, as well as his inventions, were designed for the public weal, not for his personal profit. Even today, Dr. Franklin's idealistic 18th century version of entrepreneurship is inspirational. When he reminded us that ‘energy and persistence conquer all things,’ Franklin was likely describing his own motivations to create and to succeed, using Schumpeter's formulation, for the joy of creating, of exercising one's energy and ingenuity, the will to conquer, and the joy of a good battle.”

So it is that the 45 Revolver is designed to serve the entrepreneur and creator as opposed to the capitalist and ocmmunist. While the media celebrates the youtube capitalist/commuinsists who made millions off of aggregating others' content, the 45 Revolver will celebrate the indie artist and creator, by affording them the opportunity to protect and profit from their works, as well as fathering further innovation and inventions that serve the entrepreneur, the artist, and the creator.

### Further Prior Art & Advantages of the Present Invention

Ideas have consequences, and the repeated persecution of anyone who mentions DRM throughout academia have resulted in massive corporations and state bureaucracies making vast profits at the expense of the individual artist and art. Not only have movies gotten worse in Hollywood, and the literature and books of the land declined in quality—long-term investments, but elite groups of cynical, snarky insiders have profited immensely.

The snarky mutual fund administrator class, which risks all of our money while profiting off of our parent's pensions, is one and the same as the elite contortionists who trample individual rights, so as to enrich a few at the expense of the many. Contemporary MBA programs and law schools are training the elite insiders to never question the big lies. After graduating from gutted undergraduate programs, and taking the soulless GMAT and LSAT, the youngsters are ripe to join the corruption. It is no coincidence that the rise of the MBA and JD programs have coincided with massive bubbles, and the tragic the decline in the indie artist's rights.

Without a moral context, without Shakespeare and the Bible in their hearts; and Dante, Adam Smith, Hayek, and Freidman in their souls, it is easy for young bankers and lawyers to see the masses as those who are to be exploited for ther own personal profit. It is easy for Lessig to advance his socialistic utopia, and make no mistake—socialism by any other name would still be communism.

The 45 Revolver reminds us of the divine property rights that are far more sacred than even titles to land. For Shakespeare teaches us

Throws Up Another Skull

Hamlet

There's another: why may not that be the skull of a lawyer? Where be his quiddities now, his quillets, his cases, his tenures, and his tricks? why does he suffer this rude knave now to knock him about the sconce with a dirty shovel, and will not tell him of his action of battery? Hum! This fellow might be in's time a great buyer of land, with his statutes, his recognizances, his fines, his double vouchers, his recoveries: is this the fine of his fines, and the recovery of his recoveries, to have his fine pate full of fine dirt? will his vouchers vouch him no more of his purchases, and double ones too, than the length and breadth of a pair of indentures? The very conveyances of his lands will hardly lie in this box; and must the inheritor himself have no more, ha?

For while titles to land are easily transferred, the title of the book is forever owned by the author. The sacred act of creation is the source of all wealth, for without ideas, what would land, or anything else, be worth? Were it not for the patent system, how would we farm the land, or transport the food that s grown there? The 45 Revolver allows the inide creator to protect and profit from their ideas in a new, and superior manner, thusly encouraging a renaissance.

Nicholas G. Carr blogs at, http://www.roughtype.com/archives/2006/10/web_{—}20ier_than.php: “But Lessig isn't really interested in describing the world as it is. His eyes are on a further goal. He wants to redefine “Web 2.0” in order to promote a particular ideology, the ideology of digital communalism in which private property becomes common property and the individual interest is subsumed into the public interest—in which we become the web and the web becomes us.”

Nickola G. Carr continues contines, “The process of social enlightenment always begins with the reshaping of language. According to Lessig, Web 2.0 is not, as you might have assumed, a technological or a business term. It's an ethical term, a moral term. Differences “in business models,” he writes, “should be a focus of those keen to push the values of Web 2.0.” In a gloss on Lessig's post, Joi Ito writes that “we can't really expect users to initially understand the distinction [between real sharing and fake sharing].” But “in the long run, users will understand that stand-alone or closed services do not allow them the freedoms that are becoming exceedingly more common in the Web 2.0 area.” It is hard not to hear the echo of Mao patiently explaining how the masses will make the transition from China 1.0 to China 2.0: Because of their lack of political and social experience, quite a number of young people are unable to see the contrast between the old China and the new, and it is not easy for them thoroughly to comprehend . . . the long period of arduous work needed before a happy socialist society can be established. That is why we must constantly carry on lively and effective political education among the masses and should always tell them the truth about the difficulties that crop up and discuss with them how to surmount these difficulties.”

Basically Lessig plays the classic card of the none-creator—the rights of the individual must be sacrificed for the greater good of humanity. Although we all know where that leads, it's fun to keep trying. Pockets of elite Orwellian cynicism will always prosper in capitalistic systems, just as long as they never succeed in undermining the moral tenets of capitalism and the US constitution. For, as Saint Thomas Aquinas said, “Good can exist without evil, whereas evil cannot exist without good.”

Carr offers another excellent blog post supporting the moral premise of the 45 Revolver is http://www.roughtype.com/archives/2005/10/the_amorality_o.php “In ‘We Are the Web,’ Kelly writes that “because of the ease of creation and dissemination, online culture is the culture.” I hope he's wrong, but I fear he's right—or will come to be right . . . . Like it or not, Web 2.0, like Web 1.0, is amoral. It's a set of technologies—a machine, not a Machine—that alters the forms and economics of production and consumption. It doesn't care whether its consequences are good or bad. It doesn't care whether it brings us to a higher consciousness or a lower one. It doesn't care whether it burnishes our culture or dulls it. It doesn't care whether it leads us into a golden age or a dark one. So let's can the millenialist rhetoric and see the thing for what it is, not what we wish it would be.”—http://www.roughtype.com/archives/2005/10/the_amorality_o.php

Indeed, the advancement of culture is not the realm of the Web 2.0 groupthinkers, and the groupthinkers rarely understand the value of the moral individual, and most often oppose them. The 45 Revolver allows the moral individual to protect and profit from their content, and is thus an innovation that can advance culture by creating both monetary and spiritual wealth.

No prior art, nor any entity at any of the most prominent technology conferences, including (sxsw.com/interactive/) and web 2.0 con (http://www.web2con.com/pub/w/40/coverage.html) has yet suggested offering a stand-alone software application, either on the desktop or the web, that offers the creator a full spectrum of digital rights management options. No prior art has yet suggest an application that offers watermarking options, syndication options. No prior art, nor any entity at any of the most prominent technology conferences, including (sxsw.com/interactive/) and web 2.0 con (http://www.web2con.com/pub/w/40/coverage.html) has yet suggested offering the creator a full spectrum of digital rights management for free. DRM ought to be free, as it is based on mathematical algorithms which are free as the wind.

Indeed, when I asked about providing creators with a full-spectrum of DRM options at SXSW, my question was met with groans throughout the crowd, as I knew it would be, for fanboys generally march in lockstep. I was just trying to demonstrate that leading expert opinion countered the spirit of this present invention. One panel went on to say that DRM is bad, but that iTunes is good even though it uses DRM, because some men are more equal than others. The creator is not to be trusted with something as dangerous as DRM in these contexts—only Steve Jobs is allowed to use DRM, because he is cool and hangs out with Bono, and because he is working with the major labels, who deserve more and better rights than the individual and indie artists, where, by the way, all major-label artists originate. But Larry Lessig has proclaimed that the indie artist is no longer needed in Web 2.0 business plans that benefit the bankers and aggregators over the creators and indie artists, and thus, that indie artists no longer need their Constitutional rights. Rising rap bands and metalheads must be denied the right to use DRM according to present expert opinion elaborated on throughout this present disclosure of invention.

The 45 Revolver stand-alone DRM application provides a new mechanism and means for artists to get their content to as wide an audience as possible. It can sit next to any content creation/editing/manipulating application, and then embed rights descriptions within it. The present invention allows the artist to ride into any town and charge what they want for their content.

Nicholas Carr writes the following on his blog, “What's being concentrated, in other words, is not content but the economic value of content. MySpace, Facebook, and many other businesses have realized that they can give away the tools of production but maintain ownership over the resulting products. One of the fundamental economic characteristics of Web 2.0 is the distribution of production into the hands of the many and the concentration of the economic rewards into the hands of the few. It's a sharecropping system, but the sharecroppers are generally happy because their interest lies in self-expression or socializing, not in making money, and, besides, the economic value of each of their individual contributions is trivial. It's only by aggregating those contributions on a massive scale—on a web scale—that the business becomes lucrative. To put it a different way, the sharecroppers operate happily in an attention economy while their overseers operate happily in a cash economy. In this view, the attention economy does not operate separately from the cash economy; it's simply a means of creating cheap inputs for the cash economy.”—http://www.roughtype.com/archives/2006/12/sharecropping_t.php

Nicholas's insight again supports the 45 Revolver. Whereas the Web 2.0 companies deny fundamental moral, economic, and Constitutional rights to the creator, the 45 Revolver provides these rights.

Although Google's mantra is “do no evil,” sometimes doing no evil is not enough. Sometimes one has to take a stand and do good, for “liberty requires eternal vigilance.” The present invention—the 45 Revolver—provides that eternal vigilance. Einstein said, “The world is a dangerous place. Not because of the people who are evil; but because of the people who don't do anything about it.” The 45 Revolver allows the indie creator to do something about it. George Orwell said, “People sleep peaceably in their beds at night only because rough men stand ready to do violence on their behalf.” The 45 Revolver allows indie creators to take the law, and their destiny, into their own hands. Martin Luther King Jr. said, “He who passively accepts evil is as much involved in it as he who helps to perpetrate it. He who accepts evil without protesting against it is really cooperating with it.” The 45 Revolver helps guard against the fundamental crime of theft. Finally, Nietzsche said, “Evil men have no songs.” The present invention—the 45 Revolver—allows men with songs—the indie artists—to protect their content against the legions of lawyers and MBAs with no songs.

### Further Benefits of the Present Invention

The 45 Revolver will allow the artists to
1) choose their DRM
2) syndicate their content to any one of hundreds of marketplaces and hosting services.
   1. Benefit of 45 Revolver System to Society

By empowering artists with DRM, and getting the rights and money directly to the creator, artists will be able to charge less and make more, thereby benefiting society at large. By having companies compete to provide the best mode of DRM in the 45 Revolver framework, prices for DRM will fall, as interoperability will expand.

2. Benefit of 45 Revolver System to Business

Thousands of businesses will be afforded an opportunity to start record labels, art galleries, movie distribution centers, and more. The power of the huge conglomerates to embrace and extend, to treat artists and creators as commodities, will be balanced by the artists' and creators' ability to treat the DRM providers and hosters as commodities. After all, the art is unique, while there are tens, if no hundreds, of places to host and sell the art, and mechanisms to encrypt it and protect the said art with DRM. The 45 Revolver, by staying loyal to the artists' and creators' inherent Constitutional right to profit from their creation, results in a novel system and means that benefits the creator, businesses, and the consumer, and society.

3. Benefit of 45 Revolver System to Artists

Artists will be empowered as never before. They will be able to choose the best mechanism and means for global distribution.

4. Benefit of 45 Revolver to the End Consumer.

When you buy an ipod, you can't use yahoo music, nor napster, nor Microsoft music. When you buy a scandisk or roxio, you can't use ipod, nor napster, nor Microsoft. But with the 45 Revolver system, devices will naturally emerge that will be able to handle the full spectrum of digital rights, for such devices will have marked advantages.

DRM is not the bogeyman. It is not the monster that is preventing the development of a satisfactory, pervasive form of digital distribution. Rather the current philosophy of DRM, adhered to by lawyers, corporations, activists, and programmers, is preventing progress, as it is placing the DRM decision in the hands of lawyers, programmers, and corporations, rather than in the lone artist and inventor, where such entities rightfully belong. Note what the Constitution, the bedrock of intellectual property law, states:

The Congress shall have Power . . . . To promote the Progress of Science and useful Arts, by securing for limited Times to Authors and Inventors the exclusive Right to their respective Writings and Discoveries; US Constitution, Section 8.

By placing digital rights management firmly in the hand of the creator and artist, the 45 Revolver solves what the legions of corporations, legal foundations, programmers, and lawyers have so far been unable to do.

Because the 45 Revolver solves a problem in a none-obvious, novel way that runs counter to the expert's opinion, it is worthy of a patent on many fronts. The law and the technology exist to offer a full spectrum of digital rights management—should not the creators be the ones to designate and choose the preferred mode of DRM?

45 Revolver creates a novel platform for digital rights management and distribution, that offers the creator a full spectrum of modes of digital rights management, along with a full spectrum of opportunities for publishing and syndicating the content.

“If a man write a better book, preach a better sermon, or make a better mouse-trap than his neighbour, tho' he build his house in the woods, the world will make a beaten path to his door.”-Ralph Waldo Emerson

Large internet portals and content communities view creators as commodities. While google has made billions off of content creators, relatively little of this wealth has been shared amongst the creators.

With the ubiquity of the internet and the commonly held fears of theft of IP on forums at leading content portals such as pbase.com, turbosquid.com, and deviantart.com, the 45 Revolver is needed now more than ever.

To date there exists no stand-alone full rights management suite. By treating rights in a stand-alone application, such as 45 Revolver, several advantages are gained over the prior art.

The prior art, when it even offers rights management to any degree, is limited. The business methods of hosts such as pbase.com and smugsmug.com make it difficult for the creator to move their work from one system to another, so should a better presentation or commerce system come along, they will be locked in with their tens of thousands of photos.

### Further Objects and Advanted of the Present Invention

The 45 Revolver allows the lone creator to commoditize the large portals while becoming their own portal. It provides a method and system for:

1) Defining default ownership and rights of content

2) Extracting content from leading content management and ecommerce systems

3) Watermarking and encrypting content according to rights

4) Populating leading content management and ecommerce systems.

Sites such as lulu.com and cafepress.com allow creators to upload and sell content such as pictures, books, and more, but the creator's brand is diluted, as the site always resides at lulu.com or cafepress.com. While cafepress.com and lulu.com grow and grow, the individual creator—who is treated as a commodity—rarely makes a living from such an arrangement. By providing a ready interface with companies such as cafepress.com, lulu.com, and google's database, the 45 Revolver effectively reverses the commodification of the artist, by commodifying the portals.

There exist multiple open source applications for archiving and displaying content, but these all offer little in the way of rights management, including allowing the creator to a) define rights b) watermark content according to said rights, and c) encrypting content according to said rights.

There exist multiple open source applications for ecommerce, but these do not allow for easy watermarking and protection of digital content.

There exist multiple content management suites and ecommerce applications, but none that allow for easy digital rights management, including watermarking and encryption.

There exist multiple content management suites and ecommerce applications, but no standard bridge that allows multiple applications to exchange content.

The 45 Revovler is novel, useful, and unobvious.

The 45 Revolver will guarantee the perpetuity of content over time.

The 45 Revolver is useful in that it allows creators to protect and profit form their intellectual property.

This invention is novel in that it combines different aspects of other inventions and provides new functionality that allows creators to profit from their work.

The 45 Revolver offers a unique combination of

a) rights definitions

b) content mining/extraction

c) watermarking

d) encrypting

e) digital rights management

f) content syndication/uploading

g) ecommerce

There is prior art that allows watermarking.

There is prior art that allows encryption and digital rights management.

But there exists no rights management suite which combines all of the above to foster a platform for a creator to create and syndicate content.

Unobviousness:

The present invention is unobvious to experts of all stripes—to reknown lawyers, MBAs, corporations, and activists. The chief goal of every corporate DRM initiative is to lock creators and consumers into a single system; be it the Zune and Zune DRM, Windows and Windows Media DRM, or iTunes, the iPod and iTunes DRM. Once a creator's content is in the iTunes or Zune format, is is nerer again set free, and the creators who participate are paid a pittance. The 45 Revolver allows the creator to elect multiple DRM formats.

Technological and legal experts in the field, who always tend towards the socialistic and away from creator's rights that artists such as 50 Cent, Eminem, and Harlan Ellison all favor, see DRM as unnecessary, harmful, unfeasible, a hazard, and generally impossible. And now and then Microsoft hosts them, so as to discourage Open Source DRM companies from competing with Microsoft. Cory Doctorow, an activist and well-known DRM expert and employee of the EFF, states at http://www.craphound.com/msftdrm.txt:

“Greetings fellow pirates! Arrrrr! I'm here today to talk to you about copyright, technology and DRM, I work for the Electronic Frontier Foundation on copyright stuff (mostly), and I live in London. I'm not a lawyer—I'm a kind of mouthpiece/activist type, though occasionally they shave me and stuff me into my Bar Mitzvah suit and send me to a standards body or the UN to stir up trouble. I spend about three weeks a month on the road doing completely weird stuff like going to Microsoft to talk about DRM . . . . I lead a double life: I'm also a science fiction writer. That means I've got a dog in this fight, because I've been dreaming of making my living from writing since I was 12 years old. Admittedly, my IP-based biz isn't as big as yours, but I guarantee you that it's every bit as important to me as yours is to you. Here's what I'm here to convince you of: 1. That DRM systems don't work 2. That DRM systems are bad for society 3. That DRM systems are bad for business 4. That DRM systems are bad for artists 5. That DRM is a bad business-move for MSFT . . . . It's a big brief, this talk. Microsoft has sunk a lot of capital into DRM systems, and spent a lot of time sending folks like Martha and Brian and Peter around to various smoke-filled rooms to make sure that Microsoft DRM finds a hospitable home in the future world. Companies like Microsoft steer like old Buicks, and this issue has a lot of forward momentum that will be hard to soak up without driving the engine block back into the driver's compartment. At best I think that Microsoft might convert some of that momentum on DRM into angular momentum, and in so doing, save all our asses. Let's dive into it . . . .”

The rest of Cory's speech may be found here: http://www.craphound.com/msftdrm.txt

### Further Objects and Advantages of the Invention

In addition to novelty, usefulness, and running contrary to prominent experts' opinions, such as those voiced at a Microsoft conference, the 45 Revolver is worthy of a patent for the following reasons:

1) Previous failure of others: To date a cogent, easy method for providing creators and owners of content with their fundamental Constitutional Rights does not exist. Furthermore, a coherent marketplace which offers music, movies, and various media in different formats, playable upon a wide array of devices, does not exists. This is because the DRM issue has been relegated to the “experts” in corporations, legal foundations, and academia, while leaving out the creator. The 45 Revolver rights this inversion, by being the first application or system that places the full power of DRM in the creators' hands.

It has often been argued that Apple's iTunes promotes piracy, as revealed by this post: http://forums.winamp.com/showthread.php?threadid=255673 “Re: Is Apple promoting piracy? Yes. A) The iPod, made by Apple, is a popular mp3 player. B) mp3s are aquired and distributed almost entirely through priacy. Case closed.”

2) Solves an unrecognized problem: The problem is just dawning, as creators realize they are becoming parts of little fiefdoms designed to bolster google and lulu, while keeping them in the poorhouse. While creator's are afforded opportunities to make larger corporations very wealthy, they are rarely afforded the full enrichment of their Constitutional rights that technology is capable of. The 45 Revolver allows creators to leverage existing technology on a new level.

3) Time Saver & Ease of Use: There exist hundreds of content aggregating and hosting companies. By offering a single-sign on (SSO) via a simple, intuitive interface whereby one can upload one's content once, define one's rights once, and then populate the web with one's content, this present invention offers a novel and superior means of content management for the creator/owner/user/label/studio. The present invention could interface with hundreds of other applications via web services including but not limited to technologies including CURL, SOAP, HTTPD, and REST. The pristine original could be kept securely upon the present invention's server, and watermarked/thumbnailed versions could be distributed throughout the web, which would entice many to purchase the pristine original. This present invention would vastly empower a site such as flickr or youtube, giving the user a suite of rights management tools.

4) Commercial success: A full rights management suite will bolster the compensation of artists and creators, while giving rise to brand new businesses.

5) Hosting and ecommerce solutions abound, but the rights aspect of this application make it a powerful application.

7) Unsuggested modification: to date the prior arts demonstrates that no one has devised nor suggested an application which focuses upon offering a full spectrum of rights management, coupled with the ability to syndicate the protected content to hundreds of other applications and portals for display and ecommerce.

8) Unappreciated advantage: if you give content owners the ability to define their rights in an easy manner, all of a sudden photographers will become stock photographers. Drummers will become record label executives. Neighborhood galleries will be able to get online securely, creating vast new marketplaces.

9) Solves prior inoperability: There have been many attempts to bridge zencart with gallery—they are buggy at best, and generally not well maintained. Also, open source projects as a rule never strive for digital rights management, as it is a part of the religion that DRM is necessarily bad. The 45 Revolver, by providing a proprietary bridge to the open source suppositions, will result in marrying presentation software with ecommerce software.

10) Successful implementation of ancient idea. A level playing field for all creators has been a dream of the internet since its inception—it is thus an ancient idea in internet time, and has yet to be achieved. Indeed, this idea of an equal chance reaches back to the very Declaration of Independence. For still, as downhillbattle.com reports, artists and creators receive a very small cut even when their music or creations are distributed through novel networks, such as iTunes, Napster, yahoo, and Microsoft. The universal distribution with optional creator-defined DRM that the 45 Revolver provides will truly level the playing field for all media companies and creators. The 45 Revolver will solve the distribution problem by taking the choice out of the hands of the bureaucrat—Twain's Idiots—Whenever a copyright law is to be made or altered, then the idiots assemble.—Mark Twain's Notebook, 1902-1903—and putting it in the hands of the creator.

11) Solution of long felt-need: Browse the discussion forums of flickr.com, deviantart.com, and pbase.com, and you will see artists yearning for better ways to protect and profit from their content.

12) Contrary to prior arts teaching—Corey Doctorow and Larry Lessig teach counter to the principles underlying the 45 Revolver. Ideas have consequences, and the pior art seen throughout Web 1.0 and Web 2.0 absobed Cory's and Larry's ideas.

Digital rights management has so far failed because it has been built around the whims of the corporation, academics, legal foundations, and developers, rather than for the creator. The 45 revolver is built for the creator—the engine of innovation, content, and wealth.

By putting the power of DRM in the creator's hand, this invention is superior. By offering a full suite of DRM tools to the creator, including watermarking, encryption, and a full spectrum of licenses, this software application will allow DRM standards to naturally emerge.

Simply put Google wants everyone to use Google, and they don't want to pay a Microsoft tax. Microsoft wants everyone to use Microsoft, and they don't want to pay a Google tax. Sony wants everyone to use Sony. Apple wants everyone to use apples proprietary DRM, which encourages piracy on other networks. The open source guys just want to download everything for free, ad in finitum.

However, the creator just wants their work to be seen and heard by as many people as possible, and they wish to be compensated for it. Thus the creator's motivations for DRM are different than the corporation's. The 45 Revolver invention, by offering the creator an opportunity to use DRM in several formats, helps the creator realize their dream better than any large corporation alone can.

As SatanicPuppy (611928) on Slashdot wrote, at http://yro.slashdot.org/article.pl?sid=05/12/27/1932232&threshold=1&tid=188&tid=17 “Yes, I for one welcome the indecisiveness of our would-be DRM overlords. It's amusing that the greed of the big media corporations which kickstarted this whole mess to begin with, is the same exact thing that is keeping them from developing effective DRM. All the shifting alliances as all the tech companies try and lock the content providers into their DRM scheme, and all of them fight to make sure their DRM doesn't really work with anyone else's. It'll be a moot point before they get their crap together. Ahhh, the sweet spectacle of infighting among one's enemies.”

http://yro.slashdot.org/article.pl?sid=05/12/27/1932232&threshold=1&tid=188&tid=17

Thus it is seen how the corporate and open source philosophies, by keeping DRM separated from the creator, have failed to come up with a viable, trusted, popular, and useful solution. The 45 Revolver offers such a solution for DRM, and will enrich consumers, businesses, and society; all because it will enrich creators.

Digital Wrold Tokyo reports at, littp://www.digitalworldtokyo.com/archives/2005/12/drm_to_delay_bl.htm I, “Although it has been widely reported that Pioneer is set to finally unveil its Blu-ray drive for PCs at CES next week, most media have overlooked the fact that getting the content management in place may cause yet another delay . . . . Pioneer plans to release the new drive to Japanese PC makers in January and thence to the U.S. market but squabbling over the Advanced Access Content System could delay this in the way it forced Toshiba to slam the brakes on its HD DVD player. Full details from the horse's mouth after the jump.”

Thus it is seen how the corporate and open source philosophies, by keeping DRM separated from the creator, have failed to come up with a viable, trusted, popular, and useful solution. The 45 Revolver stand-alone rights management application offers such a solution for DRM, by placing a full spectrum of DRM choices in the creators' hands, and it will thus enrich consumers, businesses, and society; all because it will enrich creators. What the lawyers, activistists, and MBAs could not figure out, the creators will, if given half the chance.

Silicon.com reports, “Rob Glaser has made his peace with Microsoft's Bill Gates. Now, the RealNetworks chief executive is turning up the rhetoric against another technology icon: Apple CEO Steve Jobs. At the Digital Living Conference in San Francisco on Monday, Glaser told a packed hotel ballroom that Jobs and co's refusal to make the iPod compatible with music services other than Apple's iTunes was “pig-headedness”. Glaser also said Apple's unwillingness to co-operate with other online music vendors promotes piracy of copyrighted materials and will eventually draw the wrath of consumers.”

Thus it is seen how the corporate and open source philosophies, by keeping DRM separated from the creator, have failed to come up with a viable, trusted, popular, and useful solution. The 45 Revolver stand-alone rights management application offers such a solution for DRM, by placing a full spectrum of DRM choices in the creators' hands, and it will thus enrich consumers, businesses, and society; all because it will enrich creators.

Zdnet reports at http://news.zdnet.com/2100-1040_{—}22-5983354.html, “Digital music player, was hurting RealNetworks. We think Apple Computer, and Steve personally, are making a mistake by making the software proprietary,” Glaser said, noting that RealNetworks would continue catering to users of Macintosh computers. “There's no reason we should penalize Apple customers for Steve's pigheadeness.”

In an interview following his presentation, Glaser called for the music industry to pressure Jobs into opening up the iPod to other online music vendors. “Steve makes for a good pinata because he's taken a position against interoperability,” Glaser said. These people “should be pressuring him to change because they have leverage over him. Apple being on its own in term of interoperability makes piracy more compelling for consumers. Because, hey, if I take all my MP3s from this illegal site or that illegal site, they'll work on the iPod or anything else. Whereas if I buy them legitimately, they'll only work at one place.”

Thus it is seen how the corporate and open source philosophies, by keeping DRM separated from the creator, have failed to come up with a viable, trusted, popular, and useful solution. The 45 Revolver stand-alone rights management application offers such a solution for DRM, by placing a full spectrum of DRM choices in the creators' hands, and it will thus enrich consumers, businesses, and society; all because it will enrich creators.

The following is written at Slashdot at http://ask.slashdot.org/article.pl?sid=05/08/29/202228&tid=141&tid=95&tid=4, “Lulu.com is founded by Robert Young, a co-founder of Red Hat, the famed Linux distributor. Lulu publishes books, images, music, etc. They use on-demand technology, and the creators own all the rights. I've never tried their music publishing side of the business, but I have a novel published through them (http://www.lulu.com/content/138218[lulu.com]). Lulu's technology of fulfilling customers' orders is topnotch, as good as Amazon.com. If you order a product from them, they inform you every step of the way—when the book (or CD) is produced, when it will be shipped, when it will arrive at your doorstep, etc. Reality check: you're not going to get rich by self-publishing, but it's a start, and starting online is a sound strategy, because there is a whole generation of people growing up being comfortable with buying things online.”

Thus it is seen how the corporate and open source philosophies, by keeping DRM separated from the creator, have failed to come up with a viable, trusted, popular, and useful solution. The 45 Revolver stand-alone rights management application offers such a solution for DRM, by placing a full spectrum of DRM choices in the creators' hands, and it will thus enrich consumers, businesses, and society; all because it will enrich creators.

The following is asked at the oscommerce forums at: http://forums.oscommerce.com/index.php?showtopic=71691&st=0&p=280619&#entry280619 “Group: Community Member, Posts: 1 Joined: 29-Dec. 2003 Member No.: 22,752 Hello, We're setting up an ebook store using OSCommerce. We've found that all the major commercial ebook format vendors are prohibitively expensive on their digital rights management (DRM) solutions, or simply do not allow individuals to deploy a DRM server. Does anyone know of an open source DRM solution for digital content, and particularly one that would integrate with OSC? Thanks, Dan.”

Here is the telling answer that is given at the oscommerce forums, “Group: Contribution Moderator Team Posts: 12,969 Joined: 8-Nov. 2003 From: Massachusetts (US): 42n22, 71w04, Massachusetts Member No.: 18,877 My Contributions Read My Blog for what you are wanting to do, the technology required to perform drm is probably why there is no open source, as takes tons of programming, etc, and having to make sure that the content is delivered encrypted, in unusable format until a key is gotten, takes a bit of work. something wrong with the windows media drm?”

Here is another telling answer given at the oscommerce forums, “John Oligario osCommerce Team Contribution Moderator Knowledge Base Contributions Dec. 29, 2003, 05:02 AM Post #3 Group: Community Member Posts: 3,734 Joined: 1-Jul. 2003 Member No.: 10,799 The biggest issue with DRM in open source is that it counters the spirit of open source which is about making it easier to share, not harder. Another problem is that the best place to do DRM is at the OS level. That is why Apple released iTunes and MS released DRM through MS Windows Media Player. They are the OS vendors and could build the DRM into their OS (already worked around for iTunes). Lindows.com was also working on this, but you can't expect your customers to install LindowsOS just to read your eBook. In other words, I think that open source is the wrong place to look for this. It's not a size/resource issue; both X windows and Apache are much larger projects. The problem is that the kind of people who would be interested in open source programming are not the kind of people who would be interested in DRM. Another problem is that open source projects tend to be very modular. You can certainly find encryption. You can probably find a suitable eBook format (e.g. PDF or PostScript). What you would have trouble finding is an eBook reader that will leave the source in encrypted form while it is using it. The more typical method would be to decrypt it and then read the decrypted file. I.e. to process it in stages. Hth, Matt”

So it is that Open Source does not offer the road towards DRM and creator's rights. While open Source works well in realms where mathematical algorithms dominate—such as the Linux Kernel, Apache, MYSAL, and PHP, PERL, PYTHON, and RUBY, open source philosophies fall short in the realm of Creator's rights, indie artsists, and thus all higher and lasting culture—for the indie creator is the fount of all lasting wealth, and their rights must be protected. May the 45 Revolver serve them well, bring down the price of DRM systems, broaden their reach, and make it easier for the indie artist to protect and profit form their content.

### BRIEF DESCRIPTION OF DRAWINGS

FIG. 1 represent the current state of the web, where creators upload all the content and make none, or very little, of the money. Creators are commoditized by the web companies. Note that both the money and content flow into the Web 1.0/2.0 companies. FIG. 2 represents the commodity reversal that an embodiment of the present invention—the 45 Revolver—will allow. Note how more of the money flows back to the creator.

FIG. 3 represents the basic operations and options provided by the 45 Revolver. Note the full and unique spectrum of rights management options.

FIG. 4 represents the trusted 45 Revolver marketplace or social network that will naturally emerge from the precepts of this invention, as well as the 45 Revolver DRM marketplace that will naturally emerge form the principles and innovations set forth herein, as DRM providers and device manufactures compete for the right to protect creator's content and allow the creator to profit from their creations in optimum manners.

### DETAILED DESCRIPTION OF DRAWINGS

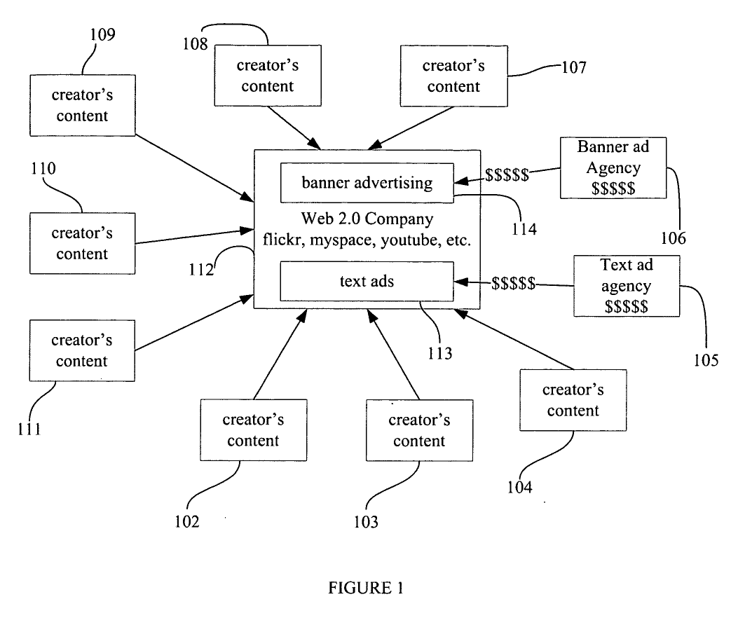

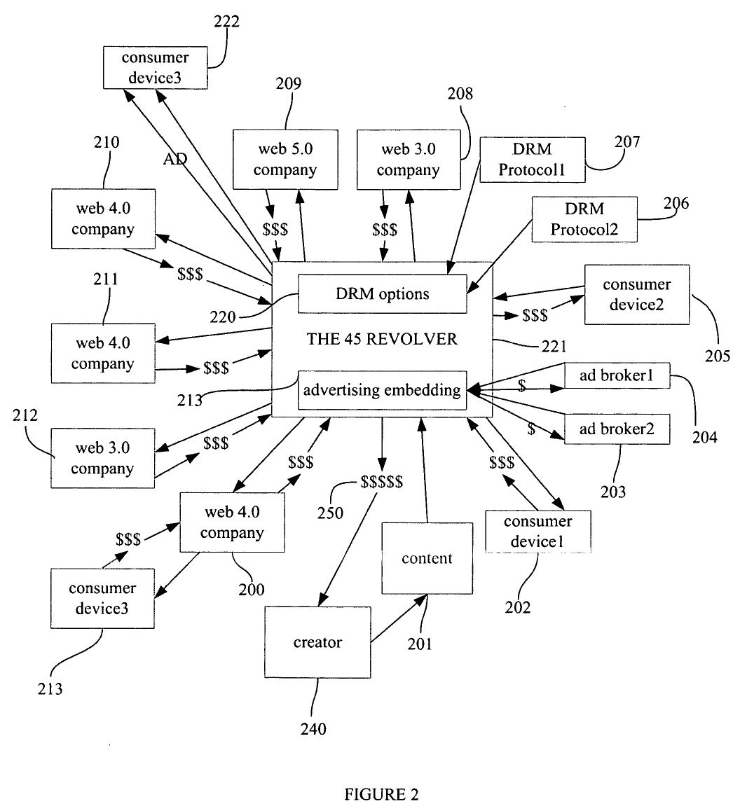

FIG. 1 represent the current state of the web. Various creators, 102, 103, 104, 107, 108, 109, 110, and 111 upload all the content to the Web 1.0/2.0 companies 112 and. Creators are commoditized by the web companies. Banner ad agency 105 and text ad agency 106 both pay the web 1.0/2.0 company to display banner and text ads. Note that both the money and content flow into the Web 1.0/2.0 companies 112. The creators 102, 103, 104, 107, 108, 109, 110, and 111 make none, or very little, of the money while the Web 1.0/2.0 companies keep the lion's share for themselves, even though the creators did the lion's share of the work.

FIG. 2 represents the commodity reversal that an embodiment of the present invention—the 45 Revolver—will allow. It all begins with the creator 240 and their content 201. Note how more of the money 250 flows back to the creator.

The creator 240 uploads their content 201 into the 45 Revolver application 221. The creator then defines their rights and selects from a full spectrum of digital rights management options 220, provided by DRM protocols 206 and 207, or embedded advertising options 213, provided by a plurality of ad brokers 203 and 204. The content is then made available directly to consumers 202, 205, and 222 and other web companies 208, 209, 210, and 211 over the web using standard and/or secure web protocols. Only the web companies or consumers who agree to the creator's terms are allowed to access and/or distribute the content. Only the companies that pay for the content, or serve advertising associated with the content, which pays the creator 240 in terms the creator 240 sets forth are allowed to use the content on their sites. Only the consumers who pay for the content 201 via consumer device1 202 or consumer device2 205 or view the associated ads as in consumer device 222, are allowed access to the content, according to the rights defined by the creator 240 in the 45 Revolver application 221.

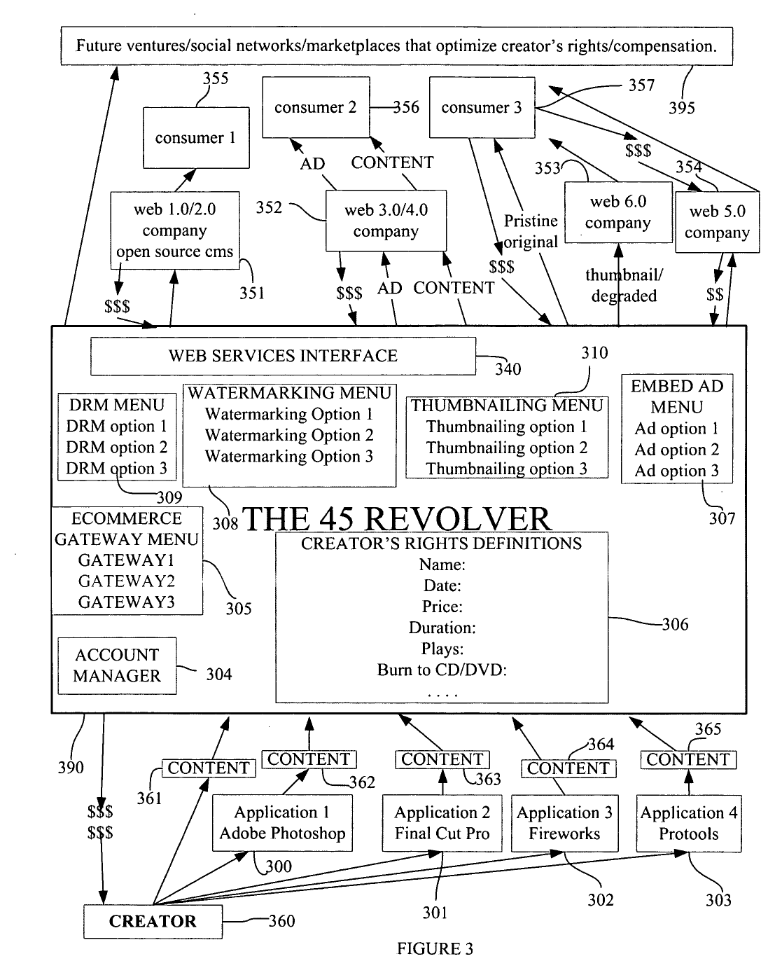

FIG. 3 represents the basic operations and options provided by the 45 Revolver system 390, which can be built on a common web server with common languages and common applications. Note the full spectrum of rights management options—DRM options 309, watermarking options 308, thumbnailing options 310, and advertising options 307. Anyone well-versed in the art of web application development could assemble the combination and build this device. The 45 Revolver also comes with an ecommerce shopping cart gateway 305 to handle transactions and collect payments from customers and other web portals using the content. A web services interface 340 handles account creations, content uploads into other applications and websites 351, 352, 353, and 354. Consumers 355, 356, and 357 interact with the original content 361, 362, 363, 364, 365 in various ways. A hallmark of the 45 Revolver application is that it is capable of manipulating content in hundreds of formats, including but not limited to pictures: jpg, gif, tif, psd, png; film mov, avi; music, avi, mp3 and more. The 45 Revolver application will be continually updated with new tools and protocols to watermark, encrypt, thumbnail, abbreviate, and perform other operations on all digital media.

The 45 Revolver system 390 is capable of registering multiple accounts at multiple content companies 351, 352, 353, and 354 via its web services interface 340, and then uploading content in various versions, along with rights definitions, to the various companies 351, 352, 353. Mulitple contet companies could include flickr, mysapce, deviantart, pbase, lulu, youtube, revver, frindster and others. The web services interface 340—using the CURL or similar protocols available off the shelf—will allow the management and tracking of content throughout.

The present invention could interface with hundreds of other applications and web companies 351, 352, 353, and 354 via web services 340 including but not limited to technologies including CURL, SOAP, HTTPD, and REST. The pristine original could be kept securely upon the present invention's server, and watermarked/thumbnailed versions could be distributed throughout the web, which would entice many to purchase the pristine original. This present invention would vastly empower a site such as flickr or youtube or myspace, giving the user a suite of bundled rights management, content management, and ecommerce tools. The sites could then in turn create superior content marketplaces. The present invention, when added to any web site such as eminem.com or 50cent.com, or social network such as myspace.com, or video or photo hosting site such as revver.com and youtube.com, or any other site, could vastly improve profits for users and owners.

The account manager 304 will display entities including the amount of money made, and all the places the media has been viewed. The ecommerce gateway 305 menu will provide options to handle financial transactions and payment. Payment gateways such as paypal, authorize.net, google payments, or amazon payments may be used to accept credit cards or other funds. Or, the creator might elect to accept checks. At any rate, the creator will be in full control.

In the DRM Menu 309, the Creator can choose from numerous types of DRM, including Windows DRM, Zune DRM, Apple DRM, Google DRM, Sun DRM, open source DRM, or some other type of DRM. With the DRM they can set typical attributes such number of plays, duration media can be played, number of copies that can be made, number of times it can be burned, and more. Over time, favored methods of default DRM schemas will emerge, and as different DRM providers compete, the price of DRM should approach zero, and its ease of use and access and universality will increase. For it will be to the vast benefit of DRM providers to make their DRM inexpensive, easy to use, and universal. This may inspire more open standards for DRM, or it may inspire companies such as Apple to open up their iPod device to other marketplaces than iTunes. Indeed, the ultimate marketplace is the lone creator.

Consumers 355, 356, and 357 interact with content from the 45 Revolver 390 in several fundamental ways which are not meant to limit the scope of the invention. There are hundreds if not thousands of similar scenarios that the 45 Revolver could foster. Consumer 1 355 views content or hears content that a web company 351 purchased from a 45 Revolver System 390. Web company 351 be run upon open source CMS software such as gallery or coppermine or postnuke or joomla. Modules written for such applications will be able to communicate with the stand alone 45 Revolver system 390 via a web services interface 340, so as to transfer appropriate version of the content and rights to the web company 351. Via the web services interface 340 and/or the chosen ecommerce gateway 305. Consumer 2 356 views content from a 45 Revolver system 390 along with an embedded ad from the 45 Revolver system 390. Alternatively, just an ad code could be embedded in the content in the 45 Revolver system 390, and the ad which is served, say from google or yahoo, could end up compensating the owner of the content, who has embedded their ad codes within the content. Such a system could be further developed as another child invention of the present invention. Consumer 3 357 acquires different content different manners. They view a watermarked, degraded, truncated, or thumbnailed version of the content on a web company's site 353—content which was processed in the 45 Revolver system 390, and uploaded via web services 340. Because the watermarked or thumbnailed version has a link embedded back to the original 45 Revolver 390 system, consumer 357 is then able to purchase a pristine original from The 45 Revolver system 390. Also, web 5.0 company 354 hosts degraded, thumbnailed, watermarked versions of the creator's 360 content 361, 362, 363, 364, 365 on their servers, with the agreement that they can sell the pristine original on consignment. Consumer 3 357 purchases the pristine original content from company 354, whereupon company 354 compensates the creator 360 via their 45 Revolver system 390.

The 45 Revolver system 390 is designed to handle all media formats form all applications, 300, 301, 302, 303—the 45 Revolver will be a Creator's best friend throughout their lifetime. As a web application, it could be updated on the fly with all the latest and greatest standards for DRM, watermarking, photography, film, and more. The vast majority of applications, 300, 301, 302, 303, don't come with any rights management tools whatsoever, just as the vast majority of web 2.0 companies come with no rights management features. Thus the principles underlying 45 Revolver system 390 would afford a powerful and much-needed web or desktop application. And anyone who created or owned this trusted bridge—this rights management suite—the primary port for all valuable content launched on out to the world wide web—would be able to conceive of and build superior social networks, content marketplaces, and more. And over time the web services system 340 could be optimized to play with the marketplaces and social networks that get it right—that optimize the creator's compensation.

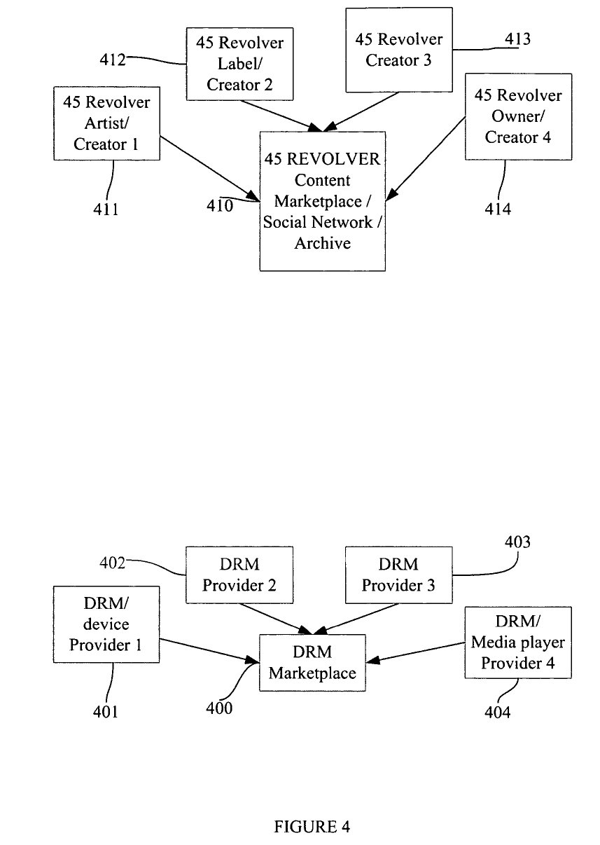

FIG. 4 depicts the trusted 45 Revolver marketplace or social network or archive 410 that will naturally emerge from the precepts of this invention. Marketplaces and social networks may be purchased off the shelf in a vast array of types and kinds—oscommerce, dzoic handhakes, phpfox to name a few. Integrating off-the-shelf software with the novel features set forth within will result in novel business ventures that can be accomplished by anyone skilled in the art. As various artists, creators, owners, labels, and studios, 411, 412, 413, 414 employ the 45 Revolver system to define their rights, manipulate their content, and apply their rights and DRM protocols to their content, the 45 Revolver concept will be ideally situated to foster a trusted marketplace, wherein DRM standards congeal around the wishes of the artists and creators, and device manufactures and DRM protocol providers are encouraged to provide inexpensive options, or free DRM options, that best serve the creator, allowing them to fully protect and profit from their creations.

In this context, the 45 Revolver DRM marketetplace 400 will naturally emerge form the principles and innovations set forth herein, as DRM providers 401, 402, 403, 404 and device manufactures compete for the right to protect the creator's content and allow the creator to profit from their creations in optimum manners. Thus the world's first DRM marketplace will emerge—offering an ebay, amazon, or priceline model for DRM packages—any of which could be easily built by someone skilled in the field, with off-the shelf commerce and auction software.

The ramifications of this rights-centric, creator-centric invention is that it will force web 2.0/3.0/4.0, and all other web companies, DRM providers, end-device makers, media player manufacturers, to compete against one-another to offer creators, labels, and studios better and better deals. To the degree that established companies fall short of the higher ideals emobided in the Constitution and Declaration of Independence, more and more opportunities will be given to ventures that respect creators rights 395. The future will belong to a renaissance in rights and compensation for the creator, and to rising entrepreneurs and entrepreneurial desktop application and web 3.0, 4.0, 5.0 ventures that respect and salute the creator's rights with enhanced options and functionality. It was quite clever of the major corporations to hire MBAs/MFAs/JDs to deconstruct the higher ideals, Great Books, and classics, but they have only succeeded in deconstructing their own souls. Betting against eternal ideals is a not a good long-term investment strategy.

The 45 Revolver in FIG. 3 could be integrated directly with a musician's website, such as Kid Rock's website at kidrock.com, or Eminen's website at eminem.com, or 50cent.com. That way, the consumer would know that the content is official, and with the universality of the 45 Revolver that is guaranteed by its novel free market approach to DRM, their device will be able to play it. Over time, devices that do not play songs downloaded straight from the artist's sites, or movies downloaded straight from the Studio's sites, will fade away. Devices built around the principles of the 45 Revolver will allow artists to charge less and make more, and that will bring about good karma.

And there would exist vast opportunities to build trusted marketplaces around the principles of the 45 Revolver.

Unlike youtube, rewer, and other web 2.0 companies who want to lock the creator into their specific software, format, and service, the 45 Revolver will always give the user access to the pristine original, as well as interfaces and information that aid in the distribution of the creator's content. Simple web services can register accounts in multiple content companies that aggregate content, and upload, manage, publicize, promote, and profit from the content throughout all of them. The 45 Revolver would be a vast time saver for the creator, artist, and content owner, allowing them to upload the pristine original once to a secure server, and syndicate watermarked, or degraded versions, on out to hundreds of other portals who make a living by commoditizing hundreds of artists. As time goes people will know that the 45 Revolver will be the place to go for the pristine originals.

As the 45 Revolver provides a rights management bridge between content creation applications and content hosting applications, the 45 Revolver could easily lead to the world's largest, most trusted marketplace for digital content. As more and more creators use the 45 Revolver's servers to define their rights, upload content, and have their rights applied to the content, more and more content will reside on the 45 Revolver servers. Now as the 45 Revolver is also committed to offering stand-alone DRM applications that can be integrated into websites such as kidrock.com or eminem.com or fiftycent.com, it will become popular amongst indie artists, who would then be confident that they could upload and trust the 45 Revolver marketplace, which is described in other child patents. In other words, the greatest way to build a marketplace is to empower each indie artist with great and vast freedom—with the 45 Revolver application described herein. This reflects that the greatest way to build a country is via united states—recognizing each states's rights—and wherein the state's respect the individual's rights.

While youtube recently sold for $1.65 billion to google, the Lord of the Rings Movies together raked in around $3 billion at the box office. Factor in the millions upon millions of DVD sales, the hundreds of millions of books sold, and one comes to see that J. R. R. Tolkien was one of the greatest entrepreneurs ever, when it comes to creating enduring wealth. While youtube received millions in venture capital, Tolkien never receieved a penny. Also, while Mark Cuban points out that Youtube was built upon a lot of pirated content, J. R. R. Tolkien created the entire Lord of The Rings Trilogy himself. Sometimes we Hobbits must leave the shire—the homestead that is taxed and assaulted by the deconstructive media, academy, and government, to fight the Orcs of Mordor, and begin the world anew. The 45 Revolver shall help the Real McCoys tame the Wild West and foster a new era of moral, creator-centric entrepreneurship.

### DESCRIPTION OF VARIOUS EMBODIMENTS

Anyone skilled in the art of web server administration and website creation, design, and hosting, could build this and other embodiments of the present invention. The 45 Revolver Stand Alone Digital Rights Management application offers a new combination of previously available technologies, that results in a novel and powerful device that 1) empowers artists, 2) empowers consumers, 3) lowers the price of DRM by inspiring more competition, 4) lowers the price of media playing devices by fostering more competition, 5) commoditized the commodities—the web companies—instead of the talent—the creators, artists, and producers.

The 45 Revolver is the creator's dream software application.

It's the world's first stand-alone digital right management application that provides such a full suite of tools—tools that are necessary to every artist looking to profit from and protect their invention. The present invention is all about calling the Web 2.0 MBA/MFA/JD bluff that says your content isn't worth anything independent of MBA/MFA/JDs. Web 2.0 is where the creators build the content. But nowhere in the Web 2.0 definition does it say anything about the creators getting paid for content they create. That's where Web 3.0 comes in—and web 4.0 and 5.0.

One way to solve the DRM dilemma is to remove ideals in both the artistic and legal realms. Story will thus be done away with, as story cannot live without characters, and there can bo no characters without ideals. And by removing ideals in the legal realm, we can easily replace the sacred part of the constitution that recognizes the right of an artist and inventor to own and profit from what they do. But without story, giving up the rights one's creations won't result in that great of a loss, and we can all just create myspace pages with racy pictures from here on out towards eternity.

45 Gallery is just one preferred embodiemet of the 45 Revolver. It is the artist/photographer's dream software application. Other embodiments would handle film, music, books, video games, and further digital content, or combinations thereof.

The 45 Revolver begins with a screen that lets you define your rights.

It makes rights definitions the first step. Your name. Your default price. Other Dublin core information. You get to choose your default DRM settings, payment gateways, watermarking options, and thumbnailing options—all from simple, drop-down menus.

You get to choose everything—the price for the originals, the price for digital copies, the price for prints; the sizes of all the media, and more.

The digital content you create is about to undergo a noble journey through space and time, circling the watery globe for as long as the internet exists. Make no mistake—content is the reason people use the internet. In addition to all the telecoms, flickr, myspace, and google, you ought to get paid for it. That's what web 3.0 is all about—where content creators define their rights and make money.

45 Gallery allows you to upload all of your photography/paintings/art, and it automatically watermarks your works, placing your art both in elegant display software (gallery) and robust commerce software (oscommerce). Future versions will handle all media—audio, video, pdfs, and combinations thereof. 45 Gallery combines the best of many worlds to offer the web's most powerful turnkey stock photography shop.

Beginning with the leading open source application for photo hosting—gallery—and adding the robust functionality of the leading open source commerce system—oscommerce—45 Gallery offers a combination of artistic presentation with robust commerce. And as gallery and oscommerce advance, as versions are rendered in Ruby on Rails and future languages, the 45 Revolver will ensure that your content is ready to surf the next generation web applications. Another function of the 45 Revolver is to always ensure that media is easily ported—both into new and different formats, such as the latest Quicktme or Windows Media or png format, and into various applications, portals, networks, and content aggregators, such as gallery, oscommerce, myspace, zencart, cubecar, glidedigital, youtube, and flickr.

The heart and soul of 45 Gallery is the 45 Revolver—a stand-alone, rights-centric, creator-centric application that offers a bridge between gallery and oscommerce, and sites beside them.

The 45 Revolver can sit beside any content-hosting application, and it could be written in current LAMP technologies or RUBY on RAILS.

The present invention could sit on myspace servers and handle all the rights management, ecommerce transactions, and watermakring—it would be a Godsend to all the indie, prosumer, and professional artists and bands.

The present invention could sit on flickr servers—it would be a Godsend to all the indie, prosumer, and professional photographers.

The present invention could sit beside any open source content management (CMS) system, thusly supplying the missing piece—a rights management suite.

Web 1.0 and 2.0 are all about aggregators of content making money off of large pools of creators who create all the content and do all the heavy-lifting. The 45 Revolver is all about creators making money.

Web 1.0/2.0 viewed the creator as a commodity, with little or no value on their own, but great value in their aggregation. The 45 Revolver views web 1.0/2.0 apps as the commodities—having little or no value of their own, but having great value to the creator when they can upload and syndicate, publish, and publicize their content throughout the multitude of Web 1.0/2.0 applications. The key to the 45 Revolver is that it always allows the creator to sell the content directly with a simple paypal or credit card transaction, thusly removing the middleman aggregator.

One should not underestimate the value that will come from the 45 Revolver's power and freedom. A rights-centric, creator-centric application that gives the creator the freedom to define rights, and the freedom to publish in all leading portals and applications throughout the web, will give rise to hitherto unforeseen business opportunities. Because of its power and freedom, the 45 Revolver will become a chosen mechanism for publishing and porting content—the first step before launching all content throughout the web, so as to protect it with DRM, brand it with watermarks, and thus monetize it. Because it concentrates on allowing the creator to publish in any portal, because it seeks to make the transfer of contenht from one application to another fluid, the 45 Revolver will become a content highway. And it is more important to own the highways—where everyone travels—than it is to own the destinations, such as Flickr, myspace, lulu, cafepress, and others, all of which would rather that neither users nor content ever use any of the other of hundreds of content marketplaces and portals. Business opportunities for new social networks that pay the creators will emerge. These new social networks may compensate creators based on algorithms tied into the inherent structure and connectivity of the underlying social network, which connects not only people, but also content.

The 45 Revolver will become the center where all roads out to other portals and applications and formats come together. Because of this, business opportunities will abound, and further opportunities for patents will become apparent. A search engine that monitors all of the traffic through various 45 Revolver applications would produce a premium search engine, as creators who care about protecting and profiting from their content generally create better content than found on the average myspace page. A social network that ties into the 45 Revolver, which allows users to upload, display, and sell their protected, branded content, will result in a social network with premium content, as again, those who seek to protect, brand, and profit from their content generally create better content.

Also, as the 45 Revolver allows the embedding of ads and adcodes in all media via various methods, including superimposed keywords, trailers, previews, and more, content that passes on through the 45 Revolver en route to its voyage on out will pay the creator ad in finitum as it voyages around the watery globe. Social networks that seek to support the embedded ad features will prosper as they will receive the premium content. Those networks that do not support the embedded ad features will have to keep on keeping all the money and see how long their userbase lingers.

DRM advertising, where the media is protected by DRM, but it is unlocked whenever an ad is served in conduction with the DRM is another business model the 45 Revolver could inspire. For instance, the 45 Revolver could encrypt all of the photographs, or audio, or video, or any other type of media file. Now the content could be uploaded to a 45 myspace, or a 45 flickr, where the only way that the media is decrypted is if the 45 myspace or 45 flick serves an ad alongside the media. Otherwise, the photography woul not be visible. Thus the creator is ensured that whenever her content is viewed, and ad is also viewed—an ad which compensates the creator.

Stronger, more pervasive DRM, would be a great way to solve the “fair use” conundrum. The creator would basically be saying—sure, you can go ahead and use my picture on your page, as long as you support the mechanism that diplays an ad along with it. “Sure—go ahead and use my video clip on your page, just as long as you support the mechanism that diplays an ad before the video,” future creators might say. “On myspace.com you can't see my photos and video, but on 45 myspace.com you can, as 45 myspace supports a mechanism by which ads are served alongside my content, which I am compensated for. My files are decrypted upon the serving of an ad.”

The 45 gallery, an embodiment of the present invention, has the following salient features

1) define rights

2) display art elegantly with fully themable templates

3) sell prints

4) sell downloads

5) choose from multiple DRM formats

6) choose from multiple watermarking options

7) multiple license options

8) batch uploads

9) drag & drop uploads

10) batch watermarking—both custom text and image overlays

11) batch export watermarked images to flickr, pbase, and other popular photo hosting sites

12) specify print sizes and prices by individual image (and quantity if limited edition)

13) customer must accept license agreement prior to allowing checkout

14) agreement presented based on license selected for customer to print.

15) download upon acceptance of payment.

16) download expires by date and/or # of attempted downloads.

17) download links only work if customer pays (random users can't just guess the url or direct link to images)

18) robust search facility by keyword, description and browse by category

19) elegant gallery presentation separated from shopping cart

20) item purchase options on photo's shopping cart detail page

21) robust reporting on sales history, tracking all customers

22) accept payment by paypal, authorize.net, and all popular gateways

23) offline credit card option: see zen cart and how this is handled by storing part and emailing part for security

24) fully customizable appearance for gallery and commerce site

25) 100% of the source code for gallery and shopping cart

26) vast support communities for the gallery (gallery.sourceforge.net) and commerce (creloaded.org and oscommerce.org)

27) phone support for the 45 Revolver Rights Management tool: 919-270-0732

28) software will surf cutting-edge developments in open source software, on out toward ruby on rails.

### Extensive Open Source Feature Set

The 45 Revolver philosophy allows for extensive features and customizability. Based on Open Source, with a proprietary part for the rights management and content syndication, it is designed to surf the waves of innovation for years to come.

The 45 Revolver offers several maverick philosophies about content including the DRC philosophy, which stands for Display, Rights, and Commerce.

There are three entities which the Professional Photographer/Painter/Gallery owner must master. These are Display, Rights, and Commerce, or Art, Law, and Business. 45 StockPhotography marries three applications, both open source and proprietary, to realize this.

Display: The famous Open Source Gallery @ gallery.sourceforge.net

Rights: Dr. E's 45 Revolver (PATENT PENDING)

Commerce: The famous Open Source creloaded.com based on oscommerce.org

When we put all of this together in the 45 Gallery/45 StockPhotography package, we realize a stock photography solution with unparalleled features. Here're more details of each of the three parts:
Display: The famous Open Source Gallery project which has modules for handling all types of media, including music, photography, film, and more—providing vast open source power. All that's missing is a commerce system, provided by oscommerce or some other application, and rights management suite, provided by the 45 Revolver.
   Gallery Features:
1) Image Magick or NetPBM—pick which image manipulation package you have on your server or want to use.
2) Auto Rotate Images—Gallery can look at information in pictures from digital cameras and automatically rotate them as needed.
3) Image Quality and Size Defaults—You can limit the quality and size of images so that when images are uploaded, Gallery will resize them to save space.
4) Main Gallery Page Settings—The configuration wizard contains all of the settings for how the main Gallery page looks and acts including showing or hiding the album tree, search engine; or album owner, and what frames to show around albums.
5) Optional Binaries: zip, jhead, jpegtran—If you have these programs on your webserver, you can enable them to make gallery work better and be more flexible.
6) Languages—Choose which languages you want your Gallery to support and how the user is presented with the choice.
7) Email Support—Set up email support to have your Gallery email users when their accounts are created or when they forget their password, email you copies, email people when the Gallery is updated, and more!
8) Gallery-wide Slideshow—enable or disable a slideshow that includes all pictures in the gallery
9) Commenting—turn off or on the public commenting system and configure it.
10) Logging—enable logging with syslog or the Windows logger
11) RSS publishing—publish your Gallery with RSS![1]
12) Album Defaults—set defaults for the way that all new albums will originally look
13) Upload a ZIP file full of photos and movies
14) Use a form to upload up to 10 photos at each time with and optional file containing descriptions. (screenshot)
15) Specify a web page and let Gallery go slurp up all the photos and movies on that page. (screenshot)
16) Copy all images to a directory on your webserver and let Gallery copy them directly into your album.
17) Use the embedded applet (screenshot) and drag-and-drop pictures and movies to upload them.
18) Use Gallery Remote or one of the Other methods available.
19) Edit the title, caption, keywords, and other custom fields that you define. (screenshot)
20) Modify the thumbnail with java applet, selecting only part of the image to show. [2]
21) Rotate the image in increments of 90 degrees.
22) Move the photo to a different place in the same album or a different album.
23) Hide the photo so that only the album owner or logged in users can see it.
24) Delete the photo.
25) Add a watermark of your choice to your photo. (screenshot)
Adding Photos:
26) Gallery Remote—Gallery Remote is ajava program that will run on any system that java will run on. Your users can use to upload photos to your Gallery via a drag-and-drop interface[0] (screenshots). On the standard file upload page there is a link to the Gallery Remote download page which will download the application from the SourceForge server directly to your user.
27) Other methods are available to easily add pictures to your Gallery including ones that support Windows XP, Apple's iPhoto, Mobile Phones, perl, python, and more.
28) RSS can be used to publish your Gallery and updates to it. Customizing:
29) CSS—Modify Gallery's style sheets, use your existing site's style sheet, or write your own to control colors, borders, spacing [0]
30) Themes—Gallery comes with lots of themes are there are plenty more to download. Check out The user contributions page to start looking for more skins and other easy customizations. [0]
31) html_wrap—Have an existing HTML template for your site but don't use a content management system? html_wrap is for you! You can include content above, below, to the left, and to the right of gallery to make it blend in with the rest of your site. (example 1, example 2, example 3)[0]
32) changing code—Gallery is open source so you can easily change the source code to make it do whatever you want it to do.
Indie Rights: Dr. E's 45 Revolver. The following application could be designed by someone well-versed in web development and software engineering
1) Allows creator/user to define default rights
2) Allows creator/user to choose from multiple DRM protocols
3) Offers multiple watermarking options
4) Offers multiple thumbnailing/abbreviating options
5) Stores pristine original securely
6) Rights management for any and all content
7) Thumbnailing for any and all content types
8) Embedding ads into any and all content types
9) Text Watermarking
10) Graphical Watermaking
11) Define price
12) Define exif/other embedded metadata
13) Export/publish watermarked, thumbnailed, degraded DRM'd, or other format to flickr, lulu, myspace, pbase, cafepress, amazon, itunes, web 1.0/2.0/3.0 company, etc.
14) Allow creator to always sell directly to consumer, bypassing all other commerce portals
15) Embed ads
16) Embed adcodes in metadata, so that when content is displayed on any site, the ads pay the creator

Microsoft's DRM, Apple's DRM, Open Source DRM, and/or some other DRM may be used here within this part of the overall application.

Functionality from Microsoft's DRM, as defined at http//:www.microsoft.com/windows/windowsmedia/forpros/drm/sdksandversions.aspx includes:

Operating Systems: Windows Media DRM 10 Windows XP, and non-Windows-based portable and network devices

Portable Device Support: Portable audio players, mobile phones, set-top boxes, and DVD players that support Windows Media DRM playback

Codecs: Windows Media Audio 1, 2, 7, 8, 9, 9 Professional, and 9 Voice, Windows Media Video 7, 8, 9 and 9 Image, Microsoft MPEG-4 version 1 through 3, ISO MPEG-4 version 1, and Windows Media Screen 7

The creator would get to control the Business Rules, setting options for all of the following.
Business Rules
   Expiration date
   Unlimited play
   Burn to CD (# of times)
   Start time
   End time
   Duration (period media can be used)
   Counted operations (plays, transfers)
User Experience:
   Greater device functionality
   Subscription content transfer to devices
   Faster license acquisition and renewal
   Playback of protected content on network devices

Same, plus revocation and exclusion are extended to portable devices and network devices.
Security: Encryption of content and license, plus:
   Individualization
   Secure Audio Path (Windows Millennium Edition and Windows XP)
   Revocation of player application
   Revocation of content (version 7.1 and later)
   Exclusion of player application (version 7.1 and later)
   Exclusion of Protected Content Module (version 7.1 and later)
   revocation and exclusion are extended to portable devices and network devices.
Commerce Component: The famous Open Source creloaded project based on oscommerce can be easily installed by anyone with knowledge in web development.
Features: from oscommerce.org: Although osCommerce is still in its development stage, the available Milestone releases are considered to be stable with the following features:
1) General Functionality
2) Compatible with all PHP 4 version
All Features Enabled by Default for a Complete Out-of-the-Box Solution
3) Object oriented backend (MS3)
4) Completely multilingual with English, German, and Spanish provided by default
5) Setup/Installation
6) Automatic web-browser based installation and upgrade procedure
7) Design/Layout
8) Template struture implementation to:
   allow layout changes to be adaptive, easy, and quickly to make (MS3)
   allow easy integration into an existing site (MS3)
9) Support for dynamic images
10) Administration/Backend Functionality
11) Supports unlimited products and categories
   +Products-to-categories structure
   +Categories-to-categories structure
12) Add/Edit/Remove categories, products, manufacturers, customers, and reviews
13) Support for physical (shippable) and virtual (downloadable) products
14) Administration area secured with a username and password defined during installation (MS3)
15) Contact customers directly via email or newsletters
16) Easily backup and restore the database
17) Print invoices and packaging lists from the order screen
18) Statistics for products and customers
19) Multilingual support
20) Multicurrency support
21) Automatically update currency exchange rates
22) Select what to display, and in what order, in the product listing page
23) Support for static and dynamic banners with full statistics
24) Customer/Frontend Functionality
25) All orders stored in the database for fast and efficient retrieval
26) Customers can view their order history and order statuses
27) Customers can maintain their accounts
   +Addressbook for multiple shipping and billing addresses
28) Temporary shopping cart for guests and permanent shopping cart for customers
29) Fast and friendly quick search and advanced search features
30) Product reviews for an interactive shopping experience
31) Forseen checkout procedure
32) Secure transactions with SSL
33) Number of products in each category can be shown or hidden
34) Global and per-category bestseller lists
35) Display what other customers have ordered with the current product shown
36) Breadcrumb trail for easy site navigation
37) Product Functionality
38) Dynamic product attributes relationship
39) HTML based product descriptions
40) Automated display of specials
41) Control if out of stock products can still be shown and are available for purchase
42) Customers can subscribe to products to receive related emails/newsletters
43) Payment Functionality
44) Accept numerous offline payment processing (cheque, money orders, offline credit care processing, . . . )
45) Accept numerous online payment processing (2CheckOut, PayPal, Authorize.net, iPayment, . . . )
46) Disable certain payment services based on a zone basis
47) Shipping Functionality
48) Weight, price, and destination based shipping modules
49) Real-time quotes available (UPS, USPS, FedEx, . . . )
50) Free shipping based on amount and destination
51) Disable certain shipping services based on a zone basis
52) Tax Functionality
53) Flexible tax implementation on a state and country basis
54) Set different tax rates for different products
55) Charge tax on shipping on a per shipping service basis

And because we're using the creloaded version of oscommerce, we find the following enhancements form the creloaded.com site within our commerce: CRE Loaded 6.15 Full List of Contributions Installed: Value Added Features:
1) Admin Control By Michael Bryant
2) All-Prods-v2.4 Author: v 1.0 by Mat Bennett, Updated for Milestone MS 2.2 by Farrukh Saeed
3) All-Categories Author: Ingo Malchow, info@gamephisto.de
4) All-Manufacturers Author: Alex Kaiser, et alS) Column Product Listing MS2 Author: David Garcia Watkins, Updated for MS2 by Michael Sasek, *Additional Bugfixes by Souza Credit Class/Gift Voucher/Discount Coupons 5.10b Author: Ian Wilson, Updated for MS2 by Strider, *Additional bugfixes by Andre, Nick Stanko
6) Define Mainpage v1.2 Author: Mattice, Updated for MS2 by Lee Nielsen
7) Google Adsense SSL Safe Code Author: Tom O'Neill
8) OSC-Affiliate 1.09 Author: Henri Schmidhuber, Updated to BTS v1.0 by Paul Langford
9) Purchase Without Account Author: Cheng et al, Updated by David Graham and Tom O'Neill
10) SaleMaker 2.2MS2v1.01 Author: Marcel van Lieshout
11) Specials On Main Page by Default Author: Steve Kemp
12) UltraPics v1.1 Author: Lee Nielsen (MaxiDVD)
13) Wish List V 2.2 Author:Jesse Labrocca, Updated by Talon177
14) X-Sell MS2 Author: Joshua Dechant
Admin Enhancements:
15) Attribute_Sorter_Copier v5.1 Author: Linda McGrath
16) Admin With Access Levels 2.2 Author: Zaenal Muttaqin, Updated for MS2 by Seth Lake
17) Basic Template Structure 1.3 + Fixes Author: Brenden Vickery, Modified by Paul Langford
18) Category Box Enhancement 1.1 Author: Nils Petersson
19) DHTML Menu in Admin V.2 Author: Matti Putkonen, Updated by Sheetal
20) Download_Controller v5.3 MS2.2 Author: Linda McGrath, Updated by Farrukh Saeed
21) Down for Maintenance v1.1b Author: Linda McGrath osCommerce@WebMakers.com, Updated by Robert Hellemans
22) Easy Populate 2.75 Author: Tim Wasson, Updated for MS2 by Deborah Carney, Bugfixes by Deborah *Carney and Ian Corner, CRE Enhancements by Tom O'Neill
23) Edit Orders 1.56 MS2 Author: Jonathan Hilgeman
24) Infobox Admin v1.1MS2 Author: Paul Langford
25) Meta Tag Controller/Generator Author: Brenden Vickery, Bugfixes by xxGeek
26) Mysql Backup Author: The Zen Cart Team
27) osC-PrintOrder with Store Logo v1.0 Author: Randy Newman
28) Super Friendly Admin Screen—Version 2.1 Author: Kerry Watson, Updated by David Graham (nimitz1061)
29) Template Install & Configure V1.2 Author: Paul Langford
30) Who's Online Enhancement 1.3 Author: Calvin K
31) WYSIWYG HTML Editor for Admin 1.7 Author: Lee Nieslen
32) WYSIWYG HTML Editor Added to Coupons and Gift Vouchers Author: W I Benjamin
Enhanced Customer Care:
33) FAQ Desk 1.01 Author:Carsten aka moyashi, Updates By: Wolfen aka 241
34) Information System V1.1f. Author: Joeri Stegeman, addition by: Xander Witteveen and Janusz Oles
35) News Desk 1.48.3 Author:Carsten aka moyashi Updates By: Wolfen aka 241
Payment Modules:
36) Authorize.net Consolidated 1.7 Author: Austin Renfroe, Updated by David Graham and Tom O'Neill
37) EFSnet Payment Module Author: John Nelson
38) GeoTrust/SkipJack Payment Module Author: Paul Kim
39) PayBox Payment Module Author: Emmanuel Alliel
40) Paypal Shopping Cart IPN 2.8 Author: Greg Baboolal, CRE Integration by David M. Graham
41) Pay Junction payment module Author: Robert Krimen rkrimen@payjunction.com
42) Quick Commerce Pro payment module Author: Tom O'Neill (zip1) based on Authorize.net 1.7
Shipping Modules:
43) FedEx 1.11 MS2 Author: Steve Fatula
44) UPS Choice 1.8 Author: Fritz Clapp
45) USPS Methods 2.5 Author: Brad Waite, Updated for MS2 by Brad Waite/Fritz Clapp
46) Zone World 2.0 Author: Elari and Friends of Zone World CRE Loaded integration: David Graham
Order Total Modules:
47) Qty discount v1.41 Author: Joshua Dechant
Reports:
48) MonthlySales&Tax1.55 Author: Fritz Clapp
InfoBox Additions:
49) Banner-ad-in-a-box V1.1 Author: Aubrey Kilian
50) Category Tree Author: Gideon Romm
51) Category Drop Down Author: David Garcia Watkins, Fixes by Brian Kiggin and Paul Boekholt
52) Credit Card in a Boxes for OSC Author: koreantown@hanmail.net, Updated by elari
53) Donate for Nonprofit Site Author: Anon
54) Google Ad Box Author: Tom O'Neill
55) Shop by Price Author: Meltus, Updated for admin control by Charles Williams

So it is that a robust and versatile embodiment of the 45 Revolver, designed to allow authors, artists, creators to protect audio, video, and photography, and other files, could be readily assembled from “off-the shelf components” by an expert in the field. The novel combination, complete with the fundamental rights-management suits offering a plurality of digital rights management options, would greatly empower the creator.

None of the prior art offers options so extensive nor versatile, nor any application that seeks to offer the user so many ways to protect and profit from their creations.

The present invention allows the creator to bypass all the traditional and new middlemen, take their rights into their own hands, and read the maximum benefits that the technology can afford in a novel, hitherto unseen, manner.

### FURTHER EMBODIMENTS

Imagine if search engines had to pay copyright holders a price-per-page to scan books, and/or a fee each time a page from the book was accessed. Imagine if search engines had to pay for copying images, video, and thumbnails, either whenever they copied such assets, or when they displayed such asetts, or when they mined such assets for the information by which search is made possible—both content and links. Imagine if search engines paid content creators whenever ads were served alongside content created by said content creators, form the search engine's servers. This would improve the quality of the search engines while also enriching creators of content. Imagine the following:
1) a mechanism by which authors set the price for the scanning and indexing of their works within directories.
2) mechanism by which authors and creators set the price per page view when a scanned page is viewed within a search engine.
3) mechanism by which authors and creators may embed ads and images within their works, so that ads and images displayed alongside, before, after, or superimposed on their work.
4) mechanism by which text ads revenue is given to authors when their books are scanned.
5) new search engine of premium content wherin copying content isn't free.
6) A search engine that pays creators when their content is served off the search engine's servers
7) A search engine that shares ad revenue with the content creators

All this could be made possible by the 45 Revolver.

Furthermore, as people are growing weary and wary of banner ads and text ads, media-embedded ads have a lot to gain. Embedding ads in photographs and video could go a long ways. Various kinds of novel ads, which scroll across the bottom of the video or photograph, could be served.

### Further Objects and Advantages

Prior art did not emphasize the creation of stand-alone, proprietary nodes, but rather open source modules that would sit on top of open source software.

While the linux operating system has proven a success, the open source model has not fared as well for creating universal standards for digital rights management and content management. Hundreds of open source content management applications exist, each with different protocols for RSS feeds.

Because the open source community is not predispositioned towards the concept of property rights management, a proprietary bridge between various open source CMA and ecommerce, capable of rights management, such as the 45 Revolver makes sense If one was seeking to build the greatest content marketplace, one would wish to begin by empowering the individual artist and creator to the fullest extent. Thus the present invention could also lead to the world's leading marketplace for content.

The content marketplace powered by the 45 Revolver would include:
1. Full Artistic Control: Open Source CMS allows Artist-Hackers to get under the hood to change themes, graphics, UI, sound quality, modules, etc.
2. Distribution: Open Source CMS coupled with RDF/RSS fosters efficient searches and syndication on the semantic web, and thus effective distribution.
3. DRM: Open Source CMS coupled with an extensible rights language such as the CC licenses expressed in RDF/RSS allows a full spectrum of rights definitions in parallel with distribution. Open security standards and protocols afford financial transactions, secure delivery, and trusted ratings for marketplaces and content.

If we used modules instead of stand-alone applications, the modules would be subject to any security breaches in the open source applications. The stand-alone application would provide an extra layer of protection form the modules.

By utilizing stand-alone applications, coupled with modules, the stand-alone application would provide more flexibility. For instance, if an open source application were surpassed in functionality by another open source application, and one wanted to switch, one could still use the same stand-alone bridge to manage content from the new open source application.

If the nodes were open source, they would be easily modified, and it would be more difficult to maintain a standard that would allow one to scale a massive marketplace.

If the nodes were modules, they would be more dependent on the fate of the open source application, and more subject to any security breaches. By creating a stand-alone rights management application such as the 45 Revolver, one will allow artists, creators, and content owners to maximize their reach, audience, and profits.

### Further Ramifications of Invention

Open Source software rocks. I use it all the time.

Proprietary software rocks. I use it all the time.

Both are firmly rooted in intellectual property law.

I want you to own your intellectual property, and I want to own mine. I want you to have the freedom, and the power, to do with your IP what you wish. Without power to take advantage of cutting-edge technology, what use is freedom?

Thus it makes sense that web 4.0 and web 5.0, where creators will get to own and profit from their content, should be based on a set of patents penned not by a corporation nor a legion of lawyers nor a publicly-traded open source company, but by an individual. By the lone Ranger. By Odysseus. By Ranger McCoy.

Postmodernism has taken a vast toll upon culture—in Hollywood, on Wall Street, in NY publishing, and in once sacred institutions such as the family, the church, and academia. If you don't believe me, chances are you have been postmodernized. They have convinced you that ideals are not real, and you have been programmed to work in a cubicle, acquire vast and random debts, and deny your soul, or something.

As it stands, companies such as Google and Red Hat have legions of lawyers to convince you that your natural rights as expressed in the Constitution are a joke, that your ideas are not worth patenting, that your content is worthless on its own, that content aggregators are more important than creators.

But what aggregator is more important than Shakespeare? What aggregator has a greater market capitalization than Dante, than Homer, than Jesus and Socrates?

All the digital content you create has a chance of outliving you. As it travels from disk to disk about the watery world, the digital bits nor bytes will ever change, thus promising it a far greater chance of eternity than mortal flesh. As the multi-billion dollar internet industry is built upon content, that means that one's content is doing the heavy-lifting in the information age, and it could be doing it for a long, long time to come. Being paid for it is the creator's natural right.

One's photography will be quite happy to labor on out towards eternity, and while the copyrights will expire about seventy years after one's death or so, once should profit from it while you can-imagine the compounding interest of a photograph viewed millions of times over seventy years. It's not like one builds a house and then gives it to flickr, yahoo, google, and lulu so they can show it off and make money off of it—once doesn't hand them the keys to their house and let them sell advertising over the paintings on your wall, so why should one give them all their content and expect nothing in return?

Web 4.0 and 5.0 are where the content creators will make money. Technology is the natural commodity as by and large it is based on natural algorithms, whereas copyrighted material—the unique, distinct creation of a single individual, imprinted with their soul—is a natural, unique, artistic asset than cannot be commoditized. And yet the present web, as well as the mega corporations, are based on treating artists and creators as commodities—as widgets. This explains the simultaneous creation of wealthy content aggregators and the declining Hollywood box office, the death of literature, the eradication of DJs who say what they want to say and play what they want to play, as Tom Petty said, and the soullessness of video games.

But something is about to happen.

Creators are about to take the law into their own hands as never before.

And this will result in the commodity reversal.

The 45 Revolver is a foundational invention that enables other inventions. The 45 Revolver empowers creators as never before. The 45 Revolver enables the commodity reversal. In its most simple form, the concept is expressed in the figures and the above 45 gallery embodiment.

Thus it is seen how the corporate and open source philosophies, by keeping DRM separated from the creator, have failed to come up with a viable, trusted, popular, and useful solution. The 45 Revolver stand-alone rights management application, or parallel module, offers the road to providing optimum DRM solutions, packages, and applications, by placing a full spectrum of DRM choices in the creators' hands, and it will thus enrich consumers, businesses, and society; all because it will enrich creators.

The individual entity is the leading contributor to content on the web, and yet there exists no simple system nor method for an individual entity to quickly and easily encode, protect, and distribute their media. The 45 Revolver provides this. The ideas contained within this invention disclosure will father further innovations and inventions, and foster entrepreneurial ventures that better serve the creator—that fount of infinite wealth.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for protecting and profiting from digital content, comprising: allowing a user to define default rights, allowing a user to select a digital rights management protocol, and applying the user's chosen rights and digital rights management protocol to digital content.

2. The method in claim 1 powered by an online software application or web application, wherein the user is allowed to securely upload and securely store a pristine original of their digital media content on a remote server.

3. The method in claim 1 powered by a desktop application, wherein the pristine original is securely stored on the user's desktop.

4. The method in claim 1 wherein the user is allowed to choose from a plurality of digital rights management protocols, and where they may choose to offer their content with one or many.

5. The method in claim 1 wherein the user is allowed to select from a plurality watermarking options.

6. The method in claim 1 wherein the user is allowed to select from a plurality of thumbnailing options.

7. The method in claim 1 wherein operations may be applied to a plurality of file types and formats, including but not limited to video, audio, text, pictures, photographs, and others.

8. The method in claim 1 wherein users can define and set prices of their content.

9. The method in claim 1 wherein users can define the permissions of how the content will be used, including duration of right to play, number of times one can play, how many times the content can be copied, how many times the content can be burned to media, and more.

10. The method in claim 1 which allows users a method for account creation, and content syndication and publishing content and rights into other applications both on the desktop and on the web.

11. The method of claim 1 which allows publishing of digital assets and their rights into open source content management systems.

12. The method of claim 1 which can be integrated into pre-existing content management systems so as to provide rights management options.

13. The method in claim 1 which allows various DRM providers to offer various DRM packages at various prices to the creator.

14. The method in claim 1, which offers various options for ecommerce transactions and collection of payment.

15. The method in claim 1, with a web-services interface that allows account creation, uploading, manipulation, statistical measurement, and tracking of content across a plurality of content-oriented websites and applications.

16. The method in claim 1, which can embed ads or ad codes into said content, ensuring that the creator is paid wherever the media is displayed along with advertising.

17. The method in claim 1 which can reside on any artist's, record label's, or studio's website, bypassing third party or middleman to facilitate the transaction between the artist/label/studio and consumer.

18. The method in claim 1 wherein the DRM is offered for free.

19. A method for aggregating content and building digital content marketplaces by offering online and/or seeding the world with a software application that provides users/creators/owners of content a full spectrum of digital rights management options, watermarking options, and thumbnailing options, and acts as a gatekeeper to different marketplaces selected by the users/creators/owners.

20. A method for creating a marketplace for DRM protocols wherein individual creators are presented with a rights management application that allows them to choose from a list of digital rights management options, and wherein DRM service providers and device manufacturers compete for the right to protect and let content owners and creators profit from their content.
